(19) United States
(12) Patent Application Publication
(10) Pub. No.: US 2026/0366414 A1
(43) Pub. Date: Nov. 19, 2026

(54) ADAPTIVE MULTI-MODEL POWER MANAGEMENT SYSTEM FOR SUBTERRANEAN DRILLING OPERATIONS

(71) Applicant: NABORS DRILLING TECHNOLOGIES USA, INC., Houston, TX (US)

(72) Inventors: Michael Vander Schueren, Calgary (CA); Tim Jonczak, Spring, TX (US); Sai Anirudh Reddy Avilala, Spring, TX (US); John Patterson, Cypress, TX (US)

(21) Appl. No.: 19/419,909

(22) Filed: Dec. 15, 2025

Related U.S. Application Data
(60) Provisional application No. 63/806,307, filed on May 15, 2025.

(51) Int. Cl. E21B 44/00; E21B 41/00; H02J 3/466

(52) U.S. Cl. CPC E21B 44/00; E21B 41/0085; H02J 3/466; E21B 2200/20; E21B 2200/22

(57) ABSTRACT

An example adaptive multi-model power selection apparatus, a computer-implemented method for determining a selected power generator of a candidate generator set to provide power to a subterranean drilling system, and a subterranean drilling system comprising an adaptive multi-model power selection apparatus are provided. The example adaptive multi-model power selection apparatus may be configured to receive historical generator operational data for a candidate generator set of power generators that are each respectively configured to provide operating power to the subterranean drilling system. The apparatus may determine, by a power generator capacity prediction model, a predicted temporal environmental capacity for each of the power generators based on the historical generator operational data. The apparatus may receive operational drilling system equipment data, and determine, by an adaptive power generator selection model, a selected power generator to provide the operating power to the subterranean drilling system during a drilling system operation period.

### CROSS-REFERENCE TO RELATED APPLICATIONS

This application claims the benefit of U.S. Provisional Patent Application No. 63/806,307, filed May 15, 2025, the entire contents of which is hereby incorporated by reference in its entirety.

### TECHNOLOGICAL FIELD

Embodiments of the present disclosure relate generally to power management systems for a subterranean drilling system, and more particularly, to power management systems configured to control a generator set for a subterranean drilling system.

### BACKGROUND

A subterranean drilling system has significant power demands, with various components (e.g., drawworks, mud pumps, top drive, pipe handler, etc.) requiring a flexible and high-capacity power supply to support critical operations. Real-time estimation of generator capacity is difficult particularly given dynamic power demands and variable engine conditions.

Applicants have identified many technical challenges and difficulties associated with dynamically predicting and controlling power supplies for subterranean drilling systems. Through applied effort, ingenuity, and innovation, Applicant has solved such technical challenges and difficulties by developing solutions that are embodied by descriptions set forth in the present disclosure.

### BRIEF SUMMARY

Various embodiments are directed to an example adaptive multi-model power selection apparatus, a computer-implemented method for determining a selected power generator of a candidate generator set to provide power to a subterranean drilling system, and a subterranean drilling system comprising an adaptive multi-model power selection apparatus. These characteristics as well as additional features, functions, and details of various embodiments are described below. The claims set forth herein further serve as a summary of this disclosure.

### BRIEF DESCRIPTION OF THE DRAWINGS

Reference will now be made to the accompanying drawings. The components illustrated in the figures may or may not be present in certain embodiments described herein. Some embodiments may include fewer (or more) components than those shown in the figures in accordance with an example embodiment of the present disclosure.

FIG. 1 depicts a schematic diagram of an example subterranean drilling system structured in accordance with an example embodiment of the present disclosure.

FIG. 2 depicts a block diagram of an example adaptive multi-model power selection apparatus configured in accordance with an example embodiment of the present disclosure.

FIG. 3 depicts a block diagram of an example adaptive multi-model power selection apparatus configured in accordance with an example embodiment of the present disclosure.

FIG. 4 depicts a block diagram of an example adaptive multi-model power selection apparatus in communication with an example operational drilling component set in accordance with an example embodiment of the present disclosure.

FIG. 5 depicts a data flow block diagram illustrating example training operations for a power generator capacity prediction model in accordance with an example embodiment of the present disclosure.

FIGS. 6A - 6B depict flow charts illustrating training operations and classification operations associated with an example power generator capacity prediction model in accordance with an example embodiment of the present disclosure.

FIG. 7 depicts a data flow block diagram illustrating example training operations for a power demand prediction model in accordance with an example embodiment of the present disclosure.

FIGS. 8A - 8B depict flow charts illustrating training operations and classification operations associated with an example power demand prediction model in accordance with an example embodiment of the present disclosure.

FIG. 9 depicts a flow chart illustrating operations executed by an adaptive multi-model power selection apparatus deploying an example adaptive power generator selection model in accordance with an example embodiment of the present disclosure.

FIGS. 10 - 12 depict example graphical user interfaces configured to enable user engagement with an adaptive multi-model power selection apparatus in accordance with an example embodiment of the present disclosure.

FIG. 13 depicts a block diagram of an example adaptive multi-model power selection apparatus configured in accordance with an example embodiment of the present disclosure.

FIG. 14 depicts a block diagram of computing components of an example adaptive multi-model power selection apparatus in accordance with an example embodiment of the present disclosure.

### DETAILED DESCRIPTION

Example embodiments will be described more fully hereinafter with reference to the accompanying drawings, in which some, but not all embodiments of the inventions of the disclosure are shown. Indeed, embodiments of the disclosure may be embodied in many different forms and should not be construed as limited to the embodiments set forth herein; rather, these embodiments are provided so that this disclosure will satisfy applicable legal requirements. Like numbers refer to like elements throughout.

### Overview

Various example embodiments discussed herein address technical problems associated with adaptive power management of a subterranean drilling system. For example, a subterranean drilling system includes a complex array of critical rig equipment (e.g., drawworks, mud pumps, top drive, pipe handler, etc.) each having time-varying power supply requirements. Such rig equipment requires a flexible and high-capacity power supply to support dynamic drilling operations. In some examples, a subterranean drilling system relies on a candidate generator set comprising a plurality of power generators to ensure continuous and reliable energy supply for its operations. To optimize efficiency, individual generators within the candidate generator set can be enabled or disabled based on the current power demand of the subterranean drilling system, preventing unnecessary fuel consumption and reducing equipment wear.

When the subterranean drilling system requires more power, additional generators can be activated to meet the higher power requirements. Conversely, during lower-demand periods, some generators can be shut down to conserve fuel and extend the operational lifespan of the power generators.

Various example embodiments described herein utilize an adaptive multi-model power selection apparatus to manage the real-time selection of power generators within a candidate generator set of a subterranean drilling system. The adaptive multi-model power selection apparatus intelligently manages generator operation to improve efficiency, reduce fuel consumption, minimize maintenance costs, and enhance the overall reliability of the drilling system.

The adaptive multi-model power selection apparatus implements a series of trained machine learning models to determine the selection of power generators at any given time and in the context of dynamically changing drilling conditions. The trained machine learning models include: (1) a power generator capacity prediction model, (2) a power demand prediction model; and (3) an adaptive power generator optimization model.

The power generator capacity prediction model is configured to utilize historical data, such as historical generator operational data, historical generator environmental data, and drilling system historical data to predict the instantaneous generator capacity (e.g., predicted temporal environmental capacity) for each power generator in a candidate generator set. The power generator capacity prediction model may also consider power generator engine health data, maintenance data, age data, etc. Such historical generator data may be used as a training data corpus for the power generator capacity prediction model and may be gathered at various locations, times, and environments, and in correlation with various differing subterranean drilling system drilling component sets.

The predicted temporal environmental capacity of each power generator may vary across drilling system operation periods during operation of the subterranean drilling system. For example, generator operational data (e.g., electrical output), run time, operational efficiency, weather data, generator maintenance, fuel data, current load, internal temperatures, and so on may cause variations in the power capacity of each power generator of the candidate generator set from one drilling system operation period to the next. In a non-limiting example, a first set of predicted temporal environmental capacities during a first drilling system operation period may suggest a first power generator has a maximum power capacity of 1100 kilowatts and a second power generator has a maximum power capacity of 900 kilowatts. During a second drilling system operation period, a second set of predicted temporal environmental capacities may suggest the first power generator has a maximum power capacity of 950 kilowatts and the second power generator now has a maximum power capacity of 1100 kilowatts. Thus, the set of selected power generators selected to provide power to the subterranean drilling system depends on the predicted temporal environmental capacity of each power generator in the candidate generator set during a given drilling system operation period.

In some embodiments, the adaptive multi-model power selection apparatus may implement model verification techniques to continually monitor the operation of the power generator capacity prediction model. The adaptive multi-model power selection apparatus may also store multiple shared power generator capacity prediction models and select a specific shared power generator capacity prediction model based on predictive performance relative to an observed power generator capacity of one or more of the power generators of the candidate generator set. For example, the adaptive multi-model power selection apparatus may determine a prediction error by comparing the predicted temporal environmental capacity from a shared power generator capacity prediction model with an observed power generator capacity of an associated power generator. The adaptive multi-model power selection apparatus may select the shared power generator capacity prediction model that generates the most accurate predictions.

The adaptive power generator selection model may be configured to determine a selected power generator (or selected power generator set) to provide power to the subterranean drilling system based on the predicted temporal environmental capacity of each of the power generators in the candidate generator set, based on the power demand of the subterranean drilling system, and based on one or more cost-based reduction strategies. For example, well plans executed by the adaptive multi-model power selection apparatus may comprise multiple drilling stages over various drilling system operation periods (e.g., spudding, vertical drilling, directional drilling, casing, completion, and so on), each associated with a different power demand. In addition, the power capacity of each power generator in the candidate generator set may vary over time. Accordingly, both the number of power generators and the specific power generators selected may vary between different drilling system operation periods.

For example, during a first drilling system operation period the adaptive power generator selection model associated with a candidate generator set comprising five power generators may select the first and third power generators to be enabled based on the power demand of the subterranean drilling system, the predicted temporal environmental capacity of each of the power generators in the candidate generator set, and based on the one or more cost-based reduction strategies. During a second drilling system operation period the adaptive power generator selection model may select the first, second, and fourth power generators to be enabled, for example, due to a change in the predicted temporal environmental capacity of one or more power generators, due to a change in power demand of the subterranean drilling system, and/or in accordance with the cost-based reduction strategy. In some embodiments, the selected power generator set may be selected to reduce fuel consumption, reduce emissions, and/or evenly distribute wear across the candidate generator set.

The power demand prediction model is trained in various embodiments to output a predicted temporal environmental power demand for the subterranean drilling system based on historical operational drilling system equipment data. Historical operational drilling system equipment data may be associated with historical operational environmental data, location data, and/or geological data. Such historical operational drilling system equipment data may be obtained from sensors deployed within and around a variety of different subterranean drilling systems executing various well plans at different locations, in various climates, in different geological sites and formations, and amidst drilling system equipment achieving differing levels of productivity.

In some embodiments, power demand prediction models trained with historical operational drilling system equipment data are configured to enable the adaptive multi-model power selection apparatus to predict a temporal environmental power demand of the subterranean drilling system for a drilling system operation period (e.g., ten minutes, 30 minutes, etc.). Well plans executed by the adaptive multi-model power selection apparatus may comprise multiple drilling system operation periods and the predicted temporal environmental power demand of the subterranean drilling system may vary among such drilling system operation periods. In various embodiments, the varying predicted temporal environmental power demand informs selection of power generators to provide power to the subterranean drilling system. For example, a first predicted temporal environmental power demand during a first drilling system operation period may suggest engagement of two power generators of the candidate generator set while a second predicted temporal environmental power demand during a second drilling system operation period may suggest engagement of four power generators of the candidate generator set.

Various embodiments discussed herein may be configured to reduce power consumption, fuel consumption, and/or emissions of a subterranean drilling system. Unnecessary mechanical strain on the power generators due to overutilization may also be reduced, increasing the operating life of the power generators of a candidate generator set.

### Definitions

The term “subterranean drilling system” refers to a subterranean drilling rig (e.g., oil rig) and its complex array of constituent components. Subterranean drilling systems are intricate industrial platforms designed to drill into the subsurface of the Earth to access oil and gas reserves. Subterranean drilling systems consist of integrated sets of operational drilling components, such as the drawworks, rotating control device, turntable, mud pumps, top drives, pipe handlers, shakers, fluid treatment equipment, wellbore, bottom-hole assembly, various sensing devices, etc.; a rig controller, and a candidate generator set. The operational drilling components work together to penetrate geological formations. To function effectively, the subterranean drilling system requires substantial operating power, which varies during different drilling operation periods and is supplied by one or more power generators from a candidate generator set. Depending on the energy demands of the drilling operation, one or multiple generators may be enabled at a time during each drilling operation period, allowing for flexible and efficient power management across various drilling phases.

Many modern subterranean drilling systems deploy an Electronic Drilling Recorder (EDR), which is configured to capture and log data from the operational drilling component set. The EDR continuously collects operational drilling system equipment data, including parameters such as torque, weight on bit, mud flow rate, and rotational speed. The operational drilling system equipment data is used for real-time monitoring of the subterranean drilling system. By analyzing trends and anomalies in the collected data, subterranean drilling systems as discussed herein can make improved predictions for adjusting operational parameters, and preventing potential failures, thereby improving the overall efficiency and reliability of the drilling process.

The term “operational drilling component set” refers to any mechanical, electrical, or other equipment that make up a subterranean drilling system. The components of the operational drilling component set work in coordination to perform the complex task of drilling into the subsurface of the Earth to access oil and gas reserves. Key examples include the drawworks, which control the hoisting and lowering of the drill string; mud pumps, which circulate drilling fluid to cool the drill bit and carry cuttings to the surface; top drives, which provide rotational force to the drill string; and pipe handlers, which automate the movement and connection of drill pipe segments.

Each component in the operational drilling component may also be a source of operational drilling system equipment data. For instance, the drawworks may generate data on hook load and line speed, while mud pumps provide pressure and flow rate readings. The top drive may report torque, RPM, and rotational direction, and pipe handlers may log positional data and operational status. Such data is typically collected in real time and monitored through systems like the Electronic Drilling Recorder, enabling an adaptive multi-model power selection apparatus to assess performance, detect anomalies, and make informed decisions to optimize drilling efficiency and safety.

The term “operational drilling system equipment data” refers to any data comprising numbers, text, and/or symbols representing measured, collected, or observed physical characteristics of one or more operational drilling components. Example operational drilling system equipment data may include but is not limited to bit depth data, block movement data, pump related data, stroke counts, weight on bit data, hook load data, candidate generator set data, top drive data, etc. Operational drilling system equipment data may further include operational environmental data representing various environmental conditions relative to the drilling operations. For example, environmental data may include temperatures, humidity, current weather data, weather forecast data, and so on. Operational drilling system equipment data may further include operational location data representing characteristics of the location of the drilling operations. For example, location data may include elevation, latitude, longitude, terrain, biome, etc. Operational drilling system equipment data may further include operational geological data representing characteristics of the geology of the drilling operations. For example, geological data may include crust composition, hardness, strength, pressure, temperature, temperature gradient, and so on.

Operational drilling system equipment data is provided at least by various equipment in the operational drilling component set, as well as by various sensing devices distributed throughout the subterranean drilling system. In some embodiments, the operational drilling system equipment data is transmitted to a rig controller and/or data recorder. In some embodiments, the operational drilling system equipment data is collected and stored by an EDR.

The term “candidate generator set” refers to a group of power generators that are electrically connected to and available to supply the operating power for a subterranean drilling system. The generators comprising the candidate generator set may be diesel or gas-powered and are configured to operate either individually or in combination, depending on the real-time power demands of the drilling operation.

Well plans executed by the adaptive multi-model power selection apparatus may comprise multiple drilling system operation periods and the power demand of the subterranean drilling system may vary among such drilling system operation periods. Accordingly, the power generators may be selectively enabled or disabled by an adaptive power generator selection model to optimize fuel efficiency, reduce emissions, reduce wear, and/or ensure redundancy in case of equipment failure. Utilizing a set of power generators enables a modular approach, allowing the drilling system to maintain continuous operation while adapting to varying load conditions across different drilling phases.

Each power generator in the candidate generator set may contribute to powering the operational drilling component set, which may include high-demand equipment such as mud pumps, top drives, drawworks, and control systems. Dynamically managing which power generators are active ensures that the subterranean drilling system may receive appropriate operating power in a timely manner in response to ever-changing power requirements of the subterranean drilling system. Dynamic management of the candidate generator set enhances operational reliability, supports better maintenance scheduling, and manages energy cost.

The term “candidate generator set data” refers to any data comprising numbers, text, and/or symbols representing measured, collected, or observed physical characteristics of one or more power generators. Candidate generator set data may comprise generator operational data, for example, electrical output of each power generator, total electrical output of the candidate generator set, run time, operational efficiency, maintenance schedules, fuel levels, fuel efficiency, load, internal temperatures, and so on. Candidate generator set data may further comprise generator environmental data, for example, temperatures, humidity, current weather data, weather forecast data, and so on.

The term “adaptive multi-model power selection apparatus” refers to an apparatus that includes one or more processors and associated circuitry. The adaptive multi-model power selection apparatus is communicatively connected to a corresponding subterranean drilling system. The adaptive multi-model power selection apparatus is designed to selectively implement a plurality of machine learning models, including in some embodiments, a power generator capacity prediction model, a power demand prediction model, and/or an adaptive power generator selection model. The adaptive multi-model power selection apparatus is configured to receive operational drilling system equipment data from the operational drilling component set of the corresponding subterranean drilling system, and candidate generator set data from a candidate generator set comprising a plurality of power generators configured to supply operating power to the corresponding subterranean drilling system. Based on the operational drilling system equipment data and the candidate generator set data, the adaptive multi-model power selection apparatus determines which power generators should be enabled to provide the necessary operating power to the drilling components of the subterranean drilling system considering one or more cost-based reduction strategies.

In some embodiments, the adaptive multi-model power selection apparatus may further include various data transformation modules. For example, the adaptive multi-model power selection apparatus may include a power generator data transformation module configured to receive the candidate generator set data from one more power generators of the candidate generator set and prepare the candidate generator set data for processing by a power generator capacity prediction model. Preparing the candidate generator set data for processing may include normalizing data from disparate power generator sources; cleaning data by correcting inconsistent formats and removing extraneous data; detecting outliers and removing or capping such data components; determining and scaling features to ensure equal contribution; and/or preparing a feature vector based on the candidate generator set data.

In some embodiments, the adaptive multi-model power selection apparatus may further include an operational drilling system equipment data transformation model configured to receive operational drilling system equipment data from the operational drilling component set of the corresponding subterranean drilling system and prepare the operational drilling system equipment data for processing by a power demand prediction model. Preparing the operational drilling system equipment data may for processing may include scaling data based on maximum threshold values specific to each component of the operational drilling component set; detecting and removing outlier data components; identifying missing data components and filling missing data based on data interpolation; and/or preparing a feature vector based on the operational drilling system equipment data.

During operation, candidate generator set data for a particular power generator may be transmitted to the anomaly detection model. In an instance in which the particular power generator is classified as a poor performing power generator, the particular power generator may be flagged for maintenance, or otherwise removed from selection as a selected power generator.

The term “power generator capacity prediction model” refers to one or more trained machine learning models configured to receive formatted candidate generator set data and determine a predicted temporal environmental capacity based on the formatted candidate generator set data. The predicted temporal environmental capacity of each power generator may vary across drilling system operation periods during operation of the subterranean drilling system. For example, generator operational data (e.g., electrical output), run time, operational efficiency, weather data, generator maintenance, fuel data, current load, internal temperatures, and so on may cause variations in the power capacity of each power generator of the candidate generator set from one drilling system operation period to the next.

For example, a first set of predicted temporal environmental capacities during a first drilling system operation period may suggest a first power generator has a maximum power capacity of 1100 kilowatts and a second power generator has a maximum power capacity of 900 kilowatts. During a second drilling system operation period, a second set of predicted temporal environmental capacities may suggest the first power generator has a maximum power capacity of 950 kilowatts and the second power generator now has a maximum power capacity of 1100 kilowatts. Accordingly, the power generator capacity prediction model generates a predicted temporal environmental capacity for each power generator during one or more drilling system operation periods.

The power generator capacity prediction model may be trained utilizing a power generator capacity prediction model generation module based on historical generator operational data, historical generator environmental data, and, in some embodiments, corresponding drilling system historical data.

In some embodiments, the power generator capacity prediction may comprise a regression model. In general, a machine learning regression model is designed to learn the relationship between the input features, and generate a model (e.g., mathematical equation) representing the learned relationship. During classification phase, the model receives the formatted candidate generator set data, and other features of the candidate generator set, and determines a predicted temporal environmental capacity based on the model. Further, in some embodiments, the power generator capacity prediction model may comprise an iterative weighted least squares regression (IWLSR) model. Utilizing an IWLSR model enables the adaptive multi-model power selection apparatus to iteratively update the model based on observed capacities. For example, the power generator capacity prediction model may determine a predicted temporal environmental capacity based on the candidate generator set data. The adaptive multi-model power selection apparatus may then observe the actual capacity of the selected power generators. Based on the accuracy of the predicted temporal environmental capacity, the adaptive multi-model power selection apparatus may update the model.

In some embodiments, the adaptive multi-model power selection apparatus may utilize various model verification techniques to verify the performance of the power generator capacity prediction model. For example, a cumulative sum control chart (CUSUM)-based algorithm may monitor the residuals of the power generator capacity prediction model on each new data sample, and trigger a notification in an instance in which the actual performance of the power generator capacity prediction model consistently deviates from the predicted temporal environmental capacity by more than a model error threshold.

In some embodiments, the adaptive multi-model power selection apparatus may further comprise an anomaly detection model.

The term “predicted temporal environmental capacity” refers to a forecast maximum amount of electrical power an associated power generator may produce at a given time (e.g., during a drilling system operation period) based on the candidate generator set data and generator environmental data. The predicted temporal environmental capacity indicates how much load the associated power generator may handle continuously. The capacity of a power generator is variable over time and based on the operating environment of the power generator. The predicted temporal environmental capacity may be utilized to ensure the power demands of the subterranean drilling system are met. For example, the predicted temporal environmental capacity may be utilized by the adaptive power generator selection model to determine a set of selected power generators to enable in order to meet the power demands of the subterranean drilling system. In some embodiments, the predicted temporal environmental capacity may be utilized to derate equipment to overcome power shortfalls when necessary during operation. In some embodiments, the predicted temporal environmental capacity may be used as an indicator of the health of the associated generator.

The predicted temporal environmental capacity is generated by the power generator capacity prediction model based on the candidate generator set data and corresponding generator environmental data. In some embodiments, the adaptive multi-model power selection apparatus may leverage rate-of-change filtering techniques to filter generated predicted temporal environmental capacity predictions. For example, the adaptive multi-model power selection apparatus may compare the current predicted temporal environmental capacity value for a particular power generator with the previous predicted temporal environmental capacity value for the particular power generator. In an instance in which the rate-of-change exceeds a threshold value, the predicted temporal environmental capacity may be indicated as invalid.

The term “power generator capacity prediction model generation module” refers to any system, subsystem, unit, or other component configured to generate, train, and tune a power generator capacity prediction model based on historical generator data, and corresponding drilling system historical data. The power generator capacity prediction model generation module initially defines the model based on the model architecture or algorithm, for example, a linear regression model. The power generator capacity prediction model generation module may then train the power generator capacity prediction model based on stored historical data. For example, in some embodiments, the power generator capacity prediction model generation module may access historical generator operational data, historical generator environmental data, and/or corresponding drilling system historical data to generate hyperparameters of the power generator capacity prediction model. The power generator capacity prediction model generation module may further fine tune hyperparameters based on continuously received labeled data.

In some embodiments, the power generator capacity prediction model generation module may tune and re-tune the power generator capacity prediction model during operation based on observed capacities of the power generators relative to predicted temporal environmental capacities for the power generators.

In some embodiments, the power generator capacity prediction model generation module may utilize a power generator data transformation module to filter, clean, reformat, and otherwise prepare data for processing in the power generator capacity prediction model.

The term “model verification technique” refers to any techniques utilized to verify the accuracy of a machine learning model, for example, the power generator capacity prediction model and/or the power demand prediction model. One example model verification technique is a CUSUM-based change detection. CUSUM-based change detection is a statistical method used to identify shifts or changes in the mean level of the machine learning model predictions over time. A CUSUM-based change detection algorithm works by cumulatively summing deviations of observed values from a target value or mean. Accumulating deviations enables the adaptive multi-model power selection apparatus to detect small and gradual changes in the accuracy of a machine learning model that may not be obvious.

The term “shared power generator capacity prediction model" refers to one or more power generator capacity prediction models accessible to and/or stored by the adaptive multi-model power selection apparatus in a power generator capacity prediction model storage. In some embodiments, the adaptive multi-model power selection apparatus may train and store a power generator capacity prediction model based on various operational parameters. For example, a first power generator capacity prediction model may be trained for normal operation of a subterranean drilling system, while a second power generator capacity prediction model is trained for derated operation, wherein one or more components of the operational drilling component set are derated.

Shared power generator capacity prediction models may be utilized during initialization of a new subterranean drilling system, during initial validation of a power generator capacity prediction model, and/or in an instance in which a current power generator capacity prediction model is ineffective. In one non-limiting example, a shared power generator capacity prediction model may be utilized upon detection of a sudden change in state at the adaptive multi-model power selection apparatus. Using a shared power generator capacity prediction model upon detection of a sudden change in state may enable the system to quickly adapt to sudden changes without waiting for additional training data and updated models. In this way, shared power generator capacity prediction models provide additional safety at subterranean drilling systems by adapting faster to changes in conditions.

During operation, each shared power generator capacity prediction model may be evaluated based on current candidate generator set data and a predicted temporal environmental capacity generated by each shared power generator capacity prediction model. For example, the adaptive multi-model power selection apparatus may determine a prediction error by comparing the predicted temporal environmental capacity of a shared power generator capacity prediction model with an observed capacity of the corresponding power generator. The shared power generator capacity prediction model whose predicted temporal environmental capacity results in the smallest prediction error may be selected for use as the power generator capacity prediction model.

The term “anomaly detection model” refers to a machine learning model trained to classify a performance of a particular power generator, for example, as poor performance or high performing. In some embodiments, well-performing or optimal-performance power generators may be identified. The candidate generator set data associated with each of the well-performing or optimal-performance power generators may be used to train the anomaly detection model to recognize a well-performing or optimal-performance power generator, and conversely, identify and detect a poor performing power generator. In this way, poor performing power generators may be identified for prescriptive maintenance based on the data signature of the candidate generator set data associated with the poor performing power generator or otherwise removed from selection as a selected power generator.

The term “power generator data transformation module” refers to any system, subsystem, unit, or other component configured to receive candidate generator set data from the candidate generator set and generate formatted candidate generator set data prepared for processing by a power generator capacity prediction model. The power generator data transformation model may be used in conjunction with the power generator capacity prediction model generation module during a training phase and/or in conjunction with the power generator capacity prediction model during the classification phase of the machine learning model.

In general, the candidate generator set data may be cleaned through various data preparation methods. Preparing the candidate generator set data for processing may include correcting inconsistent formats and removing extraneous data; detecting outliers and removing or capping such data components; determining and scaling features to ensure equal contribution; and/or preparing a feature vector based on the candidate generator set data.

In addition, the power generator data transformation module may be configured to identify the minimum amount of data required to ensure model stability, which is critical for real-time machine learning algorithms. In some embodiments, the power generator data transformation module works by binning incoming data into predefined ranges that capture meaningful variance based on load. By binning incoming data into predefined ranges, the power generator data transformation model may ensure a meaningful variance of data. A meaningful variance in data may help the model to converge faster and more reliably. Such an approach ensures the model is trained on data that best represents stable and predictable behavior.

In some embodiments, once prepared, the candidate generator set data may be normalized through feature scaling to ensure consistent input for model training and classification.

The term “power demand prediction model” refers to one or more trained machine learning models configured to receive formatted operational drilling system equipment data, operational environmental data, operational location data, and/or operational geological data, and determine a predicted temporal environmental power demand based on the received operational data. The power demand prediction model may be trained utilizing a power demand prediction model generation module based on historical operational drilling system equipment data, historical operational environmental data, historical operational location data, and/or historical operational geological data.

In some embodiments, the power demand prediction model may comprise a neural network model, for example, a recurrent neural network model, or in some embodiments, a bi-directional neural network model. In general, a neural network mimics the structure of the human brain by using layers of interconnected nodes to process the input data. The neural network learns patterns by adjusting the weights of the connections during training, enabling the neural network to make predictions or classifications based on new data. A recurrent neural network is designed to process sequential data by maintaining a memory of previous inputs through internal loops. The ability to retain and use past information helps an RNN to model temporal or ordered relationships in data. In a bi-directional RNN, the model processes data in both forward and backward directions, allowing it to capture context from both past and future time steps, which improves performance on tasks like sequence prediction.

In some embodiments, the adaptive multi-model power selection apparatus may utilize various model verification techniques to verify the performance of the power demand prediction model. For example, a cumulative sum control chart (CUSUM)-based algorithm may monitor the residuals of the power demand prediction model on each new data sample, and trigger a notification in an instance in which the actual performance of the power demand prediction model consistently deviates from the predicted temporal environmental power demand by more than a model error threshold.

The term “power demand prediction model generation module” refers to any system, subsystem, unit, or other component configured to generate, train, and tune a power demand prediction model based on historical operational data. The power demand prediction model generation module initially defines the model based on the model architecture or algorithm, for example, a neural network model. The power demand prediction model generation module may then train the power demand prediction model based on stored historical operational data. For example, in some embodiments, the power demand prediction model generation module may access historical operational drilling system equipment data, historical operational environmental data, historical operational location data, and/or historical operational geological data and known input labels to learn patterns and relationships through multiple iterations of labeled data. During training, the power demand prediction model generation module adjusts internal weights using optimization algorithms like gradient descent to minimize the difference between the predictions and the actual outcomes. The power demand prediction model generation module may further fine tune weights of the neural network based on continuously received labeled data.

In some embodiments, the power demand prediction model generation module may tune and re-tune the power demand prediction model during operation based on observed power demand of the subterranean drilling system relative to the predicted temporal environmental power demand for the subterranean drilling system.

In some embodiments, the power demand prediction model generation module may utilize an operational drilling system equipment data transformation module to filter, clean, reformat, and otherwise prepare data for processing in the power demand prediction model.

The term “predicted temporal environmental power demand” refers to a forecast time-varying power requirement of a subterranean drilling system during a drilling system operation period based on the operational drilling system equipment data, environmental, location, and geological data associated with the subterranean drilling system. The predicted temporal environmental power indicates how much load the associated subterranean drilling system may require for operating over a drilling system operation period.

The power demand of a subterranean drilling system varies over time due to several dynamic factors. Subterranean drilling system components may have varying power demands based on instantaneous operational efficiency, maintenance, wear, and so on. Weather conditions like extreme heat or cold, humidity, and so on, may affect tool efficiency and component power needs. Geographic location, elevation, latitude, longitude, terrain, biome, etc. may affect power demands of the subterranean drilling system. Geological conditions, such as rock hardness, formation pressure, crust composition, strength, temperature, temperature gradient, and so on impact the load on drilling equipment and thus power demands. Additionally, the type and sequence of equipment operations (e.g., tripping, drilling, or casing) cause fluctuations in power demand as different systems are engaged or idled.

The predicted temporal environmental power demand is generated by the power demand prediction model based on the operational drilling system equipment data, the operational environmental data, the operational location data, and/or the operational geological data. In some embodiments, the adaptive multi-model power selection apparatus may leverage rate-of-change filtering techniques to filter generated predicted temporal environmental power demand predictions. For example, the adaptive multi-model power selection apparatus may compare the current predicted temporal environmental power demand value for a particular drilling system operation period with the predicted temporal environmental power demand value for the same drilling system operation period. In an instance in which the rate-of-change exceeds a threshold value, the predicted temporal environmental power demand may be indicated as invalid.

The term “drilling system operation period” refers to a defined span of time during which the power demand of a subterranean drilling system is predicted. During the drilling system operation period, the power demand prediction model may predict power requirements based on ongoing drilling activities, equipment usage, environmental conditions, location, geology, and other factors. Determining the power demand of the subterranean drilling system during the drilling system operation period helps optimize power allocation and improve operational efficiency. In some embodiments, the predicted temporal environmental power demand may be provided at regular intervals within the drilling system operation period. For example, the predicted temporal environmental power demand may be specified at every five seconds within the drilling system operation period. In some embodiments, the drilling system operation period may be ten minutes.

The term “operational drilling system equipment data transformation module” refers to any system, subsystem, unit, or other component configured to receive operational drilling system equipment data from the operational drilling component set of a subterranean drilling system and generate formatted operational drilling system equipment data prepared for processing by a power demand prediction model. The operational drilling system equipment data transformation model may be used in conjunction with the power demand prediction model generation module during a training phase and/or in conjunction with the power demand prediction model during the classification phase of the machine learning model.

In general, the operational drilling system equipment data may be cleaned through various data cleaning methods. Preparing the operational drilling system equipment for processing may include correcting inconsistent formats and removing extraneous data; detecting outliers and removing or capping such data components; determining and scaling features to ensure equal contribution; and/or preparing a feature vector based on the candidate generator set data.

In some embodiments, once prepared, the operational drilling system equipment data may be normalized through feature scaling to ensure consistent input for model training and classification.

The term “adaptive power generator selection model” refers to one or more trained machine learning models configured to receive the predicted temporal environmental capacity for each of the power generators in the candidate generator set, the predicted temporal environmental power demand for the corresponding subterranean drilling system, and/or the power demand of the subterranean drilling system, and determine a selected power generator signal, a subset of power generators of the candidate generator set, to provide operating power to the subterranean drilling system in accordance with a cost-based reduction strategy. For example, the adaptive multi-model power selection apparatus may implement a cost-based reduction strategy to reduce one or more cost-based functions. Non-limiting examples of cost-based functions include fuel consumption cost, emissions cost, etc.

The adaptive power generator selection model may utilize any machine learning model architecture configured for generating an optimized selection based on one or more cost-based functions. For example, the adaptive power generator selection model may utilize one or more neural networks, support vector machines, linear regression models, reinforcement learning models, and so on.

During a training phase, the adaptive power generator selection model generates a mathematical model based on the selected machine learning structure. Various parameters of the mathematical model are adjusted, weighted, and/or tuned based on learned relationships between the input data and one or more cost functions. In some embodiments, the adaptive power generator selection model may be trained to maximize or minimize one or more cost-based functions. For example, the adaptive power generator selection model may be trained to maximize efficiency, minimize fuel consumption, minimize maintenance costs, maximize reliability, minimize emissions, and/or minimize uneven wear distribution of power generators.

During a classification phase, the adaptive power generator selection model is configured to generate a selected power generator set comprising one or more power generators based on the predicted temporal environmental capacity for each power generator, the candidate generator set data, the predicted temporal environmental power demand, and one or more cost factors. Cost factors may include maximizing efficiency, minimizing fuel consumption, minimizing maintenance costs, maximizing reliability, minimizing emissions, and/or minimizing uneven wear distribution of power generators.

The term “cost-based reduction strategy” refers to any strategy employed by the adaptive power generator selection model configured to represent one or more parameters of the subterranean drilling system with a cost function and to select one or more selected power generators to reduce the cost function. Various cost functions may include: a generator cost favoring fewer running power generators to optimize fuel efficiency; capacity cost configured to maximize generator load favoring higher utilization of fewer generators; hour cost configured to reduce excessive start and stop cycles by penalizing high cycle count generators; temperature cost configured to penalize overheating generators; steady-state cost configured to select a combination of power generators to remain stable and prevent unnecessary switching; and total cost configured to select power generators to minimize the overall cost of all of the above costs.

The term “historical data” refers to any stored data that is collected over time and associated with various drilling activities, with various well plans, at various locations, in various environmental conditions, and with various geological conditions. The historical data may be utilized to determine relationships between the various components of the subterranean drilling system, as well as environmental conditions, and locations, and train a plurality of machine learning models to select power generators in accordance with one or more cost-based reduction strategies. Historical data may include at least historical generator operational data, historical generator environmental data, corresponding drilling system historical data, historical operational environmental data, historical operational drilling system geological data, and historical operational drilling system location data.

The term “historical generator operational data” refers to any stored data comprising numbers, text, and/or symbols representing measured, collected, or observed physical characteristics of one or more power generators collected over time. The historical generator operational data may be associated with various power generators, combined in various candidate generator sets, in support of various drilling and non-drilling activities, in various environmental conditions and locations, and various subterranean drilling system setups. In some non-limiting examples, historical generator operational data may include but is not limited to historical electrical output of each power generator, historical total electrical output of an associated candidate generator set, historical run times of a power generator, historical operational efficiency, historical maintenance schedules, historical fuel levels, historical fuel efficiency, historical measured load, historical internal temperatures, and so on.

The term “historical generator environmental data” refers to any stored data comprising numbers, text, and/or symbols representing measured, collected, or observed physical characteristics of environmental data collected in connection with generator operational data of one or more power generators collected over time. The historical generator environmental data may be associated with various power generators, combined in various candidate generator sets, in support of various drilling and non-drilling activities, in various environmental conditions and locations, and various subterranean drilling system setups. In some non-limiting examples, historical generator environmental data may include but is not limited to environmental temperatures, humidity, associated weather data, and so on.

The term “corresponding drilling system historical data” refers to any stored data comprising numbers, text, and/or symbols representing measured, collected, or observed physical characteristics of a drilling system correlated with a power generator or candidate generator set, and collected in connection with generator operational data. The corresponding drilling system historical data may be associated with various subterranean drilling systems in support of various drilling and non-drilling activities, in various environmental conditions and locations. In some non-limiting examples, corresponding drilling system historical data may include but is not limited to bit depth data, block movement data, pump related data, stroke counts, weight on bit data, hook load data, candidate generator set data, top drive data, etc.

The term “historical operational drilling system equipment data” refers to any stored data comprising numbers, text, and/or symbols representing measured, collected, or observed physical characteristics of a subterranean drilling system. The historical operational drilling system equipment data may be associated with various subterranean drilling systems in support of various drilling and non-drilling activities, in various environmental conditions and locations, operating in various geological conditions. In some non-limiting examples, the historical operational drilling system equipment data may include but is not limited to historical bit depth data, historical block movement data, historical pump related data, historical stroke counts, historical weight on bit data, historical hook load data, historical candidate generator set data, historical top drive data, etc.

The term “historical operational environmental data” refers to any stored data comprising numbers, text, and/or symbols representing measured, collected, or observed physical characteristics of an environment proximate an operating subterranean drilling system. The historical operational environmental data is associated with historical operational drilling system equipment data. The historical operational environmental data may be associated with various subterranean drilling systems in support of various drilling and non-drilling activities, in various environmental conditions and locations, operating in various geological conditions. In some non-limiting examples, historical operational environmental data may include but is not limited to environmental temperatures, humidity, associated weather data, and so on.

The term “historical operational drilling system geological data” refers to any stored data comprising numbers, text, and/or symbols representing measured, collected, or observed geological characteristics of a site at or near an operating subterranean drilling system. The historical operational environmental data is associated with historical operational drilling system equipment data. The historical operational drilling system geological data may be associated with various subterranean drilling systems in support of various drilling and non-drilling activities, in various environmental conditions and locations, operating in various geological conditions. In some non-limiting examples, historical operational drilling system geological data may include but is not limited to crust composition, hardness, strength, pressure, temperature, temperature gradient, and so on.

The term “historical operational drilling system location data” refers to any stored data comprising numbers, text, and/or symbols representing measured, collected, or observed location characteristics of a site at or near an operating subterranean drilling system. The historical operational drilling system location data is associated with historical operational drilling system equipment data. The historical operational drilling system location data may be associated with various subterranean drilling systems in support of various drilling and non-drilling activities, in various environmental conditions and locations, operating in various geological conditions. In some non-limiting examples, historical operational drilling system location data may include but is not limited to location, elevation, latitude, longitude, terrain, biome, etc. may affect power demands of the subterranean drilling system.

The term “power consumption equipment” refers to any equipment, tools, or other mechanical or electrical equipment that require electrical energy to perform an intended function. In some embodiments, power consumption equipment may be combined to work in coordination to perform a complex task, such as operating a ship, or power an off-grid facility. The amount of power required by power consumption equipment may vary over a power operation period. For example, different tasks performed by different power consumption equipment may require different amounts of power. Or the same task performed in a different environment may require a different amount of power. Example power consumption equipment may include but is not limited to propulsion system components, such as propulsion motors and thrusters; heating and cooling system components; pump systems; compressor systems; hydraulic systems; lighting systems; navigation equipment; control systems; cargo handling equipment; medical equipment in a remote medical facility; refrigeration systems; heating, ventilation, and air conditioning systems (HVAC); air purification systems; water and sanitation systems; technology and communications systems; surveillance systems; security systems; data centers; and so on.

The term “power consumption equipment data” refers to any measurable or descriptive information related to the power demand of power consumption equipment. Power consumption equipment data may include, but is not limited to, real-time and historical power usage metrics (such as voltage, current, and power draw), operational status, equipment type and function, load profiles, efficiency ratings, and environmental or contextual factors influencing performance. Such data provides critical insight into the contribution of the power consumption equipment to the overall system power demand, enabling more accurate forecasting of power demand in dynamically powered environments.

The term “marine vessel” refers to any waterborne transport platform designed to carry cargo across oceans and waterways. Marine vessels typically operate independently for extended periods and require robust, reliable power systems to support propulsion, navigation, cargo handling, communication, environmental control, and onboard living systems. To meet diverse and dynamic power demands, a marine vessel is equipped with a candidate generator set comprising a plurality of power generators. Each generator in the set may vary in capacity, efficiency, and operational condition, and may be selectively engaged based on real-time power demand, environmental conditions, fuel availability, and maintenance status.

The term “off-grid facility" refers to any physical location, infrastructure, or operational site that functions independently of centralized electrical power grids. Off-grid facilities rely on self-contained energy systems such as power generators, solar panels, wind turbines, hydroelectric systems, or hybrid configurations to meet their electrical power needs. Off-grid facilities are commonly situated in remote, inaccessible, or undeveloped regions where connection to a public utility grid is impractical, unavailable, or cost-prohibitive.

Examples of off-grid facilities include, but are not limited to, isolated communities, military installations, scientific research stations, resource exploration sites, and emergency response camps. These facilities often experience variable and unpredictable power demands due to environmental conditions, operational schedules, equipment usage, and occupancy levels.

To meet power demands, off-grid facilities may utilize a candidate power generator set, comprising a plurality of power generators that can be selectively activated or deactivated based on real-time power requirements.

The term “adaptive multi-model power selection insight interface” refers to any user-facing graphical user interface displayed by a client computing device and configured to display components of an adaptive multi-model power selection apparatus. Various components may include selected generators, generator efficiency, generator utilization, run time, engine status, cycle count, temperature, and so on.

An adaptive multi-model power selection insight interface may further provide interactive elements enabling user interaction with the adaptive multi-model power selection apparatus and underlying back-end graphical model. User interaction may include touch screen engagement, mouse manipulation, keyboard commands, or other similar input techniques to initiate action relative to the adaptive multi-model power selection apparatus. For example, in some embodiments, a user may touch switch of a power generator of a candidate generator set to override the selection of the power generator from the adaptive power generator selection model.

The terms “trained machine learning model,” “machine learning model,” “model,” or “one or more models” refer to a machine learning or deep learning task or mechanism. Machine learning is a method used to devise complex models and algorithms that lend themselves to prediction. A machine learning model is a computer-implemented algorithm that may learn from data with or without relying on rules-based programming. These models enable reliable, repeatable decisions and results and uncovering of hidden insights through machine-based learning from historical relationships and trends in the data. In some embodiments, the machine learning model is a clustering model, a regression model, a neural network, a random forest, a decision tree model, a classification model, or the like.

A machine learning model is initially fit or trained on a training dataset (e.g., a set of examples used to fit the parameters of the model). The model may be trained on the training dataset using supervised learning or unsupervised learning. The model is run with the training dataset and produces a result, which is then compared with a target, for each input vector in the training dataset. Based on the result of the comparison and the specific learning algorithm being used, the parameters of the model are adjusted. The model fitting may include both variable selection and parameter estimation. Successively, the fitted model is used to predict the responses for the observations in a second dataset called the validation dataset. The validation dataset provides an unbiased evaluation of a model fit on the training dataset while tuning the hyperparameters of the model (e.g., the number of hidden units in a neural network).

In some embodiments, the model can be pre-trained and/or trained in real-time (e.g., online training) while in use. For example, a machine learning model may be trained based on reinforcement learning. A reinforcement learning model may receive rewards or penalties based on actions taken or predictions. Reinforcement learning is based on rewarding desired behaviors and punishing undesired ones. A reinforcement learning model is configured over time to perform actions that lead to maximum reward. A reinforcement learning model includes an agent configured to take actions, receive rewards based on the actions, and update the machine learning model to maximize the received reward.

The machine learning models, one or more models, and trained machine learning models may make use of multiple ML engines, e.g., for analysis, recommendation generating, transformation, and other needs. The system may train different ML models for different needs and different ML-based engines. The system may generate new models (based on the gathered training data) and may evaluate their performance against the existing models. Training data may include any of the gathered information, as well as information on actions performed based on the various recommendations.

The ML models may be any suitable model for the task or activity implemented by each ML-based engine. Machine learning models are known in the art and are typically some form of neural network. The term refers to the ability of systems to recognize patterns on the basis of existing algorithms and data sets to provide solution concepts. The more they are trained, the greater knowledge they develop. The underlying ML models may be learning models (supervised or unsupervised). As examples, such algorithms may be prediction (e.g., linear regression) algorithms, classification (e.g., decision trees, k‐nearest neighbors) algorithms, time‐series forecasting (e.g., regression‐based) algorithms, association algorithms, clustering algorithms (e.g., K-means clustering, Gaussian mixture models, DBscan), Bayesian methods (e.g., Naïve Bayes, Bayesian model averaging, Bayesian adaptive trials), image to image models (e.g., FCN, PSPNet, U-Net), sequence to sequence models (e.g., RNNs, LSTMs, BERT, Autoencoders), or generative models (e.g., GANs).

Alternatively, ML models may implement statistical algorithms, such as dimensionality reduction, hypothesis testing, one-way analysis of variance (ANOVA) testing, principal component analysis, conjoint analysis, neural networks, support vector machines, decision trees (including random forest methods), ensemble methods, and other techniques. Other ML models may be generative models (such as Generative Adversarial Networks or auto-encoders) to generate definitions and elements.

In various embodiments, the ML models may undergo a training or learning phase before they are released into a production, runtime, or classification phase. During a training or learning phase, the ML models may be tuned to focus on specific variables, to reduce error margins, or to otherwise optimize their performance. The ML models may initially receive input from a wide variety of data, such as the gathered data described herein.

The terms “classifier algorithm” or “classification algorithm” refer to a classifier algorithm which estimates a classification model from a set of training data. The “classifier algorithm” uses one or more classifiers and an associated algorithm to determine a probability or likelihood that a set of data belongs to another set of data. A decision tree model where a target variable can take a discrete set of values is called a classification tree (and therefore can be considered a classifier or classification algorithm).

The terms “supervised model” and “predictive model” refer to a supervised model, which is an estimate of a mathematical relationship in which the value of a dependent variable is calculated from the values of one or more independent variables. The functional form of the relationship is determined by the specific type (e.g., decision tree, Generalized Linear Model, gradient boosted trees) of supervised model. Individual numeric components of the mathematical relationship are estimated based on a set of training data. The set of functional forms and numerical estimates a specific type of supervised model can represent is called its “hypothesis space”.

The term “feature vector” refers to an n-dimensional vector of features that represent an object. N is a number. Many algorithms in machine learning require a numerical representation of objects, and therefore the features of the feature vector may be numerical representations.

### Example Subterranean Drilling System

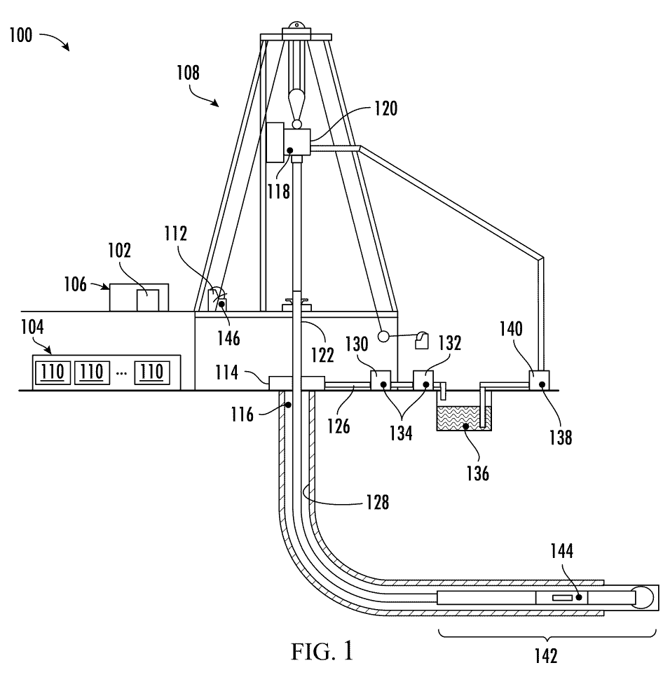

FIG. 1 illustrates a schematic diagram of an example subterranean drilling system 100. As depicted in FIG. 1, the example subterranean drilling system 100 comprises a subterranean drilling rig 108, a candidate generator set 104, and a rig controller 106.

The example subterranean drilling rig 108 includes an integrated operational drilling component set, each associated with a time-varying load demand. For example, the depicted operational drilling component set of the subterranean drilling rig 108 includes the top drive 120, the drawworks 112, the rotating control device 114, the wellbore 128, the bottom-hole assembly 142, mud pumps 140, pipe handler, etc. The depicted operational drilling component set works together to enable the depicted example subterranean drilling rig 108 to penetrate geological formations. Each component of the depicted operational drilling component set requires operating power to operate effectively, which is typically supplied by one or more power generators 110 from the candidate generator set 104. Depending on the energy demands of the drilling operation, one or multiple power generators 110 may be enabled at a time, allowing for flexible and efficient power management across various drilling phases.

The top drive 120 provides rotational force to the drill string to turn the bottom-hole assembly 142 in the wellbore 128. The top drive 120 requires a consistent and robust power supply to maintain drilling precision and stability. The power requirements of the top drive 120 may vary based on drilling depth, rock formation hardness, drilling speed, mud flow, pressure, and other variable conditions.

The drawworks 112 are primarily responsible for lifting and lowering the drill string of the subterranean drilling rig 108. The drawworks 112 can demand substantial power to handle heavy loads safely. The power requirements of the drawworks 112 may vary based on load weight, drilling depth, hoisting speed, and numerous other parameters.

The turntable 122 transfers torque to the drill pipe, causing the drill bit of the bottom-hole assembly 142 to rotate and cut through the earth. The turntable 122 may also support the weight of the drill string. In addition, the turntable 122 maintains alignment and stability of the drill string.

Mud pumps 140 are used to circulate drilling fluids. The mud pumps 140 may provide drilling fluid to the wellbore 128 at sufficient pressure and flow rates to cool and lubricate the drill bit while stabilizing the borehole. The power requirements of the mud pumps 140 may vary based on flow rate, pump pressure, drilling speed, mud viscosity, formation conditions, temperature control, and the like. The mud pumps 140 are configured to draw drilling fluid from a mud pit. The mud pit may be filled with drilling fluid returned from the wellbore. As depicted in FIG. 1, the example subterranean drilling rig 108 further includes a shaker 130 and fluid treatment equipment 132. The shaker 130 receives drilling fluid on a return line 126 and separates large solids (e.g., cuttings) from the return drilling fluid to help prevent clogging and wear in downstream equipment. The fluid treatment equipment 132 is configured to further filter the drilling fluid, for example, by removing sand, silt, and other particles in the drilling fluid.

The bottom-hole assembly 142 of the subterranean drilling rig 108 comprises the section of the drill string located at the very bottom of the wellbore 128, designed to guide and facilitate the drilling process. The bottom-hole assembly 142 typically includes components like the drill bit, stabilizers, mud motors, measurement-while-drilling tools, and drilling sensing devices 144. The electronic components of the bottom-hole assembly 142 may require a power supply provided through the drill string to collect and send real-time data to the surface.

The example subterranean drilling system 100 further includes a plurality of sensing devices that are configured to generate operational drilling system equipment data, including but not limited to, a top drive sensing device 118, a drawworks sensing device 146, fluid treatment sensing devices 134, mud pit sensing devices 136, mud pump sensing devices 138, wellbore sensing devices 116, and drilling sensing devices 144.

This operational drilling system equipment data generated by the depicted subterranean drilling system 100 may include but is not limited to bit depth data, block movement data, pump related data, stroke counts, weight on bit data, hook load data, candidate generator set data, top drive data, torque measurements, rotational speed, mud flow rates, pressure readings, temperature data, vibration measurements, and electrical characteristics of various components. The operational drilling system equipment data may further include operational environmental data representing various environmental conditions relative to the drilling operations, such as temperatures, humidity, current weather data, weather forecast data, and so on. Additionally, the operational drilling system equipment data may include operational location data representing characteristics of the location of the drilling operations, such as elevation, latitude, longitude, terrain, biome, etc., and operational geological data representing characteristics of the geology of the drilling operations, including crust composition, hardness, strength, pressure, temperature, temperature gradient, and so on.

In some embodiments, one or more of the sensing devices on the subterranean drilling rig 108 are communicatively connected to the rig controller 106. Electronic communications between the sensing devices of the subterranean drilling rig 108 and the various sensing devices may occur through a wired communication protocol over a wired connection, a wireless communication protocol over a wireless connection, or other communication means.

Each component in the operational drilling component set may also be a source of different subsets of operational drilling system equipment data. For instance, the drawworks 112 may generate data on hook load and line speed, while mud pumps 140 provide pressure and flow rate data. The top drive 120 may report torque, RPM, and rotational direction, and pipe handlers may log positional data and operational status. Such operational drilling system equipment data is typically collected in real time and monitored through systems like the Electronic Drilling Recorder, as discussed herein, enabling an adaptive multi-model power selection apparatus to assess performance, detect anomalies, and make informed decisions to optimize drilling efficiency and safety.

In some embodiments, the rig controller 106 may comprise a data recorder 102. A data recorder 102 plays a central role in capturing and logging data from the operational drilling component set. The data recorder 102 continuously collects operational drilling system equipment data, including parameters such as torque, mud flow rate, rotational speed, bit depth data, block movement data, pump related data, stroke counts, weight on bit data, hookload data, candidate generator set data, top drive data, and so on. By analyzing trends and anomalies in the collected operational drilling system equipment data, the rig controller 106 may make informed decisions, adjust operational parameters, and prevent potential failures, thereby improving the overall efficiency and reliability of the drilling process. In some embodiments, the data recorder 102 may comprise an Electronic Drilling Recorder.

While the depicted subterranean drilling system 100 is illustrated as a ground-based drilling operation, various embodiments of the adaptive multi-model power selection apparatus may be applied to other types of off-grid facilities. For example, the adaptive multi-model power selection apparatus may be implemented on subterranean drilling systems supported by marine vessels, where the operational drilling component set and candidate generator set are deployed on floating platforms or ships. In such marine-based implementations, the power consumption equipment may include additional marine systems such as vessel positioning equipment, ballast control systems, and marine-specific safety equipment, while the operational drilling system equipment data may further incorporate marine environmental sensor data such as wave condition data, vessel motion data, and salt air exposure. The adaptive multi-model power selection apparatus may also be deployed at other off-grid facilities requiring dynamic power management, where the principles of predicting temporal environmental capacity of power generators and determining selected power generators based on cost-based reduction strategies remain applicable across various operational environments and power consumption equipment configurations.

### Example System Architecture

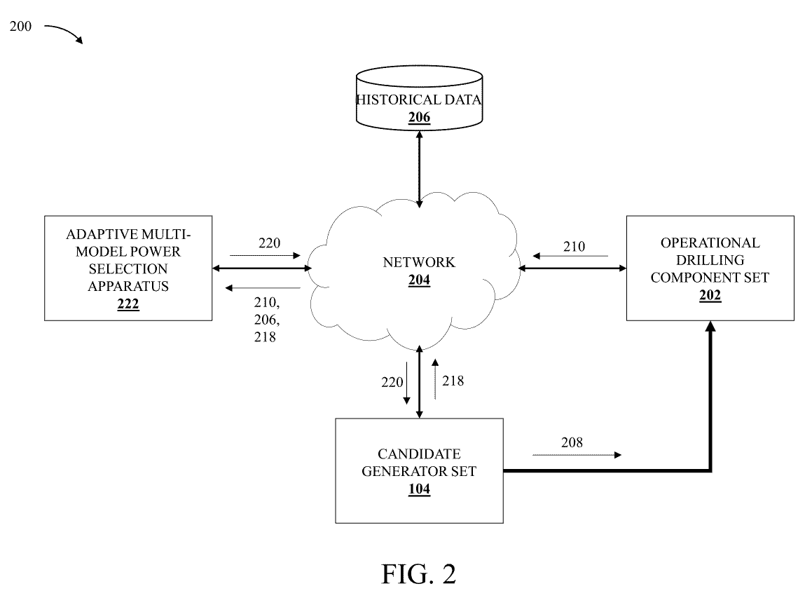

FIG. 2 illustrates an example block diagram of an example subterranean drilling system 200. The example subterranean drilling system 200 includes an adaptive multi-model power selection apparatus 222, access to stored historical data 206, candidate generator set 104, and operational drilling component set 202, each configured to communicate over a network 204. In addition, the candidate generator set 104 is further configured to generate operating power 208 provided to the operational drilling component set 202.

As depicted in FIG. 2, the subterranean drilling system 200 includes a network 204. The adaptive multi-model power selection apparatus 222, stored historical data 206, candidate generator set 104, and operational drilling component set 202 may be in communication using the network 204. The network 204 may include any wired or wireless communication network including, for example, a wired or wireless local area network (LAN), personal area network (PAN), metropolitan area network (MAN), wide area network (WAN), the like, or combinations thereof, as well as any hardware, software and/or firmware required to implement the network 204 (e.g., network routers, etc.). For example, the network 204 may include a cellular telephone, an 802.11, 802.16, 802.20, and/or WiMAX network. Further, the network 204 may include a public network, such as the Internet, a private network, such as an intranet, or combinations thereof, and may utilize a variety of networking protocols now available or later developed including, but not limited to Transmission Control Protocol/Internet Protocol (TCP/IP) based networking protocols. In some embodiments, the protocol is a custom protocol of JavaScript Object Notation (JSON) objects sent via a WebSocket channel. In some embodiments, the protocol is JSON over RPC, JSON over REST/HTTP, the like, or combinations thereof.

As depicted in FIG. 2, the subterranean drilling system 200 includes an operational drilling component set 202. An operational drilling component set 202 refers to any equipment, tools, or other mechanical or electrical equipment that make up the subterranean drilling system 200. The operational drilling component set 202 is configured to receive operating power 208 from one or more power generators of the candidate generator set 104. The components of the operational drilling component set 202 work in coordination to perform the complex task of drilling into the subsurface of the Earth to access oil and gas reserves. Key components include the drawworks, which control the hoisting and lowering of the drill string; mud pumps, which circulate drilling fluid to cool the drill bit and carry cuttings to the surface; top drives, which provide rotational force to the drill string; and pipe handlers, which automate the movement and connection of drill pipe segments. Additional components such as the rotating control device, wellbore, and bottom-hole assembly are also integral to the drilling operation, contributing to pressure control, structural integrity, and directional drilling capabilities.

The power requirements of each component of the operational drilling component set 202 may vary dynamically based on factors such as operating time, environmental conditions, terrain, geographic location, and subsurface formation characteristics. For example, drilling through hard rock formations may demand higher torque from the top drive and increased pressure from the mud pumps, while operations in offshore or high-altitude environments may require specialized power management. In addition, different stages of a well plan executed by the adaptive multi-model power selection apparatus may require varying amounts of operating power due to the distinct demands of each phase. For example, stages such as spudding, vertical drilling, directional drilling, casing, and completion each involve different equipment loads, operational intensities, and environmental conditions. As a result, the power demand of the subterranean drilling system may fluctuate across these drilling system operation periods.

These variations necessitate a flexible and intelligent approach to power distribution. Thus, the adaptive multi-model power selection apparatus 222 is configured to determine the real-time power demand of the operational drilling component set 202 and select power generators from the candidate generator set 104 to provide operating power 208 based on one or more cost-based reduction strategies.

Each component in the operational drilling component set 202 may also be a source of operational drilling system equipment data 210. For instance, the drawworks may generate data on hook load and line speed, while mud pumps provide pressure and flow rate readings. The top drive may report torque, RPM, and rotational direction, and pipe handlers may log positional data and operational status. Such data may be collected in real time and monitored through systems like a data recorder on the subterranean drilling system 200 (e.g., data recorder 102).

Each component of the operational drilling component set 202 may collect and transmit operational drilling system equipment data 210. The data produced by components within the operational drilling component set 202 may vary significantly across several dimensions. For example, periodicity may differ depending on the function and criticality of the equipment. Some components, like mud pumps or top drives, may generate high-frequency, real-time telemetry, while others, such as pipe handlers, may produce event-based or intermittent data. Formatting or data schemas may also vary, with outputs ranging from structured numerical logs (e.g., RPM, pressure, torque) to unstructured status messages or alerts. Additionally, units of measurement may differ across components and systems, such as psi for pressure, feet or meters for depth, and degrees for angular orientation, requiring normalization for integrated analysis. Further, error rates within the operational drilling system equipment data 210 may dictate how the data is filtered and analyzed. Each operational drilling component of the operational drilling component set 202 may be further configured to communicate the operational drilling system equipment data 210 in accordance with a different communication protocol.

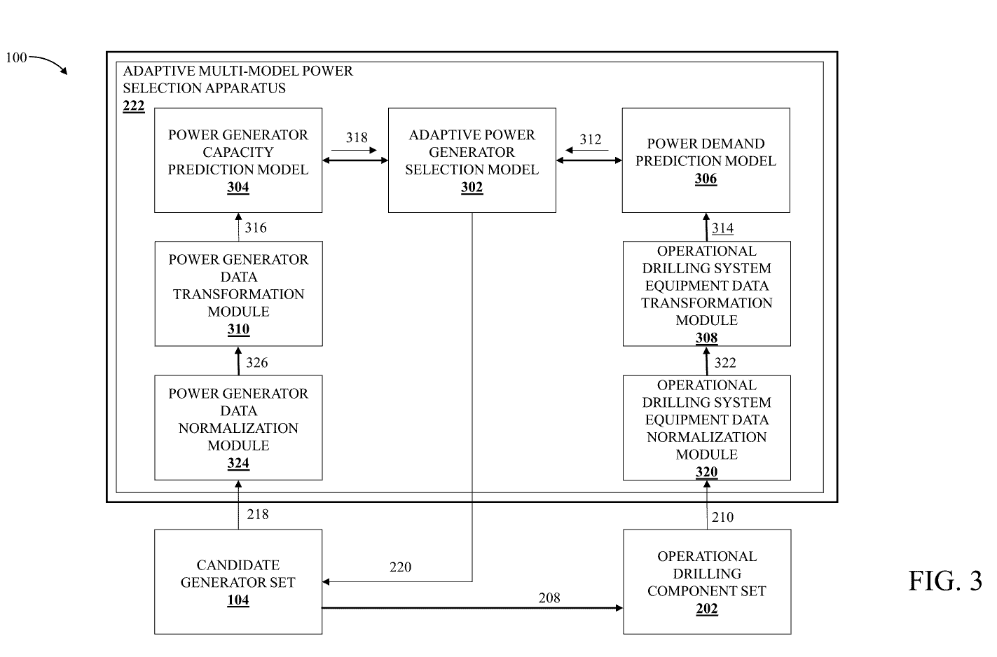

Thus, the adaptive multi-model power selection apparatus 222 may be configured to filter, normalize, correct errors, calibrate based on time stamp or other common attribute, and reformat disparate incoming data streams by applying normalization logic that accounts for variations in data periodicity, structure, units of measurement, encoding formats, source reliability, etc., enabling consistent and accurate integration across various operational inputs. Normalization logic is further described in association with the operational drilling system equipment data normalization module (e.g., operational drilling system equipment data normalization module 320) of FIG. 3.As further depicted in FIG. 2, the subterranean drilling system 200 includes a candidate generator set 104. The candidate generator set 104 comprises a group of power generators configured to provide the operating power 208 to the operational drilling component set 202 of the subterranean drilling system 200 based on the selected power generator signal 220 transmitted by the adaptive multi-model power selection apparatus 222. The selected power generator signal 220 comprises any electrical signal (e.g., wired/wireless) configured to encode data or directly enable/disable power generators in the candidate generator set 104. For example, the power generators of the candidate generator set 104 may be selectively enabled or disabled based on the selected power generator signal 220 to vary the operating power 208 provided to the operational drilling component set 202 based on power demand and power generator capacity.

The power output of the set of power generators comprising the candidate generator set 104 may be combined by synchronizing their electrical outputs, typically through a common bus or distribution system, so that the individual contributions of the power generators sum to form a single, unified operating power 208. The aggregated operating power 208 may then be directed to support operational loads across the operational drilling component set 202. By selectively enabling or disabling individual generators within the candidate generator set 104 by the selected power generator signal 220, the operating power 208 may be dynamically adjusted.

As further depicted in FIG. 2, the candidate generator set 104 is configured to transmit candidate generator set data 218. The candidate generator set data 218 is received at least by the adaptive multi-model power selection apparatus 222. The candidate generator set data 218 may include operational data for each of the individual power generators comprising the candidate generator set 104 and/or data related to the candidate generator set 104 as a whole. Example candidate generator set data may comprise generator operational data, for example, electrical output of each power generator, total electrical output of the candidate generator set, run time, operational efficiency, maintenance schedules, fuel levels, fuel efficiency, load, internal temperatures, and so on. In addition, candidate generator set data 218 may further comprise generator environmental data related to environmental characteristics in and around the candidate generator set 104. For example, generator environmental data may include internal and external temperatures, internal and external humidity, current weather data, weather forecast data, and so on.

As further depicted in FIG. 2, the subterranean drilling system 200 may access historical data 206. The historical data 206 includes any recorded information from past operations, including both internal metrics (e.g., electrical characteristics, run times, operational efficiency, fuel levels, fuel efficiency, internal temperatures, and so on), physical component characteristics (e.g., equipment depth, movement data, flow rates, stroke counts, weights, and so on), and external environmental factors (like weather conditions, location, elevation, environment classification, onshore/offshore, and so on). The historical data 206 may be collected over time and stored in structured formats, enabling the adaptive multi-model power selection apparatus 222 to access the historical data 206 to analyze patterns and make informed decisions.

Historical data 206 may be stored and accessed through a variety of systems depending on the scale, complexity, and use of the data. Common storage methods include databases, data warehouses, and cloud-based platforms. As depicted in FIG. 2, access to historical data 206 occurs via a network 204, typically facilitated through query languages, dashboards, or data integration tools that systems such as the adaptive multi-model power selection apparatus 222 to retrieve, filter, and analyze the historical data 206. In some embodiments, the operational historical data is correlated with environmental historical data to provide context for understanding cause-and-effect relationships, identifying anomalies, and forecasting future performance. The historical data 206 may include at least historical generator operational data, historical generator environmental data, corresponding drilling system historical data, historical operational environmental data, historical operational drilling system geological data, and historical operational drilling system location data.

As further depicted in FIG. 2, the subterranean drilling system 200 includes an adaptive multi-model power selection apparatus 222. The adaptive multi-model power selection apparatus 222 is configured to receive various input data (e.g., operational drilling system equipment data 210, candidate generator set data 218, and historical data 206) and generate a selected power generator signal 220 indicating the power generators of the candidate generator set 104 to be enabled and disabled.

The adaptive multi-model power selection apparatus 222 is designed to implement a plurality of machine learning models, including but not limited to, a power generator capacity prediction model, a power demand prediction model, and/or an adaptive power generator selection model. In general, the adaptive multi-model power selection apparatus 222 is configured to receive candidate generator set data 218 comprising real-time operational and environmental data for the candidate generator set 104 utilize a power generator capacity prediction model to determine a temporal environmental capacity for each of the power generators in the candidate generator set 104, wherein the power generator capacity prediction model is trained based on historical generator operational and environmental data (e.g., historical data 206) of an ensemble of power generators. The temporal environmental capacity provides a real-time capacity for each power generator in the candidate generator set 104 over a future period of time specific to the current environment and operation of the power generator.

In addition, the adaptive multi-model power selection apparatus 222 is configured to receive operational drilling system equipment data 210 comprising real-time operational and environmental data associated with the operational drilling component set 202 of the subterranean drilling system 200 and utilize a power demand prediction model to determine a predicted temporal environmental power demand for the subterranean drilling system 200 for a future drilling system operation period, wherein the power demand prediction model is trained based on historical operational drilling system equipment data, environmental data, location data, and/or geological data.

Based on the predicted temporal environmental capacity of each power generator in the candidate generator set 104, and the predicted temporal environmental power demand of the operational drilling component set 202, the adaptive multi-model power selection apparatus 222 utilizes an adaptive power generator selection model to select a set of power generators of the candidate generator set 104 to be enabled. The selected set of power generators is transmitted to the candidate generator set 104 through the selected power generator signal 220.

In some embodiments, the adaptive multi-model power selection apparatus 222 may be implemented on one or more compute devices at the subterranean drilling system. For example, the adaptive multi-model power selection apparatus 222 may be operated at the rig controller (e.g., rig controller 106) of the subterranean drilling system. The adaptive multi-model power selection apparatus 222 is further described in relation to FIG. 3.

FIG. 3 depicts a block diagram of an example adaptive multi-model power selection apparatus 222. The example adaptive multi-model power selection apparatus 222 includes a power generator capacity prediction model 304, a power demand prediction model 306, and an adaptive power generator selection model 302. The adaptive multi-model power selection apparatus 222 is configured to receive candidate generator set data 218 from a candidate generator set 104 at a power generator data transformation module 310 and generate candidate generator set data features 316 which are transmitted to the power generator capacity prediction model 304. The adaptive multi-model power selection apparatus is further configured to receive operational drilling system equipment data 210 from an operational drilling component set 202 and generate operational drilling system equipment data features 314 which are transmitted to the power demand prediction model 306. The adaptive power generator selection model 302 receives a predicted temporal environmental capacity 318 from the power generator capacity prediction model 304 and a predicted temporal environmental power demand 312 from the power demand prediction model 306 and generates a selected power generator signal 220 based on a cost-based reduction strategy. The selected power generator signal 220 is transmitted to the candidate generator set 104 to enable a set of power generators to provide operating power to the operational drilling component set 202.

As depicted in FIG. 3, the example adaptive multi-model power selection apparatus 222 includes an operational drilling system equipment data normalization module 320. The operational drilling system equipment data normalization module 320 is configured to receive operational drilling system equipment data 210 from the operational drilling component set 202 and generate normalized operational drilling system equipment data 322 based on various filtering and normalization techniques. Although depicted receiving data from the operational drilling component set 202, in some embodiments, the operational drilling system equipment data normalization module 320 may receive operational drilling system equipment data from a data recorder, such as an EDR.

As utilized by the adaptive multi-model power selection apparatus 222, the operational drilling system equipment data normalization module 320 is configured to filter, normalize, correct, and otherwise prepare disparate operational drilling system equipment data 210 for feature generation by the operational drilling system equipment data transformation module 308. Operational drilling system equipment data 210 may comprise various types of data, each comprising a different periodicity, formatting, measurement unit, error rate, communication protocol, data schema, and/or other varying data characteristics. Thus, the operational drilling system equipment data normalization module 320 is configured to perform normalization operations to generate normalized operational drilling system equipment data 322 for the operational drilling system equipment data transformation module 308.

Normalization operations on operational drilling system equipment data 210 may be utilized in preparing the raw information for feature generation and use in a power demand prediction model 306. Normalization operations may include normalizing operational drilling system equipment data 210, cleaning operational drilling system equipment data 210, reformatting operational drilling system equipment data 210, error correcting operational drilling system equipment data 210, handling missing data, and/or temporally calibrating operational drilling system equipment data 210.

For example, normalizing operational drilling system equipment data 210 may include determining and storing maximum and minimum values for each type of operational drilling system equipment data 210. Based on the stored maximum and minimum values, the operational drilling system equipment data normalization module 320 may scale incoming data between a known minimum and maximum ranges to normalize the impact of the data.

Data cleaning operational drilling system equipment data 210 performed by the operational drilling system equipment data normalization module 320 may involve identifying and correcting errors, inconsistencies, or missing values. Data cleaning may include identifying and removing duplicate entries, correcting formatting issues, and filtering out irrelevant data. Handling missing data may include replacing missing data using projection schemes like linear interpolation, where missing values are estimated based on surrounding data points.

Reformatting operational drilling system equipment data 210 is another key normalization operation, in which data is converted into a consistent structure or format, making it possible to process and analyze the data. Error correcting operational drilling system equipment data 210 may include detecting and handling outliers. Such outliers may be removed or capped to prevent the outliers from skewing model performance. Temporally calibrating operational drilling system equipment data 210 may include correlating disparate operational drilling system equipment data 210 based on a common attribute, such as a time stamp. In time stamp calibration, a operational drilling system equipment data normalization module 320 may utilize time stamps to correlate the operational drilling system equipment data 210 in time.

These normalization operations collectively enhance the quality, consistency, and usability of operational drilling system equipment data 210, ensuring the power demand prediction model 306 may utilize the data effectively and produce reliable predictions.

As depicted in FIG. 3, the example adaptive multi-model power selection apparatus 222 includes an operational drilling system equipment data transformation module 308. The operational drilling system equipment data transformation module 308 is configured to receive normalized operational drilling system equipment data 322 from the operational drilling system equipment data normalization module 320 and generate operational drilling system equipment data features 314 prepared to be received by the power demand prediction model 306. In general, the operational drilling system equipment data transformation module 308 is configured to perform transformation operations to generate operational drilling system equipment data features 314.

Transformation operations on operational drilling system equipment data 210 may be utilized in preparing the normalized operational drilling system equipment data 322 for use in a power demand prediction model 306. Transformation operations may include generation of appropriately scaled feature sets (e.g., operational drilling system equipment data features 314). Such operations may include creating a feature vector, which is a structured array of numerical values representing the input variables used by the power demand prediction model. To ensure that each feature contributes equally to the model, feature scaling techniques such as normalization or standardization are applied.

As further depicted in FIG. 3, the adaptive multi-model power selection apparatus 222 includes a power demand prediction model 306. The power demand prediction model generates a predicted temporal environmental power demand 312 based on the operational drilling system equipment data features 314. The predicted temporal environmental power demand 312 is a forecast, time-varying power requirement of a subterranean drilling system. The power demand prediction model 306 may be configured to forecast the predicted temporal environmental power demand 312 for a specific drilling system operation period, for example, 10 minutes. The power demand of the subterranean drilling system may vary based on a plurality of variables, for example, the stage of a well plan of the subterranean drilling system, the individual components of the operational drilling component set, environment, location, geology, terrain, etc.

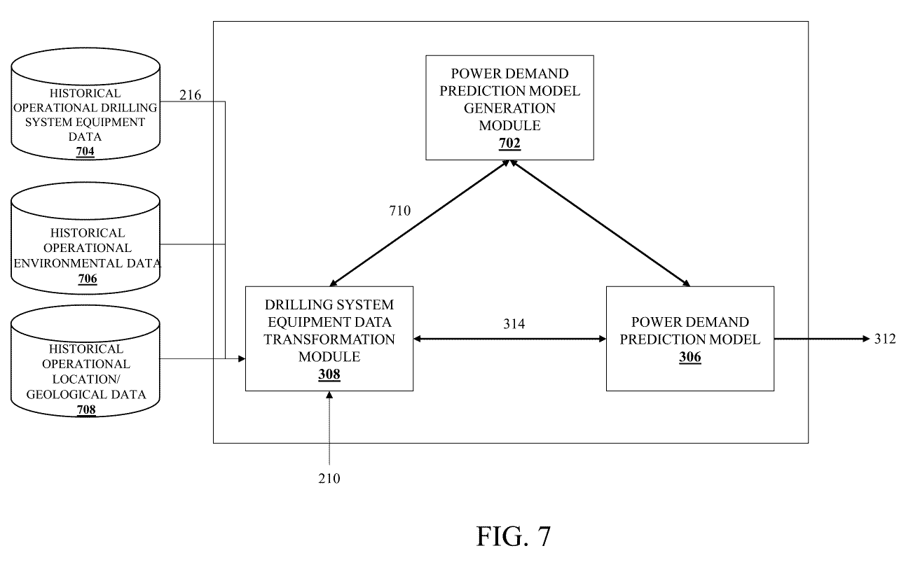

The power demand prediction model 306 further includes one or more trained machine learning models configured to determine the predicted temporal environmental power demand 312 associated with a subterranean drilling system based on the operational drilling system equipment data features 314. As further described in relation to FIG. 7, the power demand prediction model 306 may be trained by a power demand prediction model generation module based on the features of historical operational drilling system equipment data, historical operational environmental data, historical operational location data, and/or historical operational geological data.

In some embodiments, the power demand prediction model 306 may comprise a bi-directional RNN model enabling determination of the predicted temporal environmental power demand 312 based on context associated with past and future time steps. In some embodiments, the power demand prediction model 306 may comprise a bi-directional long short-term memory (LSTM) model.

During operation, the adaptive multi-model power selection apparatus 222 may utilize various model verification techniques to verify the accuracy of the power demand prediction model 306. For example, the adaptive multi-model power selection apparatus 222 may capture actual power demand values of the operational drilling component set 202 and compare the actual power demand values to the predicted temporal environmental power demand 312 for the same time step. In an instance in which the adaptive multi-model power selection apparatus 222 detects deviation from the predicted temporal environmental power demand 312, the adaptive multi-model power selection apparatus 222 may trigger retraining of the power demand prediction model 306 or transmit an alert indicating inaccuracies in the power demand prediction model 306. In some embodiments, the adaptive multi-model power selection apparatus 222 may utilize a CUSUM-based algorithm to determine deviation of the power demand prediction model 306 and trigger a notification in an instance in which the actual performance of the power demand prediction model 306 exceeds a threshold error.

As further depicted in FIG. 3, the example adaptive multi-model power selection apparatus 222 includes a power generator data normalization module 324. The power generator data normalization module 324 is configured to receive candidate generator set data 218 from the operational drilling component set 202 and generate normalized candidate generator set data 326 based on various filtering and normalization techniques. Although depicted receiving data from the candidate generator set 104, in some embodiments, the power generator data normalization module 324 may receive candidate generator set data 218 from a data recorder, such as an EDR.

As utilized by the adaptive multi-model power selection apparatus 222, the power generator data normalization module 324 is configured to filter, normalize, correct, and otherwise prepare disparate candidate generator set data 218 for feature generation by the power generator data transformation module 310. Candidate generator set data 218 may comprise various types of data, each comprising a different periodicity, formatting, measurement unit, error rate, communication protocol, data schema, and/or other varying data characteristics. Thus, the power generator data normalization module 324 is configured to perform normalization operations to generate normalized candidate generator set data 326 for the power generator data transformation module 310.

Normalization operations on candidate generator set data 218 may be utilized in preparing the raw information for feature generation and use in a power generator capacity prediction model 304. Normalization operations may include normalizing candidate generator set data 218, cleaning candidate generator set data 218, reformatting candidate generator set data 218, error correcting candidate generator set data 218, handling missing candidate generator set data 218, and/or temporally calibrating candidate generator set data 218.

For example, normalizing candidate generator set data 218 may include determining and storing maximum and minimum values for each type of candidate generator set data 218. Based on the stored maximum and minimum values, the power generator data normalization module 324 may scale incoming data between a known minimum and maximum ranges to normalize the impact of the data.

Data cleaning candidate generator set data 218 performed by the power generator data normalization module 324 may involve identifying and correcting errors, inconsistencies, or missing values. Data cleaning may include identifying and removing duplicate entries, correcting formatting issues, and filtering out irrelevant data. Handling missing data may include replacing missing data using projection schemes like linear interpolation, where missing values are estimated based on surrounding data points.

Reformatting candidate generator set data 218 is another key normalization operation, in which data is converted into a consistent structure or format, making it possible to process and analyze the data. Error correcting candidate generator set data 218 may include detecting and handling outliers. Such outliers may be removed or capped to prevent the outliers from skewing model performance. Temporally calibrating candidate generator set data 218 may include correlating disparate candidate generator set data 218 based on a common attribute, such as a time stamp. In time stamp calibration, a power generator data normalization module 324 may utilize time stamps to correlate the candidate generator set data 218 in time.

These normalization operations collectively enhance the quality, consistency, and usability of candidate generator set data 218, ensuring the power generator capacity prediction model 304 may utilize the data effectively and produce reliable predictions.

As further depicted in FIG. 3, the example adaptive multi-model power selection apparatus 222 includes a power generator data transformation module 310. The power generator data transformation module 310 is configured to receive normalized candidate generator set data 326 from the power generator data normalization module 324 and generate candidate generator set data features 316 prepared to be received by the power generator capacity prediction model 304. In general, the power generator data transformation module 310 is configured to perform transformation operations to generate candidate generator set data features 316.

Transformation operations on candidate generator set data 218 may be an important step in preparing the normalized candidate generator set data 326 for use in a power generator capacity prediction model 304.

Transformation operations may include generation of appropriately scaled feature sets (e.g., candidate generator set data features 316). Such operations may include creating a feature vector, which is a structured array of numerical values representing the input variables used by the power generator capacity prediction model. To ensure that each feature contributes equally to the model, feature scaling techniques such as normalization or standardization are applied.

As further depicted in FIG. 3, the adaptive multi-model power selection apparatus 222 includes a power generator capacity prediction model 304. The power generator capacity prediction model 304 generates a predicted temporal environmental capacity 318 based on the candidate generator set data features 316. The predicted temporal environmental capacity 318 is a forecast maximum amount of electrical power a specific power generator of the candidate generator set 104 may produce during a given time period, such as a drilling system operation period. The predicted temporal environmental capacity 318 is based on the candidate generator set data features including generator operational data, corresponding generator environmental data, and/or corresponding operational drilling system equipment data 210. The predicted temporal environmental capacity 318 indicates how much load the associated power generator may handle continuously.

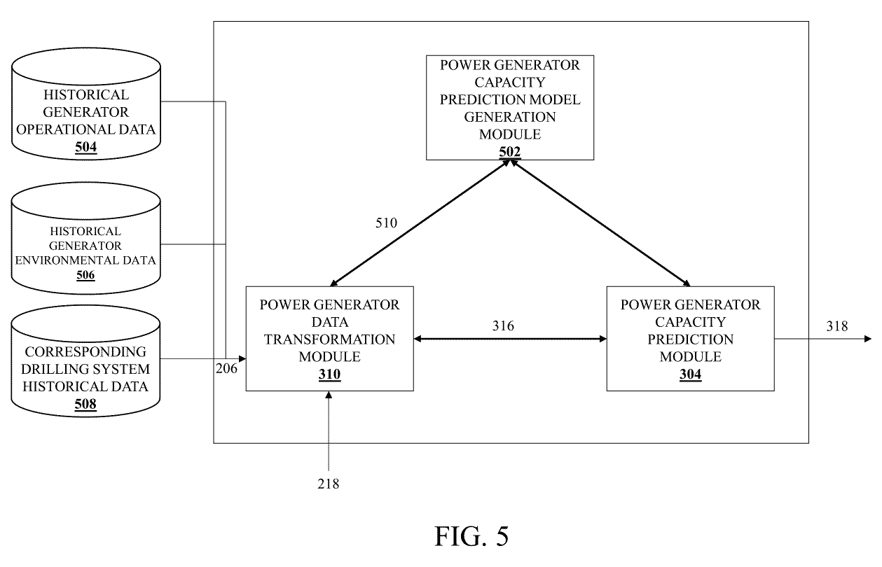

The power generator capacity prediction model 304 further includes one or more trained machine learning models configured to determine the predicted temporal environmental capacity 318 associated with each power generator of the candidate generator set 104 based on the candidate generator set data features 316. As further described in relation to FIG. 5, the power generator capacity prediction model 304 may be trained by a power generator capacity prediction model generation module based on the features of historical generator operational data, historical generator environmental data, and/or corresponding drilling system historical data.

In some embodiments, the power generator capacity prediction model 304 may comprise an IWLSR model enabling the adaptive multi-model power selection apparatus 222 to iteratively update the model based on observed capacities in the candidate generator set data 218. For example, the power generator capacity prediction model 304 may determine a predicted temporal environmental capacity based on the candidate generator set data. The adaptive multi-model power selection apparatus 222 may then observe the actual capacity of the selected power generators. Based on the accuracy of the predicted temporal environmental capacity 318, the adaptive multi-model power selection apparatus 222 may update the power generator capacity prediction model 304.

In some embodiments, the adaptive multi-model power selection apparatus may utilize various model verification techniques to verify the performance of the power generator capacity prediction model 304. For example, a CUSUM-based algorithm may monitor the residuals of the power generator capacity prediction model 304 on each new data sample and trigger a notification in an instance in which the actual performance of the power generator capacity prediction model 304 consistently deviates from the predicted temporal environmental capacity by more than a model error threshold.

In some embodiments, the adaptive multi-model power selection apparatus 222 may leverage rate-of-change filtering techniques to filter generated predicted temporal environmental capacity 318 predictions. For example, the adaptive multi-model power selection apparatus 222 may compare the current predicted temporal environmental capacity 318 value for a particular power generator with the previous predicted temporal environmental capacity 318 value for the particular power generator. In an instance in which the rate-of-change exceeds a threshold value, the predicted temporal environmental capacity 318 may be indicated as invalid.

In some embodiments, the adaptive multi-model power selection apparatus 222 may store a plurality of power generator capacity prediction models 304. In such an embodiment, a power generator capacity prediction model 304 may be stored for different subterranean drilling system configurations, for example, a specific power generator capacity prediction model 304 may be configured for a specific operational drilling component set 202, a specific location, a terrain type, or other characteristic of the subterranean drilling system. In some embodiments, the adaptive multi-model power selection apparatus 222 may select a power generator capacity prediction model 304 based on the characteristics of the subterranean drilling system. In some embodiments, a power generator capacity prediction model 304 may be updated manually.

In some embodiments, model verification techniques may further include storing historical minimum capacities of each power generator of the candidate generator set 104. For example, every time a new capacity value for a power generator is confirmed, the adaptive multi-model power selection apparatus 222 may store the capacity value as a minimum capacity for the particular power generator, if it is below the previously stored historical minimum capacity for the power generator. Such a historical minimum capacity value may be used to adjust or eliminate a predicted temporal environmental capacity 318 in an instance in which the predicted temporal environmental capacity 318 is below the historical minimum capacity value.

In some embodiments, the adaptive multi-model power selection apparatus 222 may further comprise an anomaly detection model. An anomaly detection model may comprise a machine learning model trained to identify a particular power generator as a poor performance or high performance power generator. In some embodiments, high performance power generators may be identified based on observed capacity, efficiency, or another similar metric. The candidate generator set data 218 associated with a high performance power generator may be stored and used to train the anomaly detection model to recognize other high performance power generators during operation. Conversely, the adaptive multi-model power selection apparatus 222 may identify and detect a poor performance power generator based on capacity, efficiency, or another similar metric. The candidate generator set data 218 associated with a poor performance power generator may be stored and used to train the anomaly detection model to recognize other poor performance power generators during operation. In this way, poor performance power generators may be identified. In some embodiments, poor performance power generators may be selected for prescriptive maintenance or otherwise removed from selection as a selected power generator based on the data signature of the candidate generator set data 218 associated with the poor performance power generator.

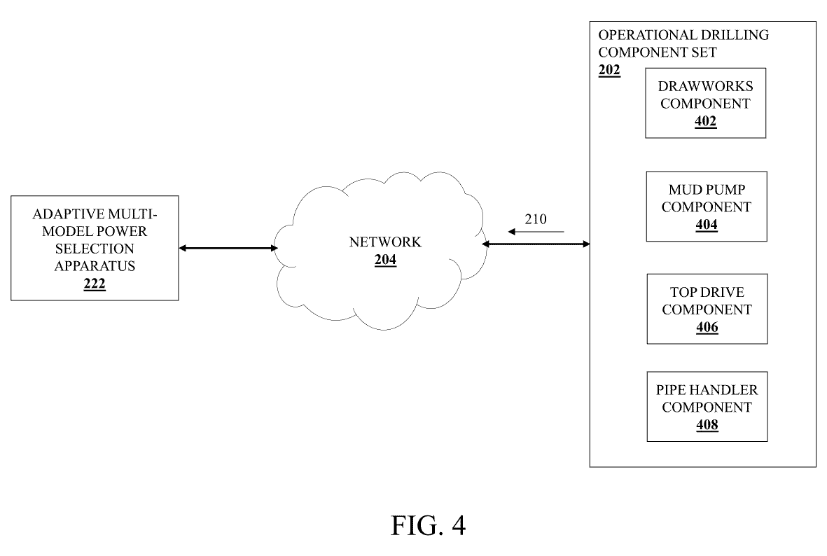

FIG. 4 shows a block diagram depicting example operational drilling system equipment data 210 generating components (e.g., drawworks component 402, mud pump component 404, top drive component 406, pipe handler component 408) of an operational drilling component set 202. As further depicted in FIG. 4, the operational drilling system equipment data 210 generated by the components of the operational drilling component set 202 are transmitted via a network 204 to the adaptive multi-model power selection apparatus 222.

The example operational drilling component set 202 includes a drawworks component 402. In general, a drawworks component 402 of a subterranean drilling system is responsible for controlling the hoisting and lowering of the drill string, which is a critical function during drilling operations. The drawworks component 402 acts as a large winch system, using a spool of wire rope, motors, and braking mechanisms to manage the vertical movement of heavy drilling equipment within the wellbore. The drawworks component 402 allows operators to safely and efficiently handle the drill string during various phases such as tripping in and out of the hole, drilling, and casing. By precisely adjusting the tension and speed of the hoisting line, the drawworks component 402 ensures smooth and controlled movement, which may help in maintaining well integrity and operational safety. It is typically integrated with other rig components like the traveling block and crown block, forming the core of the hoisting system of the rig. The drawworks component 402 may generate various data which may be included in the operational drilling system equipment data 210, for example, on hook load, line speed, drum rotation speed, torque, depth, electrical properties of the motor, and so on. The periodicity, format, units, error rates, and other characteristics of the operational drilling system equipment data 210 may vary based on the type, brand, year, and other characteristics of the drawworks component 402. The operational drilling system equipment data 210 associated with the drawworks component 402 may further comprise correlated internal and external environmental data, location data, and/or geological data.

The example operational drilling component set 202 includes a mud pump component 404. In general, a mud pump component 404 of the subterranean drilling system is responsible for delivering drilling fluid, or mud, to the wellbore at controlled pressure and flow rates. The fluid serves multiple critical functions, for example, it cools and lubricates the drill bit, stabilizes the borehole walls, and carries cuttings to the surface. By maintaining sufficient hydraulic force, the mud pump component 404 ensures continuous circulation of drilling fluid, which may contribute to safe and efficient drilling operations.

The mud pump component 404 may generate various data which may be included in the operational drilling system equipment data 210, for example, on pump pressure, flow rate, stroke rate, pump efficiency, electrical characteristics of the pump, vibration readings, temperature readings, fluid density, fluid viscosity, and so on. The periodicity, format, units, error rates, and other characteristics of the operational drilling system equipment data 210 may vary based on the type, brand, year, and other characteristics of the mud pump component 404. The operational drilling system equipment data 210 associated with the mud pump component 404 may further comprise correlated internal and external environmental data, location data, and/or geological data.

The example operational drilling component set 202 includes a top drive component 406. In general, a top drive component 406 of the subterranean drilling system is responsible for providing rotational force to the drill string, enabling the bottom-hole assembly to turn within the wellbore. The rotational force allows for continuous and controlled drilling, especially in directional or horizontal wells, and improves efficiency compared to traditional rotary table systems. The top drive component 406 also facilitates safer and faster pipe handling by allowing rotation while adding or removing drill pipe sections.

The top drive component 406 may generate various data which may be included in the operational drilling system equipment data 210, for example, rotational speed, torque output, vertical position, electrical characteristics of the motor, vibration and temperature readings, and so on. The periodicity, format, units, error rates, and other characteristics of the operational drilling system equipment data 210 may vary based on the type, brand, year, and other characteristics of the top drive component 406. The operational drilling system equipment data 210 associated with the top drive component 406 may further comprise correlated internal and external environmental data, location data, and/or geological data.

The example operational drilling component set 202 includes a pipe handler component 408. In general, a pipe handler component 408 of the subterranean drilling system is responsible for automating the movement and positioning of drill pipe and other tubulars during drilling operations. The pipe handler component 408 facilitates the safe and efficient transfer of pipe between storage racks, the rig floor, and the well center, reducing manual labor and minimizing the risk of injury. By integrating with other rig systems, the pipe handler component 408 ensures precise alignment and handling of pipe sections during tripping, casing, and connection procedures.

The pipe handler component 408 may generate various data which may be included in the operational drilling system equipment data 210, for example, pipe position and orientation, movement speed, hydraulic or motor pressure, electrical characteristics of the motors, and so on. The periodicity, format, units, error rates, and other characteristics of the operational drilling system equipment data 210 may vary based on the type, brand, year, and other characteristics of the pipe handler component 408. The operational drilling system equipment data 210 associated with the pipe handler component 408 may further comprise correlated internal and external environmental data, location data, and/or geological data.

FIG. 5 depicts an example power generator capacity prediction model generation module 502. The power generator capacity prediction model generation module 502 is initially configured to generate and train a power generator capacity prediction model 304. During a training phase, the power generator capacity prediction model generation module 502 receives feature vectors (e.g., historical data features 510) generated by the power generator data transformation module 310 based on historical data 206, which encapsulates the relevant operational and environmental data associated with various power generators and/or various candidate generator sets. The feature vectors are used to initialize and train a model, such as an iterative weighted least squares regression model. During a training phase, the power generator capacity prediction model generation module assigns weights to each data point of the model, emphasizing those with higher relevance or confidence, and iteratively adjusts the model parameters to minimize the weighted sum of squared errors between predicted and actual outcomes. The process continues until convergence criteria are met, ensuring that the model accurately captures the underlying relationships in the historical data 206. The power generator capacity prediction model generation module 502 may also include validation steps to assess general performance and prevent overfitting, resulting in a robust model (e.g., power generator capacity prediction model 304) ready for deployment in predictive tasks.

As depicted in FIG. 5, the historical data 206 includes at least historical generator operational data 504, historical generator environmental data 506, and/or corresponding drilling system historical data 508.

The historical generator operational data 504 may include generator operational data associated with various power generators, combined in various candidate generator sets, in support of various drilling and non-drilling activities, in various environmental conditions and locations, and various subterranean drilling system setups.

The historical generator environmental data 506 may include environmental characteristics associated with the historical generator operational data 504. For example, the historical generator environmental data 506 may include internal and external environmental temperatures, humidity, associated weather data, and so on. In some embodiments, the power generator data transformation module 310 may correlate the historical generator environmental data 506 with the historical generator operational data 504, such that the observed environmental data is associated with the observed operational data.

The corresponding drilling system historical data 508 may also be included in the historical data 206. The corresponding drilling system historical data 508 may include subterranean drilling system equipment data (e.g., operational drilling system equipment data) and other data related to the operation of a corresponding subterranean drilling system. In some embodiments, the power generator data transformation module 310 may correlate the corresponding drilling system historical data 508 with the historical generator environmental data 506 and the historical generator operational data 504, such that the observed environmental data and the observed operational data is associated with the observed drilling system data.

Since the data may include various power generators, including different types, makes, models, years, the power generator data transformation model may perform various transformation operations to clean, reformat, normalize, and scale the disparate historical data 206.

During a classification phase, the power generator capacity prediction model 304 is configured to receive real-time candidate generator set data features 316 based on candidate generator set data 218 received at the power generator data transformation module 310. The power generator capacity prediction model 304 continually generates predicted temporal environmental capacity 318 for each power generator based on the candidate generator set data 218.

In some embodiments, the power generator capacity prediction model generation module 502 may be configured to update the power generator capacity prediction model 304 during classification phase. For example, various model verification techniques may indicate errors in the predicted temporal environmental capacity 318 as compared to the observed temporal environmental capacity of a power generator. In such an embodiment, the power generator capacity prediction model generation module 502 may receive one or more candidate generator set data features 316 and corresponding observed temporal environmental capacities of one or more power generators. The power generator capacity prediction model generation module 502 may be configured to update the power generator capacity prediction model 304 based on the observed temporal environmental capacities.

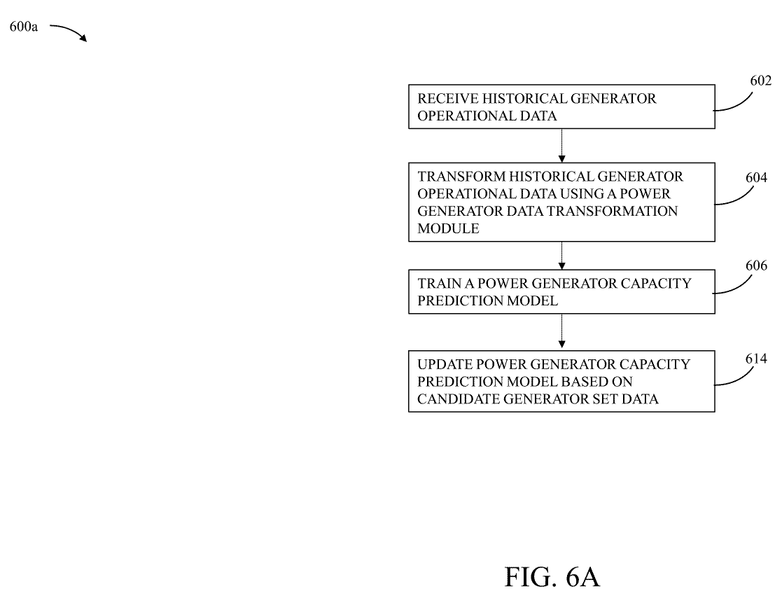

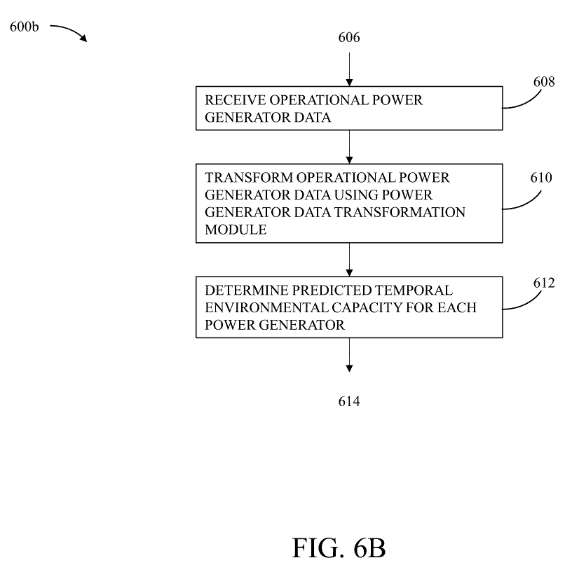

FIG. 6A depicts a flow chart 600a illustrating training operations associated with an example power generator capacity prediction model generation module (e.g., power generator capacity prediction model generation module 502). At block 602, the power generator capacity prediction model generation module receives historical generator operational data (e.g., historical generator operational data 504) for a candidate generator set (e.g., candidate generator set 104) of power generators (e.g., power generator 110) that are each respectively configured to provide operating power (e.g., operating power 208) to a subterranean drilling system (e.g., subterranean drilling system 100). As described herein, historical generator operational data may include observed physical characteristics of one or more power generators collected over time. Historical generator operational data may be collected from various power generators, combined in various candidate generator sets, in support of various drilling and non-drilling activities, in various environmental conditions and locations, and various subterranean drilling system setups, and stored in a data storage device accessible to the power generator capacity prediction model generation module. The variation in historical generator operational data may increase the accuracy and reliability of the power generator capacity prediction model in constantly varying operating conditions. In some embodiments, the power generator capacity prediction model generation module may be further configured to receive historical generator environmental data (e.g., historical generator environmental data 506) and corresponding drilling system historical data (e.g., corresponding drilling system historical data 508).

At block 604, the power generator capacity prediction model generation module transforms the historical generator operational data, for example, utilizing a power generator data transformation module (e.g., power generator data transformation module 310). In some embodiments, transforming the historical generator operational data may include scaling the historical generator operational data based on a maximum threshold associated with each of the one or more physical characteristics. In some embodiments, transforming the historical generator operational data may include identifying and removing outlier data in the historical generator operational data. Further transformation operations may include data cleaning and/or reformatting the historical generator operational data.

At block 606, the power generator capacity prediction model generation module is configured to train a power generator capacity prediction model (e.g., power generator capacity prediction model 304). For example, the power generator capacity prediction model generation module may be configured to receive historical data features (e.g., historical data features 510) based on the historical generator operational data and train the power generator capacity prediction model by, for example, assigning weights to each data point of the model, and iteratively adjusting the model parameters until the model accurately captures the underlying relationships in the historical generator operational data.

At block 614, the power generator capacity prediction model generation module may update the power generator capacity prediction model based on observed candidate generator set data generated during classification operations. For example, in some embodiments, the power generator capacity prediction model generation module may receive candidate generator set data features (e.g., candidate generator set data features 316) based on observed candidate generator set data and corresponding observed temporal environmental capacities associated with the observed candidate generator set data. In such an embodiment, the power generator capacity prediction model generation module may be configured to update the power generator capacity prediction model based on the observed candidate generator set data and corresponding observed temporal environmental capacities of the power generators.

FIG. 6B depicts a flow chart 600b illustrating classification operations associated with an example power generator capacity prediction model (e.g., power generator capacity prediction model 304). In some embodiments, the classification operations depicted in flow chart 600b may follow the training operations of FIG. 6A. At block 608, the power generator capacity prediction model receives candidate generator set data (e.g., candidate generator set data 218) comprising one or more physical characteristics associated with the power generators of the candidate generator set (e.g., candidate generator set 104). As described herein, candidate generator set data may include real-time physical characteristics of one or more power generators of the candidate generator set and/or real-time physical characteristics of the candidate generator set. Candidate generator set data may comprise generator operational data, for example, electrical output of each power generator, total electrical output of the candidate generator set, run time, operational efficiency, maintenance schedules, fuel levels, fuel efficiency, load, internal temperatures, and so on, and/or generator environmental data, for example, temperatures, humidity, current weather data, weather forecast data, and so on. In some embodiments, the power generator capacity prediction model may further be configured to receive corresponding operational drilling system equipment data which may be used to determine the predicted temporal environmental capacity of each power generator.

At block 610, the power generator capacity prediction model transforms the candidate generator set data, for example, utilizing a power generator data transformation module (e.g., power generator data transformation module 310). In some embodiments, transforming the candidate generator set data may include scaling the candidate generator set data based on a maximum threshold associated with each of the one or more physical characteristics represented in the candidate generator set data. In some embodiments, transforming the candidate generator set data may include identifying and removing outlier data in the candidate generator set data. Further transformation operations may include data cleaning and/or reformatting the candidate generator set data.

At block 612, the power generator capacity prediction model determines a predicted temporal environmental capacity (e.g., predicted temporal environmental capacity 318) for each power generator based on the candidate generator set data. For example, in some embodiments, the power generator data transformation module may be configured to generate candidate generator set data features (e.g., candidate generator set data features 316) based on the candidate generator set data. The power generator capacity prediction model may ingest the candidate generator set data features and based on the trained power generator capacity prediction model generate a predicted temporal environmental capacity for each power generator in the candidate generator set.

FIG. 7 depicts an example power demand prediction model generation module 702. The power demand prediction model generation module 702 is initially configured to generate and train a power demand prediction model 306. During a training phase, the power demand prediction model generation module 702 receives feature vectors (e.g., historical data features 710) generated by the operational drilling system equipment data transformation module 308 based on historical data 206, which encapsulates the relevant operational and environmental data associated with the various subterranean drilling system operational drilling components and equipment. The feature vectors are used to initialize and train a model, such as a bi-directional recurrent neural network model. During a training phase, the power demand prediction model generation module 702 learns patterns by adjusting the weights of the connections, enabling the power demand prediction model generation module 702 to make predictions or classifications based on new data. The power demand prediction model generation module 702 may be designed to process sequential data by maintaining a memory of previous inputs through internal loops. The ability to retain and use past information helps the power demand prediction model generation module 702 to model temporal or ordered relationships in data. The training process continues until convergence criteria are met, ensuring that the model accurately captures the underlying relationships in the historical data 206. The power demand prediction model generation module 702 may also include validation steps to assess general performance and prevent overfitting, resulting in a robust model (e.g., power demand prediction model 306) ready for deployment in predictive tasks.

As depicted in FIG. 7, the historical data 206 includes at least historical operational drilling system equipment data 704, historical operational environmental data 706, and/or historical operational location/geological data 708. The historical data 206 may be stored in a data storage device accessible to the power demand prediction model generation module 702, the operational drilling system equipment data transformation module 308, and/or the power demand prediction model 306.

The historical operational drilling system equipment data 704 may include any physical characteristics of any subterranean drilling system in various environmental conditions and locations, operating in various geological conditions. The historical operational drilling system equipment data 704 may derive from various equipment comprising the operational drilling component set (e.g., operational drilling component set 202) and/or various sensing devices configured to measure physical characteristics at strategic locations on the subterranean drilling system.

The historical operational environmental data 706 may include environmental characteristics associated observed physical characteristics of an environment proximate the operating subterranean drilling system. The historical operational environmental data 706 may capture conditions of the environment in which the subterranean drilling system is operating. For example, climate, weather, temperatures, humidity, and other similar data.

The historical operational location/geological data 708 may also be included in the historical data 206. The historical operational location/geological data 708 may include historical operational location data and/or historical operational geological data. Historical operational location data may include any observed location characteristics of a site at or near an operating subterranean drilling system. For example, historical operational location data may include but is not limited to location, elevation, latitude, longitude, terrain, biome, on shore/off shore etc. Historical operational location data may be recorded at various locations, climates, elevations, corresponding to various subterranean drilling systems and equipment. The physical characteristics of the location of the subterranean drilling system may have an impact on the power demand of the subterranean drilling system. In some embodiments, the operational drilling system equipment data transformation module 308 may correlate the historical operational location data with the historical operational drilling system equipment data 704, such that the observed location characteristics are associated with the observed equipment data.

Historical operational geological data may include any geological characteristics of a site at or near a subterranean drilling system. For example, historical operational geological data may include but is not limited to crust composition, hardness, strength, pressure, temperature, temperature gradient, and other similar data. The geological characteristics of the subterranean drilling system in coordination with a well plan may have an impact on the power demand of the subterranean drilling system. In some embodiments, the operational drilling system equipment data transformation module 308 may correlate the historical operational geological data with the historical operational drilling system equipment data 704, such that the observed geology of a site are associated with the observed equipment data.

The historical data 206 may include various types of equipment spanning various types, releases, versions, and years. In addition, environmental, location, and geological data may be collected by disparate equipment, at various intervals, and recorded/stored using different techniques. As such, the historical data 206 may comprise various formats, errors, ranges, scales, and so on. In some embodiments, the operational drilling system equipment data transformation module 308 may perform various transformation operations to clean, reformat, normalize, and scale the disparate historical data 206.

During a classification phase, the power demand prediction model 306 is configured to receive real-time operational drilling system equipment data features 314 based on operational drilling system equipment data 210 received at the operational drilling system equipment data transformation module 308. The power demand prediction model 306 continually generates predicted temporal environmental power demand 312 associated with the subterranean drilling system based on the operational drilling system equipment data 210.

In some embodiments, the power demand prediction model generation module 702 may be configured to update the power demand prediction model 306 during classification phase. For example, various model verification techniques may indicate errors in the predicted temporal environmental power demand 312 as compared to an observed power demand. In such an embodiment, the power demand prediction model generation module 702 may receive one or more operational drilling system equipment data features 314 and corresponding observed power demands of the subterranean drilling system. The power demand prediction model generation module 702 may be configured to update the power demand prediction model 306 based on the operational drilling system equipment data 210 and observed power demand.

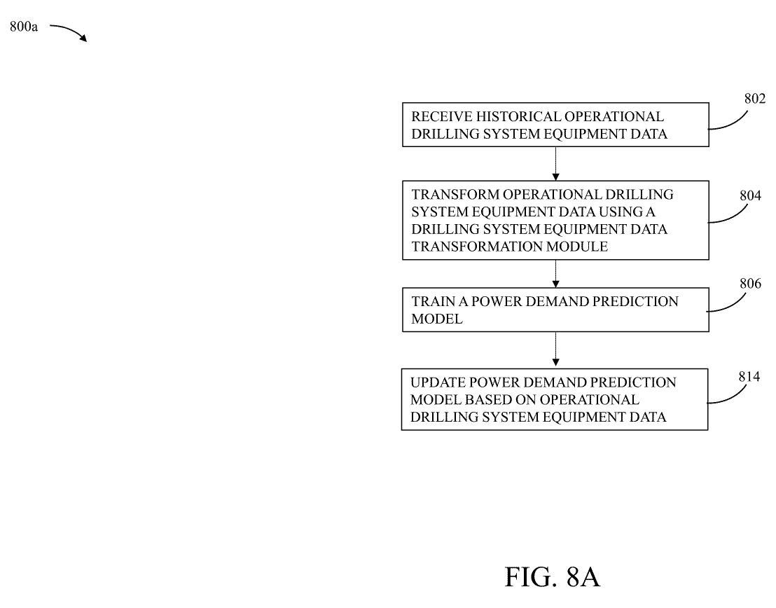

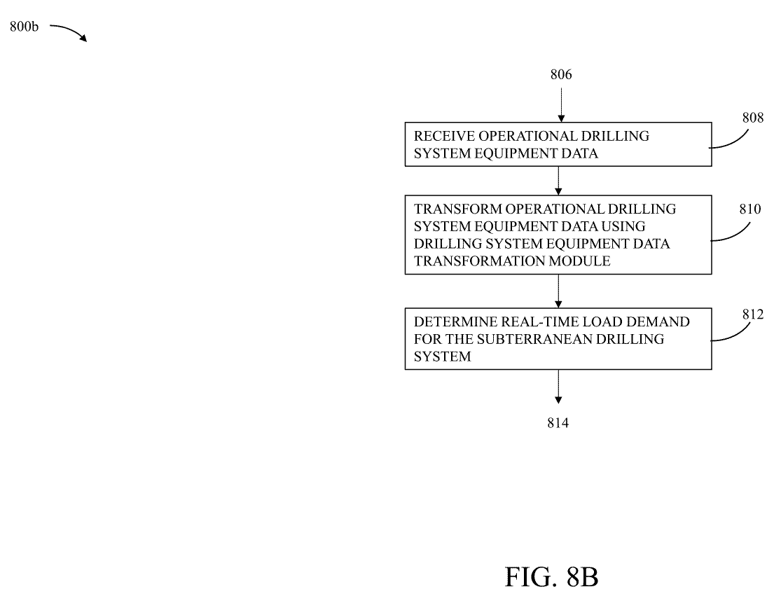

FIG. 8A depicts a flow chart 800a illustrating training operations associated with an example power demand prediction model generation module (e.g., power demand prediction model generation module 702). At block 802, the power demand prediction model generation module receives historical operational drilling system equipment data (e.g., historical operational drilling system equipment data 704) associated with various subterranean drilling systems in various environments, locations, and geologies. As described herein, the historical operational drilling system equipment data may include operational data associated with various components of a subterranean drilling system, including equipment of the operational drilling component set (e.g., operational drilling component set 202) and various sensors disposed at strategic positions on a subterranean drilling system. The variety in operating equipment, environment, location, and geometry may increase the accuracy and reliability of the power demand prediction model in various subterranean drilling system setups. The historical operational drilling system equipment data may be stored in a data storage device accessible to the power demand prediction model generation module, the drilling system equipment data transformation module, and/or the power demand prediction model. In some embodiments, the power demand prediction model generation module may be further configured to receive historical operational environmental data (e.g., historical operational environmental data 706) and corresponding historical operational location/geological data (e.g., historical operational location/geological data 708).

At block 804, the power demand prediction model generation module transforms the historical operational drilling system equipment data, for example, utilizing an operational drilling system equipment data transformation module (e.g., operational drilling system equipment data transformation module 308). In some embodiments, transforming the historical operational drilling system equipment data may include scaling the historical operational drilling system equipment data based on a maximum threshold associated with the drilling system equipment and/or associated physical characteristics. In some embodiments, transforming the historical operational drilling system equipment data may include identifying and removing outlier data in the historical operational drilling system equipment data. Further transformation operations may include data cleaning and/or reformatting the historical operational drilling system equipment data.

At block 806, the power demand prediction model generation module is configured to train a power demand prediction model (e.g., power demand prediction model 306). For example, the power demand prediction model generation module may be configured to receive historical data features (e.g., historical data features 710) based on the historical operational drilling system equipment data and train the power demand prediction model by, for example, assigning and adjusting data point weights in the model until the model accurately captures the underlying relationships in the historical operational drilling system equipment data.

At block 814, the power demand prediction model generation module may update the power demand prediction model based on observed operational drilling system equipment data generated during classification operations. For example, in some embodiments, the power demand prediction model generation module may receive operational drilling system equipment data features (e.g., operational drilling system equipment data features 314) based on observed operational drilling system equipment data and corresponding observed power demand associated with the observed operational drilling system equipment data. In such an embodiment, the power demand prediction model generation module may be configured to update the power demand prediction model based on the observed operational drilling system equipment data and corresponding observed operational drilling system equipment data associated with the subterranean drilling system.

FIG. 8B depicts a flow chart 800b illustrating classification operations associated with an example power demand prediction model (e.g., power demand prediction model 306). In some embodiments, the classification operations depicted in flow chart 800b may follow the training operations of FIG. 8A. At block 808, the power demand prediction model receives operational drilling system equipment data (e.g., operational drilling system equipment data 210) comprising one or more physical characteristics associated with equipment of an associated subterranean drilling system (e.g., subterranean drilling system 100). As described herein, operational drilling system equipment data may include any measured, collected, or observed physical characteristics of one or more operational drilling components of a subterranean drilling system, including but not limited to bit depth data, block movement data, pump related data, stroke counts, weight on bit data, hook load data, candidate generator set data, top drive data, and so on. Operational drilling system equipment data may further include sensor data from various sensors positioned throughout a subterranean drilling system. In some embodiments, operational drilling system equipment data may further include environmental data, location data, and/or geological data associated with the subterranean drilling system. In some embodiments, the operational drilling system equipment data is transmitted to a rig controller and/or data recorder. In some embodiments, the operational drilling system equipment data is collected and stored by an EDR. As such, the power demand prediction model, power demand prediction model generation module, and/or drilling system equipment data transformation module may access the operational drilling system equipment data using any suitable memory access means, including but not limited to direct memory addressing, memory-mapped I/O, bus-based access protocols, DMA (Direct Memory Access), cache controllers, or other hardware or software mechanisms configured to retrieve or manipulate stored data.

At block 810, the power demand prediction model transforms the operational drilling system equipment data, for example, utilizing a drilling system equipment data transformation module (e.g., operational drilling system equipment data transformation module 308). In some embodiments, transforming the operational drilling system equipment data may include scaling the operational drilling system equipment data based on a maximum threshold associated with each of the physical characteristics represented in the operational drilling system equipment data. In some embodiments, transforming the operational drilling system equipment data may include identifying and removing outlier data in the operational drilling system equipment data. Further transformation operations may include data cleaning and/or reformatting the operational drilling system equipment data.

At block 812, the power demand prediction model determines a predicted temporal environmental power demand (e.g., predicted temporal environmental power demand 312) for an associated subterranean drilling system based on the operational drilling system equipment data. For example, in some embodiments, the drilling system equipment data transformation module may be configured to generate operational drilling system equipment data features (e.g., operational drilling system equipment data features 314) based on the operational drilling system equipment data. The power demand prediction model may ingest the operational drilling system equipment data features and based on the trained power demand prediction model generate a predicted temporal environmental power demand associated with the subterranean drilling system.

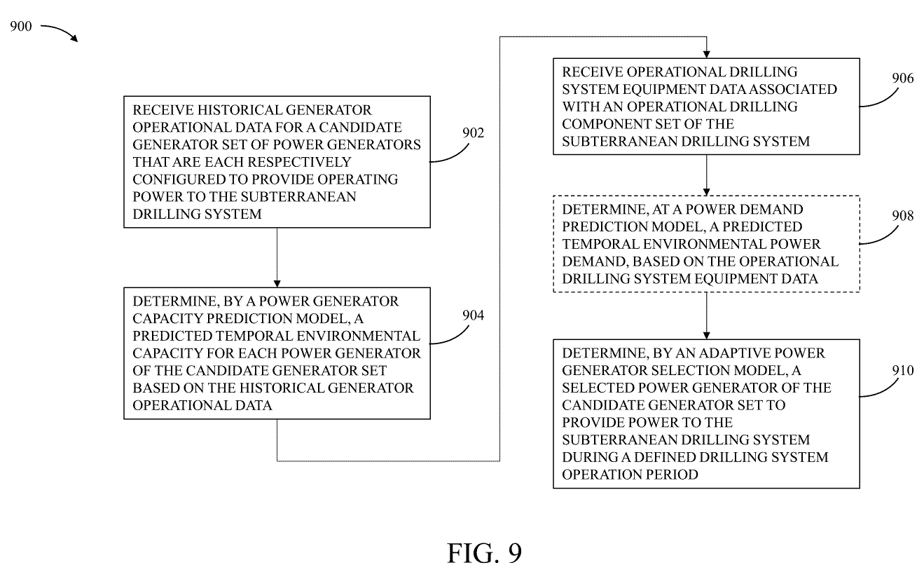

Referring to FIG. 9, a flow chart 900 illustrating operations executed by an adaptive multi-model power selection apparatus (e.g., adaptive multi-model power selection apparatus 222) deploying an example adaptive power generator selection model (e.g., adaptive power generator selection model 302) is provided. At block 902, the adaptive multi-model power selection apparatus receives historical generator operational data (e.g., historical generator operational data 504) for a candidate generator set (e.g., candidate generator set 104) of power generators that are each respectively configured to provide operating power to the subterranean drilling system (e.g., subterranean drilling system 100). Historical generator operational data may include observed physical characteristics from various power generators, combined in various candidate generator sets, in support of various drilling and non-drilling activities, in various environmental conditions and locations, and various subterranean drilling system setups collected over time. The variation in historical generator operational data may increase the accuracy and reliability of a power generator capacity prediction model in constantly varying operating conditions.

In some embodiments, the historical generator operational data may be subject to transformation techniques to prepare the data for use in generation of a power generator capacity prediction model (e.g., power generator capacity prediction model 304). For example, in some embodiments, the historical generator operational data may be scaled, filtered, cleaned, and/or reformatted. In some embodiments, candidate generator set data features (e.g., candidate generator set data features 316) may be extracted from the historical generator operational data in preparation for training and/or updating the power generator capacity prediction model.

In some embodiments, the adaptive multi-model power selection apparatus may be further configured to receive historical generator environmental data (e.g., historical generator environmental data 506), and/or corresponding drilling system historical data (e.g., corresponding drilling system historical data 508) corresponding to the historical generator operational data.

At block 904, the adaptive multi-model power selection apparatus determines, by a power generator capacity prediction model, a predicted temporal environmental capacity (e.g., predicted temporal environmental capacity 318) for each power generator of the candidate generator set based on the historical generator operational data. The power capacity for each power generator in the candidate generator set (e.g., candidate generator set 104) may vary over time due to various operational and environmental factors, for example, run times, operational efficiency, maintenance schedules, fuel levels, real-time fuel efficiency, measured load, internal temperatures, weather conditions, humidity, and so on. The predicted temporal environmental capacity provides a forecast maximum amount of electrical power an associated power generator may produce at a given time (e.g., drilling system operation period).

At block 906, the adaptive multi-model power selection apparatus receives operational drilling system equipment data (e.g., operational drilling system equipment data 210) associated with an operational drilling component set (e.g., operational drilling component set 202) of the subterranean drilling system. The operational drilling system equipment data may include operational data associated with various components of the subterranean drilling system, including data generated by equipment of the operational drilling component set, data generated by various sensors disposed at strategic positions of the subterranean drilling system, and/or based on planning materials, such as a well plan. In some embodiments, the data may be transmitted and/or stored at a rig controller (e.g., rig controller 106) in real-time. In some embodiments, the adaptive multi-model power selection apparatus may further receive environmental data, location data, and/or geological data corresponding to the operational drilling system equipment data.

The power demands of the subterranean drilling system vary based on various factors including environmental conditions, operating characteristics of the rig equipment, location and geology of the drilling site, and/or the well plan associated with the drilling operations. An adaptive multi-model power selection apparatus may utilize the data related to the subterranean drilling system to determine a real-time power demand of the subterranean drilling system.

In some embodiments, the adaptive multi-model power selection apparatus may determine, at a power demand prediction model (e.g., power demand prediction model 306), a predicted temporal environmental power demand (e.g., predicted temporal environmental power demand 312), based on the operational drilling system equipment data. For example, a power demand prediction model 306 may be trained based on various historical subterranean drilling system data, such as historical operational drilling system equipment data, historical operational environmental data, historical operational location data, and/or historical operational geological data. During a classification phase, the adaptive multi-model power selection apparatus may receive real-time operational drilling system equipment data and corresponding environmental data, location data, geological data, and/or well plan data. In such an embodiment, the power demand prediction may determine a predicted temporally environmental power demand for one or more drilling system operation periods based on the subterranean drilling system data.

At block 910, the adaptive multi-model power selection apparatus determines, by an adaptive power generator selection model (e.g., adaptive power generator selection model 302), a selected power generator of the candidate generator set to provide power to the subterranean drilling system during a defined drilling system operation period. Based on the predicted temporal environmental capacity for each power generator in the candidate generator set, and the power demand (or predicted temporal environmental power demand), the adaptive power generator selection model may determine a set of selected power generators. The adaptive multi-model power selection apparatus may transmit a selected power generator signal (e.g., selected power generator signal 220) indicating the selected power generators to enable and/or disable.

In some embodiments, the adaptive power generator selection model may select the selected power generator set based on a cost-based reduction strategy. For example, the set of selected power generators may be selected to minimize fuel consumption cost, minimize emissions, maximize performance, minimize operation time, or otherwise optimize operation of

### Example Insight Interface

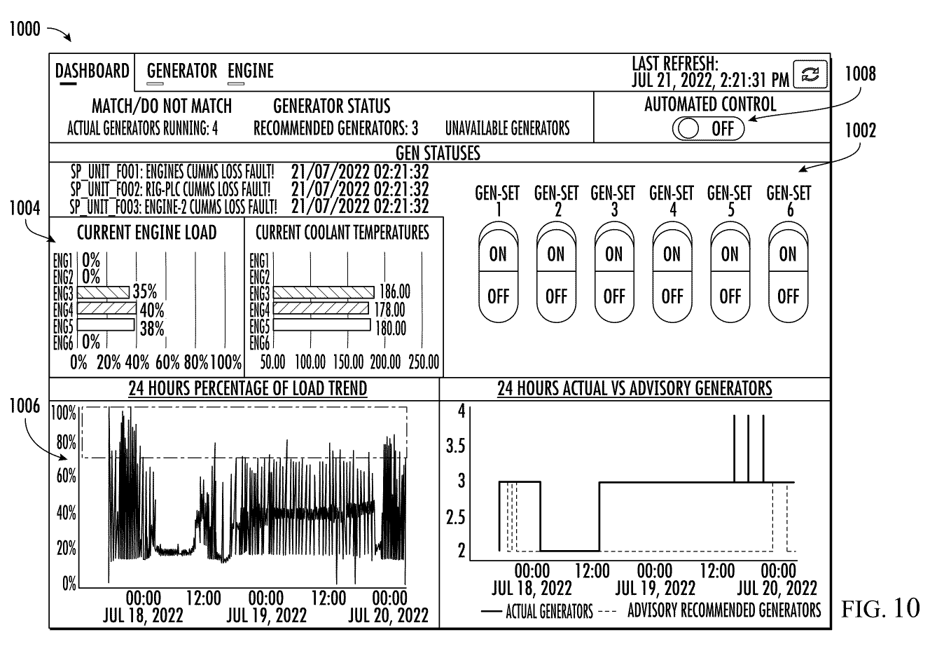

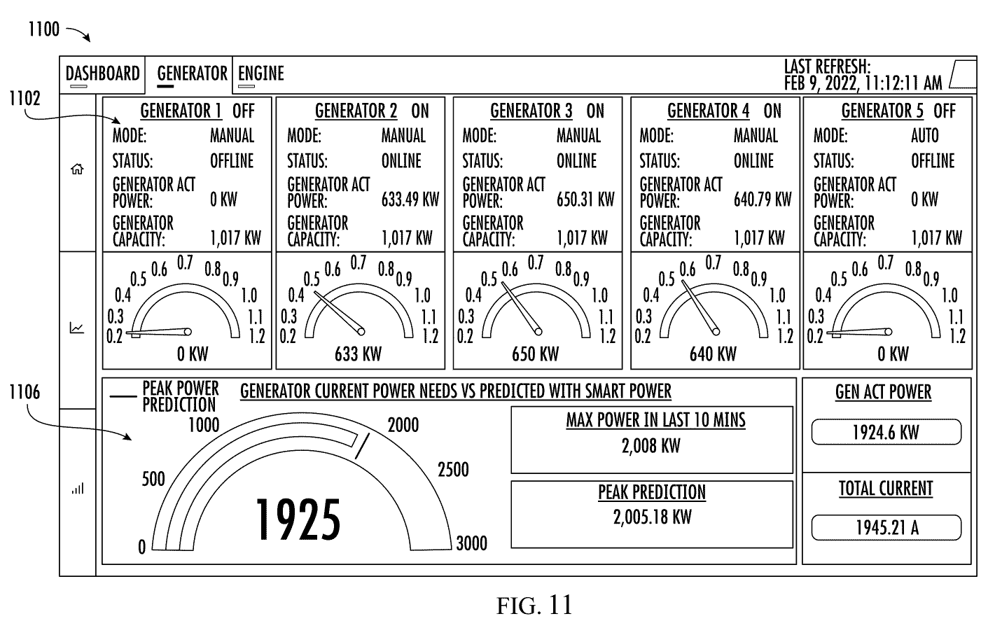

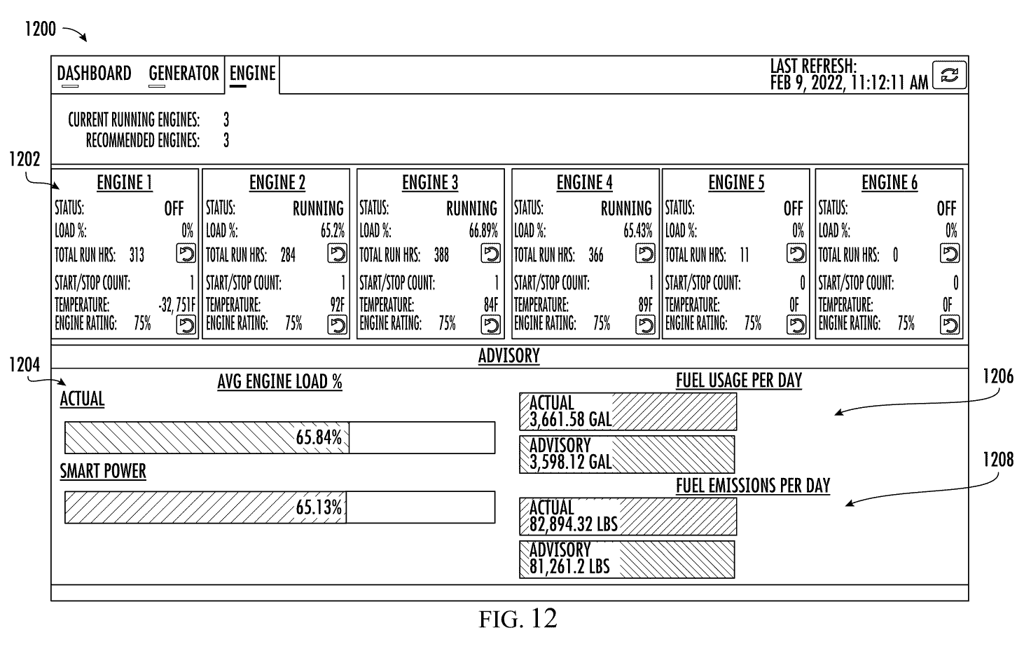

Referring now to FIGS. 10-12, example graphical user interfaces 1000, 1100, 1200 configured to enable user engagement with an adaptive multi-model power selection apparatus (e.g., adaptive multi-model power selection apparatus 222) in accordance with an example embodiment of the present disclosure are depicted. For example, in some embodiments, the adaptive multi-model power selection apparatus may operate on or connect with a rig controller (e.g., rig controller 106). The graphical user interfaces 1000, 1100, 1200 may provide status with regard to operation of the adaptive multi-model power selection apparatus. The graphical user interfaces 1000, 1100, 1200 may further enable user input to override, authorize, affirm, or select one or more operations of the adaptive multi-model power selection apparatus.

Referring now to FIG. 10, an example dashboard graphical user interface 1000 is provided. As depicted in FIG. 10, the dashboard graphical user interface 1000 depicts a visual representation of the number, availability, and operating status of each of the power generators in a candidate generator set 104. In some embodiments, the generator status 1002 may indicate the selected power generators (e.g., selected power generator signal 220), as determined by an adaptive power generator selection model (e.g., adaptive power generator selection model 302) of the adaptive multi-model power selection apparatus. In some embodiments, an operator may override the operating status of one or more power generators through the dashboard graphical user interface 1000. For example, the operator may enable or disable a power generator.

As further depicted in FIG. 10, the example dashboard graphical user interface 1000 is configured to depict candidate generator set data (e.g., engine status 1004) of each of the power generators comprising the candidate generator set 104. The engine status 1004 may provide insight into the operation of the engines powering the power generators. For example, the engine status 1004 may visually depict current engine load, current temperatures, and so on.

As further depicted in FIG. 10, the example dashboard graphical user interface 1000 is configured to depict historical generator operational data (e.g., load trend 1006). The load trend 1006 may provide a visual representation of the percentage of load relative to the output power capacity, over time.

As further depicted in FIG. 10, the example dashboard graphical user interface 1000 includes an automated control switch 1008. The automated control switch 1008 enables an operator to switch between an auto mode, in which power generators are automatically enabled and disabled according to the selected power generator signal provided by the adaptive multi-model power selection apparatus, and a manual mode, in which an operator manually selects which power generators are enabled are enabled and disabled. In some embodiments, in a manual mode, the dashboard graphical user interface 1000 may be configured to suggest the power generators to enable and disable based on the selected power generator signal, however, actual selection of power generators to enable and disable may be done by an operator, manually.

Referring now to FIG. 11, an example generator status graphical user interface 1100 is provided. As depicted in FIG. 11, the generator status graphical user interface 1100 includes individualized generator data 1102 providing additional candidate generator set data for each power generator in the candidate generator set. As depicted in FIG. 11, the individualized generator data 1102 may include generator status (e.g., on/off), generator mode (e.g., manual/automatic), generator status (e.g., online/offline), generator current power, generator capacity, and so on.

As further depicted in FIG. 11, the example generator status graphical user interface 1100 is configured to depict operating power status 1106. The operating power status 1106 depicts the real-time operating power (e.g., operating power 208) provided by the candidate generator set to the associated subterranean drilling system. As depicted in FIG. 11, the operating power status 1106 depicts the real-time operating power relative to a predicted peak power demand (e.g., predicted temporal environmental power demand 312).

Referring now to FIG. 12, an example engine status graphical user interface 1200 is provided. As depicted in FIG. 12, the engine status graphical user interface 1200 includes individualized engine data 1202 providing additional candidate generator set data relative to each engine associated with each power generator in the candidate generator set. As depicted in FIG. 12, the individualized generator data 1102 may include engine status (e.g., on/off), load percent, total running hours, start/stop count, engine temperature, efficiency rating, and so on.

As further depicted in FIG. 12, the example engine status graphical user interface 1200 is configured to depict additional candidate generator set data, such as, engine load status 1204, engine fuel usage 1206, and engine emissions status 1208. In each instance, the actual engine data is depicted relative to a target value as determined by the adaptive multi-model power selection apparatus.

### Example System Architecture for Additional Use Cases

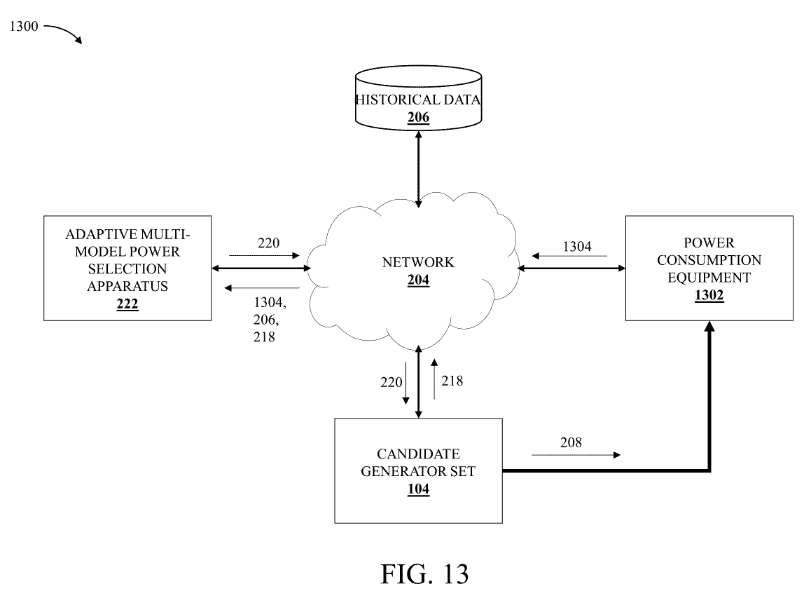

FIG. 13 illustrates an example block diagram of an example adaptive power management system 1300. The example adaptive power management system 1300 includes an adaptive multi-model power selection apparatus 222, access to stored historical data 206, candidate generator set 104, and power consumption equipment 1302, each configured to communicate over a network 204. In addition, the candidate generator set 104 is further configured to generate operating power 208 provided to the power consumption equipment 1302.

As depicted in FIG. 13, the adaptive multi-model power selection apparatus 222, stored historical data 206, candidate generator set 104, and power consumption equipment 1302 may be in communication using a network 204. The network 204 may include any wired or wireless communication network including, for example, a wired or wireless local area network (LAN), personal area network (PAN), metropolitan area network (MAN), wide area network (WAN), the like, or combinations thereof, as well as any hardware, software and/or firmware required to implement the network 204 (e.g., network routers, etc.). For example, the network 204 may include a cellular telephone, an 802.11, 802.16, 802.20, and/or WiMAX network. Further, the network 204 may include a public network, such as the Internet, a private network, such as an intranet, or combinations thereof, and may utilize a variety of networking protocols now available or later developed including, but not limited to Transmission Control Protocol/Internet Protocol (TCP/IP) based networking protocols. In some embodiments, the protocol is a custom protocol of JavaScript Object Notation (JSON) objects sent via a WebSocket channel. In some embodiments, the protocol is JSON over RPC, JSON over REST/HTTP, the like, or combinations thereof.

As depicted in FIG. 13, the adaptive power management system 1300 includes power consumption equipment 1302. Power consumption equipment 1302 refers to any equipment, tools, or other mechanical or electrical equipment that utilize the operating power 208 provided by the candidate generator set 104. The components of the power consumption equipment 1302 work in coordination to a task, such as operating a ship, powering an off-grid facility, and so on. For example, in the context of a marine vessel, power consumption equipment 1302 may include but is not limited to propulsion system components, such as propulsion motors and thrusters; heating and cooling system components; pump systems; compressor systems; hydraulic systems; lighting; navigation equipment; control systems; cargo handling equipment; and so on. In the context of off-grid facilities, power consumption equipment may include medical equipment in a remote medical facility; refrigeration systems; heating, ventilation, and air conditioning systems (HVAC); lighting systems; air purification systems; water and sanitation systems; technology and communications systems; surveillance systems; security systems; data centers; and so on. The power requirements of each component of the power consumption equipment 1302 may vary dynamically based on factors such as operating time, environmental conditions, terrain, geographic location, ocean conditions, etc. For example, during a remote field operation in mountainous terrain with freezing temperatures, and/or active surveillance equipment, power demand may surge due to heating systems and/or communications gear. However, in a temperate, low-activity zone with mild weather and minimal equipment use, power consumption may remain low, limited to basic lighting and electrical equipment. In addition, different stages of a voyage plan executed by the adaptive multi-model power selection apparatus may require varying amounts of operating power due to the distinct demands of each phase. For example, during a storm in open ocean with high waves and freezing temperatures, a marine vessel may consume significantly more power to operate propulsion systems, de-icing equipment, and enhanced navigation tools. However, in calm tropical waters, power demand may drop dramatically. As a result, the power demand of the marine vessel may fluctuate across differing power operation periods.

Such variations necessitate a flexible and intelligent approach to power distribution. Thus, the adaptive multi-model power selection apparatus 222 is configured to determine the real-time power demand of the power consumption equipment 1302 and select power generators from the candidate generator set 104 to provide operating power 208 based on one or more cost-based reduction strategies.

Each component in the power consumption equipment 1302 may also be a source of power consumption equipment data 1304. For instance, a propulsion system on a marine vessel may provide displacement and weight data, water resistance and drag data, speed and acceleration data, ocean conditions (e.g., wave data, current data), wind data, weather data, propeller efficiency, and so on. Such data may be collected in real time and transmitted to systems like a data recorder on the adaptive power management system 1300. Power consumption equipment 1302 at an off-grid facility may include surveillance equipment data such as transmission data, environmental interference, etc.; HVAC system data such as ambient temperature, humidity, system efficiency, etc.; refrigeration system data such as cooling efficiency, environment temperature, refrigeration temperature, etc.; lighting system data; navigation system data; and so on.

Each component of the power consumption equipment 1302 may collect and transmit power consumption equipment data 1304. The data produced by components within the power consumption equipment 1302 may vary significantly across several dimensions. For example, periodicity may differ depending on the function and criticality of the equipment. Some components, like propulsion systems and medical equipment, may generate high-frequency, real-time data, while others, such as weather equipment, may produce event-based or intermittent data. Formatting can also vary, with outputs ranging from structured numerical logs (e.g., RPM, pressure, torque) to unstructured status messages or alerts. Additionally, units of measurement may differ across components and systems, such as psi for pressure, feet or meters for depth, and degrees for angular orientation, requiring normalization for integrated analysis. Further, error rates within the power consumption equipment data 1304 may dictate how the data is filtered and analyzed. Each component of the power consumption equipment 1302 may be further configured to communicate the power consumption equipment data 1304 in accordance with a different communication protocol. Thus, the adaptive multi-model power selection apparatus 222 may be configured to filter, normalize, correct errors, and reformat disparate incoming data streams by applying transformation logic that accounts for variations in data periodicity, structure, units of measurement, encoding formats, source reliability, etc., enabling consistent and accurate integration across various operational inputs.

As further depicted in FIG. 13, the adaptive power management system 1300 includes a candidate generator set 104. The candidate generator set 104 comprises a group of power generators configured to provide the operating power 208 to the power consumption equipment 1302 of the adaptive power management system 1300 based on the selected power generator signal 220 transmitted by the adaptive multi-model power selection apparatus 222. The selected power generator signal 220 comprises any electrical signal (e.g., wired/wireless) configured to encode data to enable/disable one or more power generators in the candidate generator set 104 and/or directly enable/disable power generators in the candidate generator set 104. For example, the power generators of the candidate generator set 104 may be selectively enabled or disabled based on the selected power generator signal 220 to vary the operating power 208 provided to the power consumption equipment 1302 based on power demand and power generator capacity.

The power output of the set of power generators comprising the candidate generator set 104 may be combined by synchronizing their electrical outputs, typically through a common bus or distribution system, such that the individual contributions of the power generators sum to form a single, unified operating power 208. The aggregated operating power 208 may then be directed to support operational loads across the power consumption equipment 1302. By selectively enabling or disabling individual generators within the candidate generator set 104 by the selected power generator signal 220, the operating power 208 may be dynamically adjusted.

As further depicted in FIG. 13, the candidate generator set 104 is configured to transmit candidate generator set data 218. The candidate generator set data 218 is received at least by the adaptive multi-model power selection apparatus 222. The candidate generator set data 218 may include operational data for each of the individual power generators comprising the candidate generator set 104 and/or data related to the candidate generator set 104 as a whole. Example candidate generator set data may comprise generator operational data, for example, electrical output of each power generator, total electrical output of the candidate generator set, run time, operational efficiency, maintenance schedules, fuel levels, fuel efficiency, load, internal temperatures, and so on. In addition, candidate generator set data 218 may further comprise generator environmental data related to environmental characteristics in and around the candidate generator set 104. For example, generator environmental data may include internal and external temperatures, internal and external humidity, current weather data, weather forecast data, and so on.

As further depicted in FIG. 13, the adaptive power management system 1300 may access historical data 206. The historical data 206 includes any recorded information from past operations, including both internal metrics (e.g., electrical characteristics, run times, operational efficiency, fuel levels, fuel efficiency, internal temperatures, and so on), physical power consumption equipment characteristics (e.g., displacement data, weight data, drag data, speed data, acceleration data, propeller efficiency, transmission data, ambient temperature data cooling efficiency data, and so on), and external environmental factors (like weather conditions, location, elevation, environment classification, onshore/offshore, ocean data, wind data, weather data, and so on). The historical data 206 may be collected over time and stored in structured formats, enabling the adaptive multi-model power selection apparatus 222 to access the historical data 206 to analyze patterns and make informed decisions.

Historical data 206 may be stored and accessed through a variety of systems depending on the scale, complexity, and use of the data. Common storage methods include databases, data warehouses, and cloud-based platforms. As depicted in FIG. 13, access to historical data 206 occurs via a network 204, typically facilitated through query languages, dashboards, or data integration tools that systems such as the adaptive multi-model power selection apparatus 222 to retrieve, filter, and analyze the historical data 206. In some embodiments, the operational historical data is correlated with environmental historical data to provide context for understanding cause-and-effect relationships, identifying anomalies, and forecasting future performance. The historical data 206 may include at least historical generator operational data, historical generator environmental data, corresponding drilling system historical data, historical operational environmental data, historical operational drilling system geological data, and historical operational drilling system location data.

As further depicted in FIG. 13, the adaptive power management system 1300 includes an adaptive multi-model power selection apparatus 222. The adaptive multi-model power selection apparatus 222 is configured to receive various input data (e.g., power consumption equipment data 1304, candidate generator set data 218, and historical data 206) and generate a selected power generator signal 220 indicating the power generators of the candidate generator set 104 to be enabled and disabled.

The adaptive multi-model power selection apparatus 222 is designed to implement a plurality of machine learning models, including but not limited to, a power generator capacity prediction model, a power demand prediction model, and/or an adaptive power generator selection model. In general, the adaptive multi-model power selection apparatus 222 is configured to receive candidate generator set data 218 comprising real-time operational and environmental data for the candidate generator set 104 utilize a power generator capacity prediction model to determine a temporal environmental capacity for each of the power generators in the candidate generator set 104, wherein the power generator capacity prediction model is trained based on historical generator operational and environmental data (e.g., historical data 206) of an ensemble of power generators. The temporal environmental capacity provides a real-time capacity for each power generator in the candidate generator set 104 over a future period of time specific to the current environment and operation of the power generator.

In addition, the adaptive multi-model power selection apparatus 222 is configured to receive power consumption equipment data 1304 comprising real-time operational and environmental data associated with the power consumption equipment 1302 of the adaptive power management system 1300 and utilize a power demand prediction model to determine a predicted temporal environmental power demand for the adaptive power management system 1300 for a future power operation period, wherein the power demand prediction model is trained based on historical operational drilling system equipment data, environmental data, location data, and/or geological data.

Based on the predicted temporal environmental capacity of each power generator in the candidate generator set 104, and the predicted temporal environmental power demand of the power consumption equipment 1302, the adaptive multi-model power selection apparatus 222 utilizes an adaptive power generator selection model to select a set of power generators of the candidate generator set 104 to be enabled. The selected set of power generators is transmitted to the candidate generator set 104 through the selected power generator signal 220.

In some embodiments, the adaptive multi-model power selection apparatus 222 may be implemented on one or more compute devices at the subterranean drilling system. For example, the adaptive multi-model power selection apparatus 222 may be operated at the rig controller (e.g., rig controller 106) of the subterranean drilling system. The adaptive multi-model power selection apparatus 222 is further described in relation to FIG. 3.

### Example System Architecture for Additional Use Cases

In an example embodiment, the adaptive multi-model power selection apparatus (e.g., adaptive multi-model power selection apparatus 222) may be utilized as part of an adaptive power management system (e.g., adaptive power management system 1300) to determine selected power generators (e.g., as indicated by the selected power generator signal 220) for a marine vessel. During operation, ships and other marine vessels may rely heavily on multiple power generators in a candidate power generator set (e.g., candidate generator set 104) to meet fluctuating power demands.

Power generator capacity and power demand may vary across power operation periods during operation of a marine vessel. Voyage plans executed by a marine vessel may comprise a plurality of power operation periods. Voyage plans may outline the intended route, waypoints, speed, fuel requirements, weather considerations, and so on for a specific route. Power operation periods may comprise any time segment of a voyage plan. Power operation periods may be separated by waypoint, or other voyage plan indicator. In some embodiments, the power operation periods may be a fixed time period (e.g., 5 minutes).

Power generator capacity may vary across power operation periods based on various factors. For example, generator operational data (e.g., electrical output), run time, operational efficiency, weather data, generator maintenance, fuel data, current load, internal temperatures, and so on may cause variations in the power capacity of each power generator of the candidate generator set from one power operation period to the next. Thus, the set of selected power generators selected to provide power to the marine vessel depends on the predicted temporal environmental capacity of each power generator in the candidate generator set during a given power operation period. During operation, candidate generator set data may be gathered and provided to a power generator capacity prediction model (e.g., power generator capacity prediction model 304). The power generator capacity prediction model may utilize historical generator operational data, historical generator environmental data, and associated historical marine vessel operational data to predict the instantaneous generator capacity (e.g., predicted temporal environmental capacity) for each power generator in a candidate generator set based on the candidate generator set data. In some embodiments, candidate generator set data may include power generator engine health data, maintenance data, age data, etc.

In addition, the power demand of the marine vessel may vary across power operation periods. For example, marine vessel operational data, environmental data, location data, and/or ocean data may all affect the power demand of a marine vessel. Marine vessel operational data may include but is not limited to vessel data such as vessel speed, vessel displacement, cargo weight, hull condition, etc.; auxiliary system data such as HVAC, lighting, navigation systems, communication systems data; and so on. Marine vessel operation data may further include weather conditions; air temperatures; ocean conditions such as wave height, wave frequency, wind speed and direction, current speed and direction, water temperature, salinity, water temperatures, cargo weight; and so on.

The power demand prediction model (e.g., power demand prediction model 306) is trained in various embodiments to output a predicted temporal environmental power demand for the marine vessel based on historical marine vessel operational data. Historical marine vessel operational data may be collected across various vessel types, voyage plans, weather conditions, ocean conditions, cargo types, seasons, and so on to train a power demand prediction model to provide a predicted temporal environmental power demand (e.g., predicted temporal environmental power demand 312). During operation, marine vessel data may be obtained from sensors deployed within and around the marine vessel to provide marine vessel operational data to the power demand prediction model. Based on the historical marine vessel operational data, historical environmental data, location data, and/or ocean data, the power demand prediction model generates a predicted temporal environmental power demand.

An adaptive power generator selection model may be configured to determine a selected power generator (or selected power generator set) to provide power to the marine vessel based on the predicted temporal environmental capacity of each of the power generators in the candidate generator set, based on the power demand of the marine vessel, and based on one or more cost-based reduction strategies. Cost-based reduction strategies for a marine vessel may include strategies to optimize fuel efficiency, maximize generator utilization, reduce travel time, reduce emissions, and so on.

Applying the adaptive multi-model power selection technology to the marine and shipping industry may offer transformative potential for optimizing selected power generators in a candidate generator set (e.g., candidate generator set 104) on board a marine vessel.

### Example Adaptive Power Management System for an Off-Grid Facility

In some embodiments, the adaptive multi-model power selection apparatus (e.g., adaptive multi-model power selection apparatus 222) may be utilized as part of an adaptive power management system (e.g., adaptive power management system 1300) to determine selected power generators (e.g., as indicated by the selected power generator signal 220) for an off-grid facility. Off-grid facilities comprise any location or infrastructure that operates independently from centralized electrical power grids. Off-grid facilities rely on self-contained energy systems (e.g., power generators, solar, wind, hydro, etc.) to meet operating power demands. Off-grid facilities are often situated in remote or inaccessible areas where grid connection is impractical or unavailable. Off-grid facilities may include but are not limited to isolated communities, military outposts, research stations, exploration sites, or emergency response camps. During operation, off-grid facilities may rely heavily on multiple power generators in a candidate power generator set (e.g., candidate generator set 104) to meet fluctuating power demands.

Power generator capacity and power demand may vary across power operation periods during operation of an off-grid facility. In some embodiments, an off-grid facility may employ a power schedule incorporating a schedule of enabled power consuming equipment. Power consuming equipment on a power schedule may include lighting systems, water pump systems, HVAC systems, security systems, communication systems, and so on. Power operation periods may comprise any time segment of a power plan. Power operation periods may be separated by various events in the power plan. In some embodiments, the power operation periods may be a fixed time period (e.g., 5 minutes).

Power generator capacity may vary across power operation periods based on various factors. For example, generator operational data (e.g., electrical output), run time, operational efficiency, weather data, generator maintenance, fuel data, current load, internal temperatures, and so on may cause variations in the power capacity of each power generator of the candidate generator set from one power operation period to the next. Thus, the set of selected power generators selected to provide power to the off-grid facility may depend on the predicted temporal environmental capacity of each power generator in the candidate generator set during a given power operation period. During operation, candidate generator set data may be gathered and provided to a power generator capacity prediction model (e.g., power generator capacity prediction model 304). The power generator capacity prediction model may utilize historical generator operational data, historical generator environmental data, and associated historical off-grid facility operational data to predict the instantaneous generator capacity (e.g., predicted temporal environmental capacity) for each power generator in a candidate generator set based on the candidate generator set data. In some embodiments, candidate generator set data may include power generator engine health data, maintenance data, age data, etc.

In addition, the power demand of the off-grid facility may vary across power operation periods. For example, off-grid facility operational data, environmental data, and/or location data may all affect the power demand of an off-grid facility. Off-grid facility operational data may include but is not limited to electrical characteristics such as time-varying power demand, voltage, current, etc.; structural characteristics, such as building sizes and layout, building type, roof type, insulation materials; equipment characteristics such as equipment type, power requirements, real-time current, and so on; occupancy patterns such as work schedules, event schedules, equipment schedules, and so on; and other physical and operational characteristics of the off-grid facility.

The power demand prediction model (e.g., power demand prediction model 306) is trained in various embodiments to output a predicted temporal environmental power demand for the off-grid facility based on historical off-grid facility operational data. Historical off-grid facility operational data may be collected across various facility types, power plans, weather conditions, elevations, locations, resources, and so on to train a power demand prediction model to provide a predicted temporal environmental power demand (e.g., predicted temporal environmental power demand 312). During operation, off-grid facility operational data may be obtained from sensors deployed within and around the off-grid facility to provide off-gird facility operational data to the power demand prediction model. Based on the historical off-grid facility operational data, historical environmental data, location data, and/or geological data, the power demand prediction model generates a predicted temporal environmental power demand.

An adaptive power generator selection model may be configured to determine a selected power generator (or selected power generator set) to provide power to the off-grid facility based on the predicted temporal environmental capacity of each of the power generators in the candidate generator set, based on the power demand of the off-grid facility, and based on one or more cost-based reduction strategies. Cost-based reduction strategies for an off-grid facility may include strategies to optimize fuel efficiency, maximize generator utilization, avoid down time, reduce emissions, and so on.

Applying the adaptive multi-model power selection technology to an off-grid facility may offer transformative potential for optimizing selected power generators in a candidate generator set (e.g., candidate generator set 104) providing operational power to an off-grid facility.

### Example Adaptive Multi-Model Power Selection Apparatus Architecture

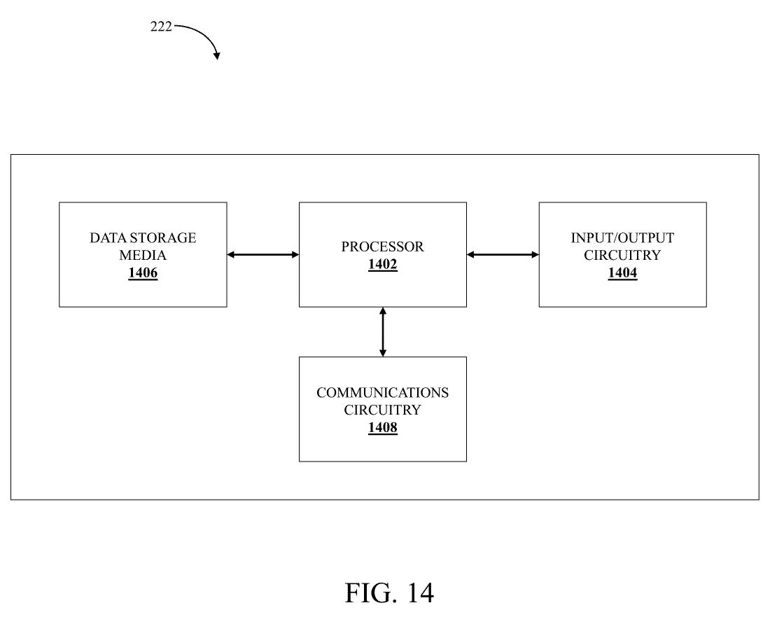

Referring now to FIG. 14, FIG. 14 illustrates an example adaptive multi-model power selection apparatus 222 in accordance with at least some example embodiments of the present disclosure. The adaptive multi-model power selection apparatus 222 includes processor 1402, input/output circuitry 1404, data storage media 1406, and communications circuitry 1408. In some embodiments, the adaptive multi-model power selection apparatus 222 is configured, using one or more of the sets of circuitry 1402, 1404, 1406, and/or 1408, to execute and perform the operations described herein.

Although components are described with respect to functional limitations, it should be understood that the particular implementations necessarily include the use of particular computing hardware. It should also be understood that in some embodiments certain of the components described herein include similar or common hardware. For example, two sets of circuitry may both leverage use of the same processor(s), network interface(s), storage medium(s), and/or the like, to perform their associated functions, such that duplicate hardware is not required for each set of circuitry. The user of the term “circuitry” as used herein with respect to components of the apparatuses described herein should therefore be understood to include particular hardware configured to perform the functions associated with the particular circuitry as described herein.

Particularly, the term “circuitry” should be understood broadly to include hardware and, in some embodiments, software for configuring the hardware. For example, in some embodiments, “circuitry” includes processing circuitry, storage media, network interfaces, input/output devices, and/or the like. Alternatively, or additionally, in some embodiments, other elements of the adaptive multi-model power selection apparatus 222 provide or supplement the functionality of other particular sets of circuitry. For example, the processor 1402 in some embodiments provides processing functionality to any of the sets of circuitry, the data storage media 1406 provides storage functionality to any of the sets of circuitry, the communications circuitry 1408 provides network interface functionality to any of the sets of circuitry, and/or the like.

In some embodiments, the processor 1402 (and/or co-processor or any other processing circuitry assisting or otherwise associated with the processor) is/are in communication with the data storage media 1406 via a bus for passing information among components of the adaptive multi-model power selection apparatus 222. In some embodiments, for example, the data storage media 1406 is non-transitory and may include, for example, one or more volatile and/or non-volatile memories. In other words, for example, the data storage media 1406 in some embodiments includes or embodies an electronic storage device (e.g., a computer readable storage medium). In some embodiments, the data storage media 1406 is configured to store information, data, content, applications, instructions, or the like, for enabling the adaptive multi-model power selection apparatus 222 to carry out various functions in accordance with example embodiments of the present disclosure.

The processor 1402 may be embodied in a number of different ways. For example, in some example embodiments, the processor 1402 includes one or more processing devices configured to perform independently. Additionally, or alternatively, in some embodiments, the processor 1402 includes one or more processor(s) configured in tandem via a bus to enable independent execution of instructions, pipelining, and/or multithreading. The use of the terms “processor” and “processing circuitry” should be understood to include a single core processor, a multi-core processor, multiple processors internal to the adaptive multi-model power selection apparatus 222, and/or one or more remote or “cloud” processor(s) external to the adaptive multi-model power selection apparatus 222.

In an example embodiment, the processor 1402 is configured to execute instructions stored in the data storage media 1406 or otherwise accessible to the processor. Alternatively, or additionally, the processor 1402 in some embodiments is configured to execute hard-coded functionality. As such, whether configured by hardware or software methods, or by a combination thereof, the processor 1402 represents an entity (e.g., physically embodied in circuitry) capable of performing operations according to an embodiment of the present disclosure while configured accordingly. Alternatively, or additionally, as another example in some example embodiments, when the processor 1402 is embodied as an executor of software instructions, the instructions specifically configure the processor 1402 to perform the algorithms embodied in the specific operations described herein when such instructions are executed.

In some embodiments, the adaptive multi-model power selection apparatus 222 includes input/output circuitry 1404 that provides output to the user and, in some embodiments, to receive an indication of a user input. In some embodiments, the input/output circuitry 1404 is in communication with the processor 1402 to provide such functionality. The input/output circuitry 1404 may comprise one or more user interface(s) (e.g., user interface) and in some embodiments includes a display that comprises the interface(s) rendered as a web user interface, an application user interface, a user device, a backend system, or the like. The processor 1402 and/or input/output circuitry 1404 comprising the processor may be configured to control one or more functions of one or more user interface elements through computer program instructions (e.g., software and/or firmware) stored on a memory accessible to the processor (e.g., data storage media 1406, and/or the like). In some embodiments, the input/output circuitry 1404 includes or utilizes a user-facing application to provide input/output functionality to a client device and/or other display associated with a user.

In some embodiments, the adaptive multi-model power selection apparatus 222 includes communications circuitry 1408. The communications circuitry 1408 includes any means such as a device or circuitry embodied in either hardware or a combination of hardware and software that is configured to receive and/or transmit data from/to a network and/or any other device, circuitry, or module in communication with the adaptive multi-model power selection apparatus 222. In this regard, the communications circuitry 1408 includes, for example in some embodiments, a network interface for enabling communication with a wired or wireless communications network. Additionally or alternatively in some embodiments, the communications circuitry 1408 includes one or more network interface card(s), antenna(s), bus(es), switch(es), router(s), modem(s), and supporting hardware, firmware, and/or software, or any other device suitable for enabling communications via one or more communications network(s). Additionally, or alternatively, the communications circuitry 1408 includes circuitry for interacting with the antenna(s) and/or other hardware or software to cause transmission of signals via the antenna(s) or to handle receipt of signals received via the antenna(s). In some embodiments, the communications circuitry 1408 enables transmission to and/or receipt of data from a client device in communication with the adaptive multi-model power selection apparatus 222.

Additionally, or alternatively, in some embodiments, one or more of the sets of circuitry 1402-1408 are combinable. Additionally, or alternatively, in some embodiments, one or more of the sets of circuitry perform some or all of the functionality described associated with another component. For example, in some embodiments, one or more sets of circuitry 1402-1408 are combined into a single module embodied in hardware, software, firmware, and/or a combination thereof. Similarly, in some embodiments, one or more of the sets of circuitry is/are combined such that the processor 1402 performs one or more of the operations described above with respect to each of these circuitry individually.

### Conclusion

While this detailed description has set forth some embodiments of the present invention, the appended claims cover other embodiments of the present invention which differ from the described embodiments according to various modifications and improvements. For example, one skilled in the art may recognize that such principles may be applied to any power management system utilizing a plurality of power generators to meet a power demand that varies over time. For example, off-grid power generation for remote facilities, smart power generation for marine vessels, mobile field operations or emergency response units, renewable energy microgrids, and so on.

Within the appended claims, unless the specific term “means for” or “step for” is used within a given claim, it is not intended that the claim be interpreted under 35 U.S.C. 112, paragraph 6.

Use of broader terms such as “comprises,” “includes,” and “having” should be understood to provide support for narrower terms such as “consisting of,” “consisting essentially of,” and “comprised substantially of” Use of the terms “optionally,” “may,” “might,” “possibly,” and the like with respect to any element of an embodiment means that the element is not required, or alternatively, the element is required, both alternatives being within the scope of the embodiment(s). Also, references to examples are merely provided for illustrative purposes, and are not intended to be exclusive.

Hereinafter, various characteristics will be highlighted in a set of numbered clauses or paragraphs. These characteristics are not to be interpreted as being limiting on the invention or inventive concept, but are provided merely as a highlighting of some characteristics as described herein, without suggesting a particular order of importance or relevancy of such characteristics.

Clause 1. An adaptive multi-model power selection apparatus for a subterranean drilling system, wherein the adaptive multi-model power selection apparatus comprises one or more processors and one or more memories storing instructions that are operable, when executed by the one or more processors, to cause the adaptive multi-model power selection apparatus to: receive historical generator operational data for a candidate generator set of power generators that are each respectively configured to provide operating power to the subterranean drilling system.

Clause 2. The adaptive multi-model power selection apparatus of clause 1, wherein the instructions are further operable, when executed by the one or more processors to cause the adaptive multi-model power selection apparatus to: determine, by a power generator capacity prediction model, a predicted temporal environmental capacity for each of the power generators of the candidate generator set based on the historical generator operational data.

Clause 3. The adaptive multi-model power selection apparatus of any one of the foregoing clauses, wherein the instructions are further operable, when executed by the one or more processors to cause the adaptive multi-model power selection apparatus to: receive operational drilling system equipment data associated with an operational drilling component set of the subterranean drilling system.

Clause 4. The adaptive multi-model power selection apparatus of any one of the foregoing clauses, wherein the instructions are further operable, when executed by the one or more processors to cause the adaptive multi-model power selection apparatus to: determine, by an adaptive power generator selection model, a selected power generator of the candidate generator set to provide the operating power to the subterranean drilling system during a drilling system operation period.

Clause 5. The adaptive multi-model power selection apparatus of any one of the foregoing clauses, wherein the instructions are further operable, when executed by the one or more processors to cause the adaptive multi-model power selection apparatus to: determine, by the adaptive power generator selection model, a plurality of selected power generators of the candidate generator set to provide the operating power to the subterranean drilling system during the drilling system operation period.

Clause 6. The adaptive multi-model power selection apparatus of any one of clauses 1-4, wherein the instructions are further operable, when executed by the one or more processors to cause the adaptive multi-model power selection apparatus to: determine, at a power demand prediction model, a predicted temporal environmental power demand, based on the operational drilling system equipment data.

Clause 7. The adaptive multi-model power selection apparatus of any one of clauses 1-4 or 6, wherein the instructions are further operable, when executed by the one or more processors to cause the adaptive multi-model power selection apparatus to: receive, at the adaptive power generator selection model, candidate generator set data, and determine the selected power generator based on the predicted temporal environmental capacity for each power generator, the predicted temporal environmental power demand of the operational drilling component set, and the candidate generator set data.

Clause 8. The adaptive multi-model power selection apparatus of any one of clauses 1-4, 6, or 7, wherein the instructions are further operable, when executed by the one or more processors to cause the adaptive multi-model power selection apparatus to: determine the selected power generator based on a cost-based reduction strategy utilizing the candidate generator set data.

Clause 9. The adaptive multi-model power selection apparatus of any one of clauses 1-4, 6, 7, or 8, wherein the candidate generator set data comprises fuel efficiency data of each power generator of the candidate generator set, generator run data of each power generator of the candidate generator set, and/or thermal conditions of each power generator of the candidate generator set.

Clause 10. The adaptive multi-model power selection apparatus of any one of clauses 1-4, 6, 7, or 8, wherein the cost-based reduction strategy determines the selected power generator to reduce a fuel consumption cost and/or an emissions cost.

Clause 11. The adaptive multi-model power selection apparatus of any one of clauses 1-4 or 6, wherein the power demand prediction model comprises a bi-directional recurrent neural network.

Clause 12. The adaptive multi-model power selection apparatus of any one of clauses 1-4 or 6, wherein the instructions are further operable, when executed by the one or more processors to cause the adaptive multi-model power selection apparatus to: receive historical operational drilling system equipment data corresponding to the subterranean drilling system; and train the power demand prediction model based on the historical operational drilling system equipment data.

Clause 13. The adaptive multi-model power selection apparatus of any one of clauses 1-4, 6, or 12, wherein the instructions are further operable, when executed by the one or more processors to cause the adaptive multi-model power selection apparatus to: receive historical operational environmental data corresponding to the historical operational drilling system equipment data; and train the power demand prediction model based on the historical operational environmental data.

Clause 14. The adaptive multi-model power selection apparatus of any one of clauses 1-4, 6, or 12, wherein the instructions are further operable, when executed by the one or more processors to cause the adaptive multi-model power selection apparatus to: receive historical geological data corresponding to the historical operational drilling system equipment data; and train the power demand prediction model based on the historical geological data.

Clause 15. The adaptive multi-model power selection apparatus of any one of clauses 1-4 or 6, wherein the drilling system operation period is greater than five minutes.

Clause 16. The adaptive multi-model power selection apparatus of any one of clauses 1-4, wherein the selected power generator of the candidate generator set is determined based on even wear distribution of each power generator of the candidate generator set.

Clause 17. The adaptive multi-model power selection apparatus of any one of clauses 1-4, wherein the instructions are further operable, when executed by the one or more processors to cause the adaptive multi-model power selection apparatus to: receive, at power generator data transformation module, candidate generator set data comprising one or more physical characteristics associated with the power generators; and scale the candidate generator set data based on a maximum threshold associated with each of the one or more physical characteristics.

Clause 18. The adaptive multi-model power selection apparatus of any one of clauses 1-4 or 17, wherein the instructions are further operable, when executed by the one or more processors to cause the adaptive multi-model power selection apparatus to: identify outlier data in the candidate generator set data; and remove outlier data from the candidate generator set data.

Clause 19. The adaptive multi-model power selection apparatus of any one of clauses 1-4 or 17, wherein the instructions are further operable, when executed by the one or more processors to cause the adaptive multi-model power selection apparatus to: identify missing data in the candidate generator set data; and fill missing data in the candidate generator set data based on linear interpolation.

Clause 20. The adaptive multi-model power selection apparatus of any one of clauses 1-4, wherein the instructions are further operable, when executed by the one or more processors to cause the adaptive multi-model power selection apparatus to: receive, at a power generator data transformation module, the operational drilling system equipment data; and scale the operational drilling system equipment data based on a maximum threshold for each component of the subterranean drilling system.

Clause 21. The adaptive multi-model power selection apparatus of any one of clauses 1-4 or 20, wherein the instructions are further operable, when executed by the one or more processors to cause the adaptive multi-model power selection apparatus to: identify outlier data in the operational drilling system equipment data; and remove outlier data from the operational drilling system equipment data.

Clause 22. The adaptive multi-model power selection apparatus of any one of clauses 1-4 or 20, wherein the instructions are further operable, when executed by the one or more processors to cause the adaptive multi-model power selection apparatus to: identify missing data in the operational drilling system equipment data; and fill missing data in the operational drilling system equipment data based on linear interpolation.

Clause 23. The adaptive multi-model power selection apparatus of any one of clauses 1-4, wherein the operational drilling system equipment data comprises bit depth data, block movement data, pump related data, stroke counts, weight on bit data, hookload data, candidate generator set data, top drive data.

Clause 24. The adaptive multi-model power selection apparatus of any one of clauses 1-4, wherein the power generator capacity prediction model is an iteratively weighted least squares regression model.

Clause 25. The adaptive multi-model power selection apparatus of any one of clauses 1-4, wherein the instructions are further operable, when executed by the one or more processors to cause the adaptive multi-model power selection apparatus to: train the power generator capacity prediction model based on the historical generator operational data.

Clause 26. The adaptive multi-model power selection apparatus of any one of clauses 1-4, wherein the instructions are further operable, when executed by the one or more processors to cause the adaptive multi-model power selection apparatus to: receive historical generator environmental data corresponding to the historical generator operational data; and determine the predicted temporal environmental capacity for each power generator based on the historical generator operational data and corresponding historical generator environmental data.

Clause 27. The adaptive multi-model power selection apparatus of any one of clauses 1-4, wherein the instructions are further operable, when executed by the one or more processors to cause the adaptive multi-model power selection apparatus to: receive historical corresponding drilling system data corresponding to the historical generator operational data; and determine the predicted temporal environmental capacity for each power generator based on the historical generator operational data and historical corresponding drilling system data.

Clause 28. The adaptive multi-model power selection apparatus of any one of clauses 1-4, wherein the instructions are further operable, when executed by the one or more processors to cause the adaptive multi-model power selection apparatus to: utilize model verification techniques to continually ensure stability of the power generator capacity prediction model.

Clause 29. The adaptive multi-model power selection apparatus of any one of clauses 1-4 or 28, wherein the model verification techniques comprise at least one of cumulative sum (CUSUM)-based change detection and rate-of-change detection techniques.

Clause 30. The adaptive multi-model power selection apparatus of any one of clauses 1-4, wherein the instructions are further operable, when executed by the one or more processors to cause the adaptive multi-model power selection apparatus to: store a plurality of shared power generator capacity prediction models; calculate a prediction error for each shared power generator capacity prediction model relative to an observed temporal environmental capacity; and select a selected shared power generator capacity prediction model from the plurality of shared power generator capacity prediction models based on the prediction error.

Clause 31. The adaptive multi-model power selection apparatus of any one of clauses 1-4, wherein the instructions are further operable, when executed by the one or more processors to cause the adaptive multi-model power selection apparatus to: adapt the power generator capacity prediction model based on an observed temporal environmental capacity.

Clause 32. The adaptive multi-model power selection apparatus of any one of clauses 1-4, wherein the instructions are further operable, when executed by the one or more processors to cause the adaptive multi-model power selection apparatus to: determine a historical minimum capacity for each power generator in the candidate generator set; and store the historical minimum capacity for each power generator in the candidate generator set.

Clause 33. The adaptive multi-model power selection apparatus of any one of clauses 1-4, wherein the instructions are further operable, when executed by the one or more processors to cause the adaptive multi-model power selection apparatus to: identify high performance power generators of the candidate generator set; train an anomaly detection model based on the high performance power generators; and detect a poor performance power generator based on a comparison of the poor performance power generator to the anomaly detection model.

Clause 34. A subterranean drilling system comprising: an operational drilling component set configured to generate operational drilling system equipment data; a candidate generator set of power generators that are each respectively configured to provide operating power to the subterranean drilling system; an adaptive multi-model power selection apparatus comprising one or more processors and one or more memories storing instructions that are operable, when executed by the one or more processors, to cause the adaptive multi-model power selection apparatus to: receive historical generator operational data for the candidate generator set of power generators.

Clause 35. The subterranean drilling system of clause 34, wherein the instructions are further operable, when executed by the one or more processors to cause the adaptive multi-model power selection apparatus to: determine, by a power generator capacity prediction model, a predicted temporal environmental capacity for each of the power generators of the candidate generator set based on the historical generator operational data.

Clause 36. The subterranean drilling system of any one of clauses 34-35, wherein the instructions are further operable, when executed by the one or more processors to cause the adaptive multi-model power selection apparatus to: receive the operational drilling system equipment data associated with the operational drilling component set of the subterranean drilling system.

Clause 37. The subterranean drilling system of any one of clauses 34-36, wherein the instructions are further operable, when executed by the one or more processors to cause the adaptive multi-model power selection apparatus to: determine, by an adaptive power generator selection model, a selected power generator of the candidate generator set to provide the operating power to the subterranean drilling system during a drilling system operation period.

Clause 38. The subterranean drilling system of any one of clauses 34-37, wherein the instructions are further operable, when executed by the one or more processors to cause the adaptive multi-model power selection apparatus to: determine, by the adaptive power generator selection model, a plurality of selected power generators of the candidate generator set to provide the operating power to the subterranean drilling system during the drilling system operation period.

Clause 39. The subterranean drilling system of any one of clauses 34-37, wherein the instructions are further operable, when executed by the one or more processors to cause the adaptive multi-model power selection apparatus to: determine, at a power demand prediction model, a predicted temporal environmental power demand, based on the operational drilling system equipment data.

Clause 40. The subterranean drilling system of any one of clauses 34-37 or 39, wherein the instructions are further operable, when executed by the one or more processors to cause the adaptive multi-model power selection apparatus to: receive, at the adaptive power generator selection model, candidate generator set data, and determine the selected power generator based on the predicted temporal environmental capacity for each power generator, the predicted temporal environmental power demand of the operational drilling component set, and the candidate generator set data.

Clause 41. The subterranean drilling system of any one of clauses 34-37, 39, or 40, wherein the instructions are further operable, when executed by the one or more processors to cause the adaptive multi-model power selection apparatus to: determine the selected power generator based on a cost-based reduction strategy utilizing the candidate generator set data.

Clause 42. The subterranean drilling system of any one of clauses 34-37, 39, 40, or 41, wherein the candidate generator set data comprises fuel efficiency data of each power generator of the candidate generator set, generator run data of each power generator of the candidate generator set, and/or thermal conditions of each power generator of the candidate generator set.

Clause 43. The subterranean drilling system of any one of clauses 34-37, 39, 40, or 41, wherein the cost-based reduction strategy determines the selected power generator to reduce a fuel consumption cost and/or an emissions cost.

Clause 44. The subterranean drilling system of any one of clauses 34-37 or 39, wherein the power demand prediction model comprises a bi-directional recurrent neural network.

Clause 45. The subterranean drilling system of any one of clauses 34-37 or 39, wherein the instructions are further operable, when executed by the one or more processors to cause the adaptive multi-model power selection apparatus to: receive historical operational drilling system equipment data corresponding to the subterranean drilling system; and train the power demand prediction model based on the historical operational drilling system equipment data.

Clause 46. The subterranean drilling system of any one of clauses 34-37, 39, or 45, wherein the instructions are further operable, when executed by the one or more processors to cause the adaptive multi-model power selection apparatus to: receive historical operational environmental data corresponding to the historical operational drilling system equipment data; and train the power demand prediction model based on the historical operational environmental data.

Clause 47. The subterranean drilling system of any one of clauses 34-37, 39, or 45, wherein the instructions are further operable, when executed by the one or more processors to cause the adaptive multi-model power selection apparatus to: receive historical geological data corresponding to the historical operational drilling system equipment data; and train the power demand prediction model based on the historical geological data.

Clause 48. The subterranean drilling system of any one of clauses 34-37 or 39, wherein the drilling system operation period is greater than five minutes.

Clause 49. The subterranean drilling system of any one of clauses 34-37, wherein the selected power generator of the candidate generator set is determined based on even wear distribution of each power generator of the candidate generator set.

Clause 50. The subterranean drilling system of any one of clauses 34-37, wherein the instructions are further operable, when executed by the one or more processors to cause the adaptive multi-model power selection apparatus to: receive, at power generator data transformation module, candidate generator set data comprising one or more physical characteristics associated with the power generators; and scale the candidate generator set data based on a maximum threshold associated with each of the one or more physical characteristics.

Clause 51. The subterranean drilling system of any one of clauses 34-37, wherein the instructions are further operable, when executed by the one or more processors to cause the adaptive multi-model power selection apparatus to: identify outlier data in the candidate generator set data; and remove outlier data from the candidate generator set data.

Clause 52. The subterranean drilling system of any one of clauses 34-37 or 50, wherein the instructions are further operable, when executed by the one or more processors to cause the adaptive multi-model power selection apparatus to: identify missing data in the candidate generator set data; and fill missing data in the candidate generator set data based on linear interpolation.

Clause 53. The subterranean drilling system of any one of clauses 34-37, wherein the instructions are further operable, when executed by the one or more processors to cause the adaptive multi-model power selection apparatus to: receive, at a power generator data transformation module, the operational drilling system equipment data; and scale the operational drilling system equipment data based on a maximum threshold for each component of the subterranean drilling system.

Clause 54. The subterranean drilling system of any one of clauses 34-37 or 53, wherein the instructions are further operable, when executed by the one or more processors to cause the adaptive multi-model power selection apparatus to: identify outlier data in the operational drilling system equipment data; and remove outlier data from the operational drilling system equipment data.

Clause 55. The subterranean drilling system of any one of clauses 34-37 or 53, wherein the instructions are further operable, when executed by the one or more processors to cause the adaptive multi-model power selection apparatus to: identify missing data in the operational drilling system equipment data; and fill missing data in the operational drilling system equipment data based on linear interpolation.

Clause 56. The subterranean drilling system of any one of clauses 34-37, wherein the operational drilling system equipment data comprises bit depth data, block movement data, pump related data, stroke counts, weight on bit data, hookload data, candidate generator set data, top drive data.

Clause 57. The subterranean drilling system of any one of clauses 34-37, wherein the power generator capacity prediction model is an iteratively weighted least squares regression model.

Clause 58. The subterranean drilling system of any one of clauses 34-37, wherein the instructions are further operable, when executed by the one or more processors to cause the adaptive multi-model power selection apparatus to: train the power generator capacity prediction model based on the historical generator operational data.

Clause 59. The subterranean drilling system of any one of clauses 34-37, wherein the instructions are further operable, when executed by the one or more processors to cause the adaptive multi-model power selection apparatus to: receive historical generator environmental data corresponding to the historical generator operational data; and determine the predicted temporal environmental capacity for each power generator based on the historical generator operational data and corresponding historical generator environmental data.

Clause 60. The subterranean drilling system of any one of clauses 34-37, wherein the instructions are further operable, when executed by the one or more processors to cause the adaptive multi-model power selection apparatus to: receive historical corresponding drilling system data corresponding to the historical generator operational data; and determine the predicted temporal environmental capacity for each power generator based on the historical generator operational data and historical corresponding drilling system data.

Clause 61. The subterranean drilling system of any one of clauses 34-37, wherein the instructions are further operable, when executed by the one or more processors to cause the adaptive multi-model power selection apparatus to: utilize model verification techniques to continually ensure stability of the power generator capacity prediction model.

Clause 62. The subterranean drilling system of any one of clauses 34-37 or 61, wherein the model verification techniques comprise at least one of cumulative sum (CUSUM)-based change detection and rate-of-change detection techniques.

Clause 63. The subterranean drilling system of any one of clauses 34-37, wherein the instructions are further operable, when executed by the one or more processors to cause the adaptive multi-model power selection apparatus to: store a plurality of shared power generator capacity prediction models; calculate a prediction error for each shared power generator capacity prediction model relative to an observed temporal environmental capacity; and select a selected shared power generator capacity prediction model from the plurality of shared power generator capacity prediction models based on the prediction error.

Clause 64. The subterranean drilling system of any one of clauses 34-37, wherein the instructions are further operable, when executed by the one or more processors to cause the adaptive multi-model power selection apparatus to: adapt the power generator capacity prediction model based on an observed temporal environmental capacity.

Clause 65. The subterranean drilling system of any one of clauses 34-37, wherein the instructions are further operable, when executed by the one or more processors to cause the adaptive multi-model power selection apparatus to: determine a historical minimum capacity for each power generator in the candidate generator set; and store the historical minimum capacity for each power generator in the candidate generator set.

Clause 66. The subterranean drilling system of any one of clauses 34-37, wherein the instructions are further operable, when executed by the one or more processors to cause the adaptive multi-model power selection apparatus to: identify high performance power generators of the candidate generator set; train an anomaly detection model based on the high performance power generators; and detect a poor performance power generator based on a comparison of the poor performance power generator to the anomaly detection model.

Clause 67. A computer-implemented method for determining a selected power generator at a subterranean drilling system, the computer-implemented method comprising: receiving, at an adaptive multi-model power selection apparatus, historical generator operational data for a candidate generator set of power generators that are each respectively configured to provide operating power to the subterranean drilling system.

Clause 68. The computer-implemented method of clause 67, further comprising: determining, by a power generator capacity prediction model, a predicted temporal environmental capacity for each of the power generators of the candidate generator set based on the historical generator operational data.

Clause 69. The computer-implemented method of any one of clauses 67-68, further comprising: receiving operational drilling system equipment data associated with an operational drilling component set of the subterranean drilling system.

Clause 70. The computer-implemented method of any one of clauses 67-69, further comprising: determining, by an adaptive power generator selection model, a selected power generator of the candidate generator set to provide the operating power to the subterranean drilling system during a drilling system operation period.

Clause 71. The computer-implemented method of any one of clauses 67-70, further comprising: determining, by the adaptive power generator selection model, a plurality of selected power generators of the candidate generator set to provide the operating power to the subterranean drilling system during the drilling system operation period.

Clause 72. The computer-implemented method of any one of clauses 67-70, further comprising: determining, at a power demand prediction model, a predicted temporal environmental power demand, based on the operational drilling system equipment data.

Clause 73. The computer-implemented method of any one of clauses 67-70 or 72, further comprising: receiving, at the adaptive power generator selection model, candidate generator set data, and determining the selected power generator based on the predicted temporal environmental capacity for each power generator, the predicted temporal environmental power demand of the operational drilling component set, and the candidate generator set data.

Clause 74. The computer-implemented method of any one of clauses 67-70, 72, or 73, further comprising: determining the selected power generator based on a cost-based reduction strategy utilizing the candidate generator set data.

Clause 75. The computer-implemented method of any one of clauses 67-70, 72, 73, or 74, wherein the candidate generator set data comprises fuel efficiency data of each power generator of the candidate generator set, generator run data of each power generator of the candidate generator set, and/or thermal conditions of each power generator of the candidate generator set.

Clause 76. The computer-implemented method of any one of clauses 67-70, 72, 73, or 74, wherein the cost-based reduction strategy determines the selected power generator to reduce a fuel consumption cost and/or an emissions cost.

Clause 77. The computer-implemented method of any one of clauses 67-70 or 72, wherein the power demand prediction model comprises a bi-directional recurrent neural network.

Clause 78. The computer-implemented method of any one of clauses 67-70 or 72, further comprising: receiving historical operational drilling system equipment data corresponding to the subterranean drilling system; and training the power demand prediction model based on the historical operational drilling system equipment data.

Clause 79. The computer-implemented method of any one of clauses 67-70, 72, or 78, further comprising: receiving historical operational environmental data corresponding to the historical operational drilling system equipment data; and training the power demand prediction model based on the historical operational environmental data.

Clause 80. The computer-implemented method of any one of clauses 67-70, 72, or 78, further comprising: receiving historical geological data corresponding to the historical operational drilling system equipment data; and training the power demand prediction model based on the historical geological data.

Clause 81. The computer-implemented method of any one of clauses 67-70 or 72, wherein the drilling system operation period is greater than five minutes.

Clause 82. The computer-implemented method of any one of clauses 67-70, wherein the selected power generator of the candidate generator set is determined based on even wear distribution of each power generator of the candidate generator set.

Clause 83. The computer-implemented method of any one of clauses 67-70, further comprising: receiving, at power generator data transformation module, candidate generator set data comprising one or more physical characteristics associated with the power generators; and scaling the candidate generator set data based on a maximum threshold associated with each of the one or more physical characteristics.

Clause 84. The computer-implemented method of any one of clauses 67-70 or 83, further comprising: identifying outlier data in the candidate generator set data; and removing outlier data from the candidate generator set data.

Clause 85. The computer-implemented method of any one of clauses 67-70 or 83, further comprising: identifying missing data in the candidate generator set data; and filling missing data in the candidate generator set data based on linear interpolation.

Clause 86. The computer-implemented method of any one of clauses 67-70, further comprising: receiving, at a power generator data transformation module, the operational drilling system equipment data; and scaling the operational drilling system equipment data based on a maximum threshold for each component of the subterranean drilling system.

Clause 87. The computer-implemented method of any one of clauses 67-70 or 86, further comprising: identifying outlier data in the operational drilling system equipment data; and removing outlier data from the operational drilling system equipment data.

Clause 88. The computer-implemented method of any one of clauses 67-70 or 86, further comprising: identifying missing data in the operational drilling system equipment data; and filling missing data in the operational drilling system equipment data based on linear interpolation.

Clause 89. The computer-implemented method of any one of clauses 67-70, wherein the operational drilling system equipment data comprises bit depth data, block movement data, pump related data, stroke counts, weight on bit data, hookload data, candidate generator set data, top drive data.

Clause 90. The computer-implemented method of any one of clauses 67-70, wherein the power generator capacity prediction model is an iteratively weighted least squares regression model.

Clause 91. The computer-implemented method of any one of clauses 67-70, further comprising: training the power generator capacity prediction model based on the historical generator operational data.

Clause 92. The computer-implemented method of any one of clauses 67-70, further comprising: receiving historical generator environmental data corresponding to the historical generator operational data; and determining the predicted temporal environmental capacity for each power generator based on the historical generator operational data and corresponding historical generator environmental data.

Clause 93. The computer-implemented method of any one of clauses 67-70, further comprising: receiving historical corresponding drilling system data corresponding to the historical generator operational data; and determining the predicted temporal environmental capacity for each power generator based on the historical generator operational data and historical corresponding drilling system data.

Clause 94. The computer-implemented method of any one of clauses 67-70, further comprising: utilizing model verification techniques to continually ensure stability of the power generator capacity prediction model.

Clause 95. The computer-implemented method of any one of clauses 67-70 or 94, wherein the model verification techniques comprise at least one of cumulative sum (CUSUM)-based change detection and rate-of-change detection techniques.

Clause 96. The computer-implemented method of any one of clauses 67-70, further comprising: storing a plurality of shared power generator capacity prediction models; calculating a prediction error for each shared power generator capacity prediction model relative to an observed temporal environmental capacity; and selecting a selected shared power generator capacity prediction model from the plurality of shared power generator capacity prediction models based on the prediction error.

Clause 97. The computer-implemented method of any one of clauses 67-70, further comprising: adapting the power generator capacity prediction model based on an observed temporal environmental capacity.

Clause 98. The computer-implemented method of any one of clauses 67-70, further comprising: determining a historical minimum capacity for each power generator in the candidate generator set; and storing the historical minimum capacity for each power generator in the candidate generator set.

Clause 99. The computer-implemented method of any one of clauses 67-70, further comprising: identifying high performance power generators of the candidate generator set; training an anomaly detection model based on the high performance power generators; and detecting a poor performance power generator based on a comparison of the poor performance power generator to the anomaly detection model.

Many modifications and other embodiments of the disclosures set forth herein will come to mind to one skilled in the art to which these disclosures pertain having the benefit of the teachings presented in the foregoing description and the associated drawings. Therefore, it is to be understood that the disclosures are not to be limited to the specific embodiments disclosed and that modifications and other embodiments are intended to be included within the scope of the appended claims. Although specific terms are employed herein, they are used in a generic and descriptive sense only and not for purposes of limitation, unless described otherwise.

1. An adaptive multi-model power selection apparatus for a subterranean drilling system, wherein the adaptive multi-model power selection apparatus comprises one or more processors and one or more memories storing instructions that are operable, when executed by the one or more processors, to cause the adaptive multi-model power selection apparatus to:
receive historical generator operational data for a candidate generator set of power generators that are each respectively configured to provide operating power to the subterranean drilling system;
determine, by a power generator capacity prediction model, a predicted temporal environmental capacity for each of the power generators of the candidate generator set based on the historical generator operational data;
receive operational drilling system equipment data associated with an operational drilling component set of the subterranean drilling system; and
determine, by an adaptive power generator selection model, a selected power generator of the candidate generator set to provide the operating power to the subterranean drilling system during a drilling system operation period.

2. The adaptive multi-model power selection apparatus of claim 1, wherein the instructions are further operable, when executed by the one or more processors to cause the adaptive multi-model power selection apparatus to:
determine, by the adaptive power generator selection model, a plurality of selected power generators of the candidate generator set to provide the operating power to the subterranean drilling system during the drilling system operation period.

3. The adaptive multi-model power selection apparatus of claim 1, wherein the instructions are further operable, when executed by the one or more processors to cause the adaptive multi-model power selection apparatus to:
determine, at a power demand prediction model, a predicted temporal environmental power demand, based on the operational drilling system equipment data.

4. The adaptive multi-model power selection apparatus of claim 3, wherein the instructions are further operable, when executed by the one or more processors to cause the adaptive multi-model power selection apparatus to:
receive, at the adaptive power generator selection model, candidate generator set data, and
determine the selected power generator based on the predicted temporal environmental capacity for each power generator, the predicted temporal environmental power demand of the operational drilling component set, and the candidate generator set data.

5. The adaptive multi-model power selection apparatus of claim 4, wherein the instructions are further operable, when executed by the one or more processors to cause the adaptive multi-model power selection apparatus to:
determine the selected power generator based on a cost-based reduction strategy utilizing the candidate generator set data.

6. The adaptive multi-model power selection apparatus of claim 5, wherein the candidate generator set data comprises fuel efficiency data of each power generator of the candidate generator set, generator run data of each power generator of the candidate generator set, and/or thermal conditions of each power generator of the candidate generator set.

7. The adaptive multi-model power selection apparatus of claim 5, wherein the cost-based reduction strategy determines the selected power generator to reduce a fuel consumption cost and/or an emissions cost.

8. The adaptive multi-model power selection apparatus of claim 3, wherein the power demand prediction model comprises a bi-directional recurrent neural network.

9. The adaptive multi-model power selection apparatus of claim 3, wherein the instructions are further operable, when executed by the one or more processors to cause the adaptive multi-model power selection apparatus to:
receive historical operational drilling system equipment data corresponding to the subterranean drilling system; and
train the power demand prediction model based on the historical operational drilling system equipment data.

10. The adaptive multi-model power selection apparatus of claim 9, wherein the instructions are further operable, when executed by the one or more processors to cause the adaptive multi-model power selection apparatus to:
receive historical operational environmental data corresponding to the historical operational drilling system equipment data; and
train the power demand prediction model based on the historical operational environmental data.

11. The adaptive multi-model power selection apparatus of claim 9, wherein the instructions are further operable, when executed by the one or more processors to cause the adaptive multi-model power selection apparatus to:
receive historical geological data corresponding to the historical operational drilling system equipment data; and
train the power demand prediction model based on the historical geological data.

12. The adaptive multi-model power selection apparatus of claim 3, wherein the drilling system operation period is greater than five minutes.

13. The adaptive multi-model power selection apparatus of claim 1, wherein the selected power generator of the candidate generator set is determined based on even wear distribution of each power generator of the candidate generator set.

14. The adaptive multi-model power selection apparatus of claim 1, wherein the instructions are further operable, when executed by the one or more processors to cause the adaptive multi-model power selection apparatus to:
receive, at power generator data transformation module, candidate generator set data comprising one or more physical characteristics associated with the power generators; and
scale the candidate generator set data based on a maximum threshold associated with each of the one or more physical characteristics.

15. The adaptive multi-model power selection apparatus of claim 14, wherein the instructions are further operable, when executed by the one or more processors to cause the adaptive multi-model power selection apparatus to:
identify outlier data in the candidate generator set data; and
remove outlier data from the candidate generator set data.

16. The adaptive multi-model power selection apparatus of claim 14, wherein the instructions are further operable, when executed by the one or more processors to cause the adaptive multi-model power selection apparatus to:
identify missing data in the candidate generator set data; and
fill missing data in the candidate generator set data based on linear interpolation.

17. The adaptive multi-model power selection apparatus of claim 1, wherein the instructions are further operable, when executed by the one or more processors to cause the adaptive multi-model power selection apparatus to:
receive, at a power generator data transformation module, the operational drilling system equipment data; and
scale the operational drilling system equipment data based on a maximum threshold for each component of the subterranean drilling system.

18. The adaptive multi-model power selection apparatus of claim 17, wherein the instructions are further operable, when executed by the one or more processors to cause the adaptive multi-model power selection apparatus to:
identify outlier data in the operational drilling system equipment data; and
remove outlier data from the operational drilling system equipment data.

19. The adaptive multi-model power selection apparatus of claim 17, wherein the instructions are further operable, when executed by the one or more processors to cause the adaptive multi-model power selection apparatus to:
identify missing data in the operational drilling system equipment data; and
fill missing data in the operational drilling system equipment data based on linear interpolation.

20. The adaptive multi-model power selection apparatus of claim 1, wherein the operational drilling system equipment data comprises bit depth data, block movement data, pump related data, stroke counts, weight on bit data, hookload data, candidate generator set data, top drive data.

21. The adaptive multi-model power selection apparatus of claim 1, wherein the power generator capacity prediction model is an iteratively weighted least squares regression model.

22. The adaptive multi-model power selection apparatus of claim 1, wherein the instructions are further operable, when executed by the one or more processors to cause the adaptive multi-model power selection apparatus to:
train the power generator capacity prediction model based on the historical generator operational data.

23. The adaptive multi-model power selection apparatus of claim 1, wherein the instructions are further operable, when executed by the one or more processors to cause the adaptive multi-model power selection apparatus to:
receive historical generator environmental data corresponding to the historical generator operational data; and
determine the predicted temporal environmental capacity for each power generator based on the historical generator operational data and corresponding historical generator environmental data.

24. The adaptive multi-model power selection apparatus of claim 1, wherein the instructions are further operable, when executed by the one or more processors to cause the adaptive multi-model power selection apparatus to:
receive historical corresponding drilling system data corresponding to the historical generator operational data; and
determine the predicted temporal environmental capacity for each power generator based on the historical generator operational data and historical corresponding drilling system data.

25. The adaptive multi-model power selection apparatus of claim 1, wherein the instructions are further operable, when executed by the one or more processors to cause the adaptive multi-model power selection apparatus to:
utilize model verification techniques to continually ensure stability of the power generator capacity prediction model.

26. The adaptive multi-model power selection apparatus of claim 25, wherein the model verification techniques comprise at least one of cumulative sum (CUSUM)-based change detection and rate-of-change detection techniques.

27. The adaptive multi-model power selection apparatus of claim 1, wherein the instructions are further operable, when executed by the one or more processors to cause the adaptive multi-model power selection apparatus to:
store a plurality of shared power generator capacity prediction models;
calculate a prediction error for each shared power generator capacity prediction model relative to an observed temporal environmental capacity; and
select a selected shared power generator capacity prediction model from the plurality of shared power generator capacity prediction models based on the prediction error.

28. The adaptive multi-model power selection apparatus of claim 1, wherein the instructions are further operable, when executed by the one or more processors to cause the adaptive multi-model power selection apparatus to:
adapt the power generator capacity prediction model based on an observed temporal environmental capacity.

29. The adaptive multi-model power selection apparatus of claim 1, wherein the instructions are further operable, when executed by the one or more processors to cause the adaptive multi-model power selection apparatus to:
determine a historical minimum capacity for each power generator in the candidate generator set; and
store the historical minimum capacity for each power generator in the candidate generator set.

30. The adaptive multi-model power selection apparatus of claim 1, wherein the instructions are further operable, when executed by the one or more processors to cause the adaptive multi-model power selection apparatus to:
identify high performance power generators of the candidate generator set;
train an anomaly detection model based on the high performance power generators; and
detect a poor performance power generator based on a comparison of the poor performance power generator to the anomaly detection model.

31. A subterranean drilling system comprising:
an operational drilling component set configured to generate operational drilling system equipment data;
a candidate generator set of power generators that are each respectively configured to provide operating power to the subterranean drilling system;
an adaptive multi-model power selection apparatus comprising one or more processors and one or more memories storing instructions that are operable, when executed by the one or more processors, to cause the adaptive multi-model power selection apparatus to:
receive historical generator operational data for the candidate generator set of power generators;
determine, by a power generator capacity prediction model, a predicted temporal environmental capacity for each of the power generators of the candidate generator set based on the historical generator operational data;
receive the operational drilling system equipment data associated with the operational drilling component set of the subterranean drilling system; and
determine, by an adaptive power generator selection model, a selected power generator of the candidate generator set to provide the operating power to the subterranean drilling system during a drilling system operation period.

32. The subterranean drilling system of claim 31, wherein the instructions are further operable, when executed by the one or more processors to cause the adaptive multi-model power selection apparatus to:
determine, by the adaptive power generator selection model, a plurality of selected power generators of the candidate generator set to provide the operating power to the subterranean drilling system during the drilling system operation period.

33. The subterranean drilling system of claim 31, wherein the instructions are further operable, when executed by the one or more processors to cause the adaptive multi-model power selection apparatus to:
determine, at a power demand prediction model, a predicted temporal environmental power demand, based on the operational drilling system equipment data.

34. The subterranean drilling system of claim 33, wherein the instructions are further operable, when executed by the one or more processors to cause the adaptive multi-model power selection apparatus to:
receive, at the adaptive power generator selection model, candidate generator set data, and
determine the selected power generator based on the predicted temporal environmental capacity for each power generator, the predicted temporal environmental power demand of the operational drilling component set, and the candidate generator set data.

35. The subterranean drilling system of claim 34, wherein the instructions are further operable, when executed by the one or more processors to cause the adaptive multi-model power selection apparatus to:
determine the selected power generator based on a cost-based reduction strategy utilizing the candidate generator set data.

36. The subterranean drilling system of claim 35, wherein the candidate generator set data comprises fuel efficiency data of each power generator of the candidate generator set, generator run data of each power generator of the candidate generator set, and/or thermal conditions of each power generator of the candidate generator set.

37. The subterranean drilling system of claim 35, wherein the cost-based reduction strategy determines the selected power generator to reduce a fuel consumption cost and/or an emissions cost.

38. The subterranean drilling system of claim 33, wherein the power demand prediction model comprises a bi-directional recurrent neural network.

39. The subterranean drilling system of claim 33, wherein the instructions are further operable, when executed by the one or more processors to cause the adaptive multi-model power selection apparatus to:
receive historical operational drilling system equipment data corresponding to the subterranean drilling system; and
train the power demand prediction model based on the historical operational drilling system equipment data.

40. The subterranean drilling system of claim 39, wherein the instructions are further operable, when executed by the one or more processors to cause the adaptive multi-model power selection apparatus to:
receive historical operational environmental data corresponding to the historical operational drilling system equipment data; and
train the power demand prediction model based on the historical operational environmental data.

41. The subterranean drilling system of claim 39, wherein the instructions are further operable, when executed by the one or more processors to cause the adaptive multi-model power selection apparatus to:
receive historical geological data corresponding to the historical operational drilling system equipment data; and
train the power demand prediction model based on the historical geological data.

42. The subterranean drilling system of claim 33, wherein the drilling system operation period is greater than five minutes.

43. The subterranean drilling system of claim 31, wherein the selected power generator of the candidate generator set is determined based on even wear distribution of each power generator of the candidate generator set.

44. The subterranean drilling system of claim 31, wherein the instructions are further operable, when executed by the one or more processors to cause the adaptive multi-model power selection apparatus to:
receive, at power generator data transformation module, candidate generator set data comprising one or more physical characteristics associated with the power generators; and
scale the candidate generator set data based on a maximum threshold associated with each of the one or more physical characteristics.

45. The subterranean drilling system of claim 44, wherein the instructions are further operable, when executed by the one or more processors to cause the adaptive multi-model power selection apparatus to:
identify outlier data in the candidate generator set data; and
remove outlier data from the candidate generator set data.

46. The subterranean drilling system of claim 44, wherein the instructions are further operable, when executed by the one or more processors to cause the adaptive multi-model power selection apparatus to:
identify missing data in the candidate generator set data; and
fill missing data in the candidate generator set data based on linear interpolation.

47. The subterranean drilling system of claim 31, wherein the instructions are further operable, when executed by the one or more processors to cause the adaptive multi-model power selection apparatus to:
receive, at a power generator data transformation module, the operational drilling system equipment data; and
scale the operational drilling system equipment data based on a maximum threshold for each component of the subterranean drilling system.

48. The subterranean drilling system of claim 47, wherein the instructions are further operable, when executed by the one or more processors to cause the adaptive multi-model power selection apparatus to:
identify outlier data in the operational drilling system equipment data; and
remove outlier data from the operational drilling system equipment data.

49. The subterranean drilling system of claim 47, wherein the instructions are further operable, when executed by the one or more processors to cause the adaptive multi-model power selection apparatus to:
identify missing data in the operational drilling system equipment data; and
fill missing data in the operational drilling system equipment data based on linear interpolation.

50. The subterranean drilling system of claim 31, wherein the operational drilling system equipment data comprises bit depth data, block movement data, pump related data, stroke counts, weight on bit data, hookload data, candidate generator set data, top drive data.

51. The subterranean drilling system of claim 31, wherein the power generator capacity prediction model is an iteratively weighted least squares regression model.

52. The subterranean drilling system of claim 31, wherein the instructions are further operable, when executed by the one or more processors to cause the adaptive multi-model power selection apparatus to:
train the power generator capacity prediction model based on the historical generator operational data.

53. The subterranean drilling system of claim 31, wherein the instructions are further operable, when executed by the one or more processors to cause the adaptive multi-model power selection apparatus to:
receive historical generator environmental data corresponding to the historical generator operational data; and
determine the predicted temporal environmental capacity for each power generator based on the historical generator operational data and corresponding historical generator environmental data.

54. The subterranean drilling system of claim 31, wherein the instructions are further operable, when executed by the one or more processors to cause the adaptive multi-model power selection apparatus to:
receive historical corresponding drilling system data corresponding to the historical generator operational data; and
determine the predicted temporal environmental capacity for each power generator based on the historical generator operational data and historical corresponding drilling system data.

55. The subterranean drilling system of claim 31, wherein the instructions are further operable, when executed by the one or more processors to cause the adaptive multi-model power selection apparatus to:
utilize model verification techniques to continually ensure stability of the power generator capacity prediction model.

56. The subterranean drilling system of claim 55, wherein the model verification techniques comprise at least one of cumulative sum (CUSUM)-based change detection and rate-of-change detection techniques.

57. The subterranean drilling system of claim 31, wherein the instructions are further operable, when executed by the one or more processors to cause the adaptive multi-model power selection apparatus to:
store a plurality of shared power generator capacity prediction models;
calculate a prediction error for each shared power generator capacity prediction model relative to an observed temporal environmental capacity; and
select a selected shared power generator capacity prediction model from the plurality of shared power generator capacity prediction models based on the prediction error.

58. The subterranean drilling system of claim 31, wherein the instructions are further operable, when executed by the one or more processors to cause the adaptive multi-model power selection apparatus to:
adapt the power generator capacity prediction model based on an observed temporal environmental capacity.

59. The subterranean drilling system of claim 31, wherein the instructions are further operable, when executed by the one or more processors to cause the adaptive multi-model power selection apparatus to:
determine a historical minimum capacity for each power generator in the candidate generator set; and
store the historical minimum capacity for each power generator in the candidate generator set.

60. The subterranean drilling system of claim 31, wherein the instructions are further operable, when executed by the one or more processors to cause the adaptive multi-model power selection apparatus to:
identify high performance power generators of the candidate generator set;
train an anomaly detection model based on the high performance power generators; and
detect a poor performance power generator based on a comparison of the poor performance power generator to the anomaly detection model.

61. A computer-implemented method for determining a selected power generator at a subterranean drilling system, the computer-implemented method comprising:
receiving, at an adaptive multi-model power selection apparatus, historical generator operational data for a candidate generator set of power generators that are each respectively configured to provide operating power to the subterranean drilling system;
determining, by a power generator capacity prediction model, a predicted temporal environmental capacity for each of the power generators of the candidate generator set based on the historical generator operational data;
receiving operational drilling system equipment data associated with an operational drilling component set of the subterranean drilling system; and
determining, by an adaptive power generator selection model, the selected power generator of the candidate generator set to provide the operating power to the subterranean drilling system during a drilling system operation period.

62. The computer-implemented method of claim 61, further comprising:
determining, by the adaptive power generator selection model, a plurality of selected power generators of the candidate generator set to provide the operating power to the subterranean drilling system during the drilling system operation period.

63. The computer-implemented method of claim 61, further comprising:
determining, at a power demand prediction model, a predicted temporal environmental power demand, based on the operational drilling system equipment data.

64. The computer-implemented method of claim 63, further comprising:
receiving, at the adaptive power generator selection model, candidate generator set data, and
determining the selected power generator based on the predicted temporal environmental capacity for each power generator, the predicted temporal environmental power demand of the operational drilling component set, and the candidate generator set data.

65. The computer-implemented method of claim 64, further comprising:
determining the selected power generator based on a cost-based reduction strategy utilizing the candidate generator set data.

66. The computer-implemented method of claim 65, wherein the candidate generator set data comprises fuel efficiency data of each power generator of the candidate generator set, generator run data of each power generator of the candidate generator set, and/or thermal conditions of each power generator of the candidate generator set.

67. The computer-implemented method of claim 65, wherein the cost-based reduction strategy determines the selected power generator to reduce a fuel consumption cost and/or an emissions cost.

68. The computer-implemented method of claim 63, wherein the power demand prediction model comprises a bi-directional recurrent neural network.

69. The computer-implemented method of claim 63, further comprising:
receiving historical operational drilling system equipment data corresponding to the subterranean drilling system; and
training the power demand prediction model based on the historical operational drilling system equipment data.

70. The computer-implemented method of claim 69, further comprising:
receiving historical operational environmental data corresponding to the historical operational drilling system equipment data; and
training the power demand prediction model based on the historical operational environmental data.

71. The computer-implemented method of claim 69, further comprising:
receiving historical geological data corresponding to the historical operational drilling system equipment data; and
training the power demand prediction model based on the historical geological data.

72. The computer-implemented method of claim 63, wherein the drilling system operation period is greater than five minutes.

73. The computer-implemented method of claim 61, wherein the selected power generator of the candidate generator set is determined based on even wear distribution of each power generator of the candidate generator set.

74. The computer-implemented method of claim 61, further comprising:
receiving, at power generator data transformation module, candidate generator set data comprising one or more physical characteristics associated with the power generators; and
scaling the candidate generator set data based on a maximum threshold associated with each of the one or more physical characteristics.

75. The computer-implemented method of claim 74, further comprising:
identifying outlier data in the candidate generator set data; and
removing outlier data from the candidate generator set data.

76. The computer-implemented method of claim 74, further comprising:
identifying missing data in the candidate generator set data; and
filling missing data in the candidate generator set data based on linear interpolation.

77. The computer-implemented method of claim 61, further comprising:
receiving, at a power generator data transformation module, the operational drilling system equipment data; and
scaling the operational drilling system equipment data based on a maximum threshold for each component of the subterranean drilling system.

78. The computer-implemented method of claim 77, further comprising:
identifying outlier data in the operational drilling system equipment data; and
removing outlier data from the operational drilling system equipment data.

79. The computer-implemented method of claim 77, further comprising:
identifying missing data in the operational drilling system equipment data; and
filling missing data in the operational drilling system equipment data based on linear interpolation.

80. The computer-implemented method of claim 61, wherein the operational drilling system equipment data comprises bit depth data, block movement data, pump related data, stroke counts, weight on bit data, hookload data, candidate generator set data, top drive data.

81. The computer-implemented method of claim 61, wherein the power generator capacity prediction model is an iteratively weighted least squares regression model.

82. The computer-implemented method of claim 61, further comprising:
training the power generator capacity prediction model based on the historical generator operational data.

83. The computer-implemented method of claim 61, further comprising:
receiving historical generator environmental data corresponding to the historical generator operational data; and
determining the predicted temporal environmental capacity for each power generator based on the historical generator operational data and corresponding historical generator environmental data.

84. The computer-implemented method of claim 61, further comprising:
receiving historical corresponding drilling system data corresponding to the historical generator operational data; and
determining the predicted temporal environmental capacity for each power generator based on the historical generator operational data and historical corresponding drilling system data.

85. The computer-implemented method of claim 61, further comprising:
utilizing model verification techniques to continually ensure stability of the power generator capacity prediction model.

86. The computer-implemented method of claim 85, wherein the model verification techniques comprise at least one of cumulative sum (CUSUM)-based change detection and rate-of-change detection techniques.

87. The computer-implemented method of claim 61, further comprising:
storing a plurality of shared power generator capacity prediction models;
calculating a prediction error for each shared power generator capacity prediction model relative to an observed temporal environmental capacity; and
selecting a selected shared power generator capacity prediction model from the plurality of shared power generator capacity prediction models based on the prediction error.

88. The computer-implemented method of claim 61, further comprising:
adapting the power generator capacity prediction model based on an observed temporal environmental capacity.

89. The computer-implemented method of claim 61, further comprising:
determining a historical minimum capacity for each power generator in the candidate generator set; and
storing the historical minimum capacity for each power generator in the candidate generator set.

90. The computer-implemented method of claim 61, further comprising:
identifying high performance power generators of the candidate generator set;
training an anomaly detection model based on the high performance power generators; and
detecting a poor performance power generator based on a comparison of the poor performance power generator to the anomaly detection model.
